(19) United States
(12) Patent Application Publication
(10) Pub. No.: US 2024/0158896 A1
(43) Pub. Date: May 16, 2024

(54) NON-ORIENTED ELECTRICAL STEEL SHEET AND METHOD FOR MANUFACTURING SAME

(71) Applicant: NIPPON STEEL CORPORATION, Tokyo (JP)

(72) Inventors: Tesshu MURAKAWA, Tokyo (JP); Satoshi KANO, Tokyo (JP)

(73) Assignee: NIPPON STEEL CORPORATION, Tokyo (JP)

(21) Appl. No.: 18/279,757

(22) PCT Filed: Mar. 18, 2022
(86) PCT No.: PCT/JP2022/012760

§ 371 Date: Aug. 31, 2023

(30) Foreign Application Priority Data
Mar. 19, 2021 (JP) 2021-046004

(51) Int. Cl. C22C 38/34; C21D 6/00; C21D 8/02; C21D 9/46; C22C 38/00; C22C 38/06; C22C 38/60

(52) U.S. Cl. CPC C22C 38/34; C21D 6/008; C21D 8/0273; C21D 9/46; C22C 38/004; C22C 38/008; C22C 38/06; C22C 38/60

(57) ABSTRACT

This non-oriented electrical steel sheet has a predetermined chemical composition, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, 0.20≤S_{tyl}/Sₜₒₜ≤0.85, 0.05≤S₁₀₀/Sₜₒₜ≤0.80, S₁₀₀/Sₜₒₜ≥0.5, and K₁₀₀/K_{tyl}≤0.990 are satisfied.

### TECHNICAL FIELD OF THE INVENTION

The present invention relates to a non-oriented electrical steel sheet and a method for manufacturing the same.

Priority is claimed on Japanese Patent Application No. 2021-046004, filed Mar. 19, 2021, the content of which is incorporated herein by reference.

### RELATED ART

Non-oriented electrical steel sheets are used for, for example, cores of motors, and non-oriented electrical steel sheets are required to be excellent in terms of magnetic characteristics, for example, a low iron loss and a high magnetic flux density in a direction parallel to sheet surfaces thereof.

In order for this, it is advantageous to control the texture of the steel sheet such that the magnetization easy axis (<100> orientation) of crystals coincides with the sheet in-plane direction. Ordinarily, the {100} orientation having many magnetization easy axes in the sheet in-plane direction is a particularly preferable representative orientation, and a {111} orientation having no magnetization easy axis in the sheet in-plane direction is a representative orientation that should be avoided. Regarding such texture control, many techniques for controlling a {100} orientation, a {110} orientation, a {111} orientation, and the like have been disclosed like, for example, techniques described in Patent Documents 1 to 5.

Various methods have been devised as methods for controlling textures, and among them, there are techniques in which “strain-induced boundary migration” is utilized. In strain-induced boundary migration under specific conditions, it is possible to suppress the accumulation of {111} orientations, and thus the strain-induced boundary migration is effectively utilized for non-oriented electrical steel sheets. These techniques are disclosed in Patent Documents 6 to 10 and the like.

However, when these non-oriented electrical steel sheets are sheared, there is a possibility that the characteristics may fluctuate.

### PRIOR ART DOCUMENT

### Patent Document

[Patent Document 1] Japanese Unexamined Patent Application, First Publication No. 2017-193754
[Patent Document 2] Japanese Unexamined Patent Application, First Publication No. 2011-111658
[Patent Document 3] PCT International Publication No. WO 2016/148010
[Patent Document 4] Japanese Unexamined Patent Application, First Publication No. 2018-3049
[Patent Document 5] PCT International Publication No. WO 2015/199211
[Patent Document 6] Japanese Unexamined Patent Application, First Publication No. H8-143960
[Patent Document 7] Japanese Unexamined Patent Application, First Publication No. 2002-363713
[Patent Document 8] Japanese Unexamined Patent Application, First Publication No. 2011-162821
[Patent Document 9] Japanese Unexamined Patent Application, First Publication No. 2013-112853
[Patent Document 10] Japanese Patent No. 4029430

### DISCLOSURE OF THE INVENTION

### Problems to be Solved by the Invention

The present invention has been made in consideration of the above-described problem, and an objective of the present invention is to provide a non-oriented electrical steel sheet in which excellent magnetic characteristics (low iron loss or the like) can be obtained even after shearing and a method for manufacturing the same.

### Means for Solving the Problem

The present inventors studied techniques for forming preferable textures for non-oriented electrical steel sheets utilizing strain-induced boundary migration and the characteristics of steel sheets that are obtained by the techniques. Among them, it was recognized that, in non-oriented electrical steel sheets for which strain-induced boundary migration has been utilized, there are cases where fluctuations in characteristics (particularly, iron loss) become large depending on processing conditions at the time of cutting out a sample for characteristic evaluation. When this phenomenon was observed in detail, it was considered that, in a case where the characteristics became low, the cross section of the sample was rough and there was a possibility that fracture behaviors during shearing may have an influence.

As a result of studying an association between the state of this cross section and the crystal structure in detail, the present inventors clarified that, in steel sheets having a rough cross section, the crystal structure became duplex grains, and a difference in grain size between {100} orientated grains and {110} orientated grains, which became encroaching orientations in strain-induced boundary migration and {1111} orientated grains, which became an orientation to be encroached, was characteristic.

The present inventors performed intensive studies to solve the above-described problem. As a result, it was clarified that in order to manufacture a non-oriented electrical steel sheet having excellent magnetic characteristics in which, particularly, {100} orientated grains are preferentially grown in strain-induced boundary migration and, in order to suppress an adverse influence on magnetic characteristics by shearing, it is important to make the areas and area ratios of {100} orientated grains and {111} orientated grains when observed on a surface parallel to the steel sheet surface (steel sheet surface) appropriate.

In addition, it was also clarified that, in order to manufacture such a non-oriented electrical steel sheet, in a stage where strain causing strain induction has been imparted, it is important to control the areas and area ratio of orientated grains in which a Taylor factor is small and orientated grains in which the Taylor factor is large when observed on a surface parallel to the steel sheet surface and the strain amount imparted thereto to be within predetermined ranges and to cause strain-induced boundary migration.

The present inventors further repeated intensive studies based on such findings. As a result, the present inventors obtained ideas of various aspects of the invention to be described below.

[1]

A non-oriented electrical steel sheet according to an aspect of the present invention containing, as a chemical composition, by mass %,
Si: 1.50% to 4.00%,
one or more selected from the group consisting of Mn, Ni, Co, Pt, Pb, Cu, and
Au: less than 2.50% in total,
C: 0.0100% or less,
sol. Al: 4.00% or less,
S: 0.0400% or less,
N: 0.0100% or less,
Sn: 0.00% to 0.40%,
Sb: 0.00% to 0.40%,
P: 0.00% to 0.40%,
Cr: 0.001% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass % c) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities,
in which, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied.

([Mn]+[Ni]+[Co]+[Pt]+[Pb]+[Cu]+[Au])−([Si]+[sol. Al])≤0.00% (1)

M=(cos ϕ×cos λ)⁻¹ (2)

0.20≤S_{tyl}/Sₜₒₜ≤0.85 (3)

0.05≤S₁₀₀/Sₜᵣₐ≥0.80 (4)

S₁₀₀/Sₜᵣₐ≥0.50 (5)

K₁₀₀/K_{tyl}≤0.990 (6)

Here, ϕ in Formula (2) represents an angle formed by a stress vector and a slip direction vector of a crystal, and λ represents an angle formed by the stress vector and a normal vector of a slip plane of the crystal.

[2]

The non-oriented electrical steel sheet according to [1], in which, in a case where an average KAM value of the orientated grains in which the Taylor factor M becomes 2.8 or less is indicated by Kₜᵣₐ, Formula (7) may be satisfied.

K₁₀₀/Kₜᵣₐ<1.010 (7)

[3]

The non-oriented electrical steel sheet according to [1] or [2], in which, in a case where an area of {110} orientated grains is indicated by S₁₁₀, Formula (8) may be satisfied.

S₁₀₀/S₁₁₀≥1.00 (8)

Here, it is assumed that Formula (8) is satisfied even when an area ratio S₁₀₀/S₁₁₀ diverges to infinity.

[4]

The non-oriented electrical steel sheet according to any one of [1] to [3], in which, in a case where an average KAM value of {110} orientated grains is indicated by K₁₁₀, Formula (9) may be satisfied.

K₁₀₀/K₁₁₀<1.010 (9)

[5] A non-oriented electrical steel sheet according to another aspect of the present invention containing, as a chemical composition, by mass %,
Si: 1.50% to 4.00%,
one or more selected from the group consisting of Mn, Ni, Co, Pt, Pb, Cu, and Au: less than 2.50% in total,
C: 0.0100% or less,
sol. Al: 4.00% or less,
S: 0.0400% or less,
N: 0.0100% or less,
Sn: 0.00% to 0.40%,
Sb: 0.00% to 0.40%,
P: 0.00% to 0.40%,
Cr: 0.001% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass % k) is indicated by [Pb], a Cu content (mass %) is indicated by [Cu], a Au content (mass %) is indicated by [Au], a Si content (mass %) is indicated by [Si], and a sol. Al content (mass %) is indicated by [sol. AU], Formula (1) is satisfied, and
a remainder of Fe and impurities,
in which, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, an average KAM value of the orientated grains in which the Taylor factor M becomes more than 2.8 is indicated by K_{tyl}, an average grain size in an observation region is indicated by dₐᵥₑ, an average grain size of the {100} orientated grains is indicated by d₁₀₀, and an average grain size of the orientated grains in which the Taylor factor M becomes more than 2.8 is indicated by d_{tyl}, Formulas (10) to (15) are satisfied.

([Mn]+[Ni]+[Co]+[Pt]+[Pb]+[Cu]+[Au])−([Si]+[sol. Al])≤0% (1)

M=(cos ϕ×cos λ)⁻¹ (2)

S_{tyl}/Sₜₒₜ≤0.70 (10)

0.20≤S₁₀₀/Sₜₒₜ (11)

S₁₀₀/Sₜᵣₐ≥0.55 (12)

K₁₀₀/K_{tyl}≤1.010 (13)

d₁₀₀/dₐᵥₑ>1.00 (14)

d₁₀₀/d_{tyl}>1.00 (15)

Here, ϕ in Formula (2) represents an angle formed by a stress vector and a slip direction vector of a crystal, and λ represents an angle formed by the stress vector and a normal vector of a slip plane of the crystal.

[6]

The non-oriented electrical steel sheet according to [5], in which, in a case where an average KAM value of the orientated grains in which the Taylor factor M becomes 2.8 or less is indicated by Kₜᵣₐ, Formula (16) may be satisfied.

K₁₀₀/Kₜᵣₐ<1.010 (16)

[7]

The non-oriented electrical steel sheet according to [5] or [6], in which, in a case where an average grain size of the orientated grains in which the Taylor factor M becomes 2.8 or less is indicated by dₜᵣₐ, Formula (17) may be satisfied.

d₁₀₀/dₜᵣₐ>1.00 (17)

[8]

The non-oriented electrical steel sheet according to any one of [5] to [7], in which, in a case where an area of {110} orientated grains is indicated by S₁₁₀, Formula (18) may be satisfied.

S₁₀₀/S₁₁₀≥1.00 (18)

Here, it is assumed that Formula (18) is satisfied even when an area ratio S₁₀₀/S₁₁₀ diverges to infinity.

[9]

The non-oriented electrical steel sheet according to any one of [5] to [8], in which, in a case where an average KAM value of {110} orientated grains is indicated by K₁₁₀, Formula (19) may be satisfied.

K₁₀₀/K₁₁₀<1.010 (19)

[10]

A method for manufacturing a non-oriented electrical steel sheet according to an aspect of the present invention is a method for manufacturing the non-oriented electrical steel sheet according to any of [5] to [9], the method including
performing a heat treatment on the non-oriented electrical steel sheet according to any one of [1] to [4] at a temperature of 700° C. to 950° C. for 1 second to 100 seconds.

[11]

A non-oriented electrical steel sheet according to another aspect of the present invention containing, as a chemical composition, by mass %,
Si: 1.50% to 4.00%,
one or more selected from the group consisting of Mn, Ni, Co, Pt, Pb, Cu, and Au: less than 2.50% in total,
C: 0.0100% or less,
sol. Al: 4.00% or less,
S: 0.0400% or less,
N: 0.0100% or less,
Sn: 0.00% to 0.40%,
Sb: 0.00% to 0.40%,
P: 0.00% to 0.40%,
Cr: 0.001% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities,
in which, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average grain size in an observation region is indicated by dₐᵥₑ, an average grain size of the {100} orientated grains is indicated by d₁₀₀, and an average grain size of the orientated grains in which the Taylor factor M becomes more than 2.8 is indicated by d_{tyl}, Formulas (20) to (24) are satisfied.

([Mn]+[Ni]+[Co]+[Pt]+[Pb]+[Cu]+[Au])−([Si]+[sol. Al])≤0% (1)

M=(cos ϕ×cos λ)⁻¹ (2)

S_{tyl}/Sₜₒₜ<0.55 (20)

S₁₀₀/Sₜₒₜ>0.30 (21)

S₁₀₀/Sₜᵣₐ≥0.60 (22)

d₁₀₀/dₐᵥₑ≥0.95 (23)

d₁₀₀/d_{tyl}≥0.95 (24)

Here, ϕ in Formula (2) represents an angle formed by a stress vector and a slip direction vector of a crystal, and λ represents an angle formed by the stress vector and a normal vector of a slip plane of the crystal.

[12]

The non-oriented electrical steel sheet according to [11], in which, in a case where an average grain size of the orientated grains in which the Taylor factor M becomes 2.8 or less is indicated by dₜᵣₐ, Formula (25) may be satisfied.

d₁₀₀/dₜᵣₐ≥0.95 (25)

[13]

A method for manufacturing a non-oriented electrical steel sheet according to another aspect of the present invention, including
performing a heat treatment on the non-oriented electrical steel sheet according to any one of [1] to [9] at a temperature of 950° C. to 1050° C. for 1 second to 100 seconds or at a temperature of 700° C. to 900° C. for longer than 1000 seconds.

### Effects of the Invention

According to the above-described aspects of the present invention, since the area and the area ratio of specific crystal orientations in a cross section parallel to the steel sheet surface are appropriate, it is possible to provide a non-oriented electrical steel sheet having excellent magnetic characteristics even after shearing and a method for manufacturing the same.

### EMBODIMENTS OF THE INVENTION

Hereinafter, embodiments of the present invention will be described. A non-oriented electrical steel sheet according to the present embodiment is manufactured by subjecting a steel material manufactured by casting or the like to a hot rolling step, a hot-rolled sheet annealing step, a cold rolling step, an intermediate annealing step, and a skin pass rolling step. At this stage, a steel sheet has a metallographic structure to be described in Embodiment 1 to be described below.

Furthermore, a non-oriented electrical steel sheet is manufactured through a first heat treatment step afterwards. At this stage, a non-oriented electrical steel sheet has a metallographic structure to be described in Embodiment 2 to be described below.

Furthermore, a non-oriented electrical steel sheet is manufactured by performing a second heat treatment on the non-oriented electrical steel sheet after the skin pass rolling or after the first heat treatment. At this stage, a steel sheet has a metallographic structure to be described in Embodiment 3 to be described below.

Due to the heat treatments (the first heat treatment and/or the second heat treatment) after the skin pass rolling, the steel sheet undergoes strain-induced boundary migration and then normal grain growth. The strain-induced boundary migration and the normal grain growth may occur in the first heat treatment step or may occur in the second heat treatment step.

The steel sheet after the skin pass rolling is a base sheet of the steel sheet after the strain-induced boundary migration or a base sheet of the steel sheet after the normal grain growth. In addition, the steel sheet after the strain-induced boundary migration is a base sheet of the steel sheet after the normal grain growth. Hereinafter, steel sheets after skin pass rolling, steel sheets after strain-induced boundary migration, and steel sheets after normal grain growth will be all described as non-oriented electrical steel sheets regardless of before or after the heat treatments.

The chemical composition does not change throughout the hot rolling step, the hot-rolled sheet annealing step, the cold rolling step, the intermediate annealing step, the skin pass rolling step, the first heat treatment step, and the second heat treatment step.

First, the chemical compositions of the non-oriented electrical steel sheet according to the present embodiment and a steel material that is used in a method for manufacturing the same will be described. In the following description, “%” that is the unit of the amount of each element that is contained in the non-oriented electrical steel sheet or the steel material means “mass %” unless particularly otherwise described. The non-oriented electrical steel sheet and the steel material according to the present embodiment contain, as a chemical composition, Si: 1.50% to 4.00%, one or more selected from the group consisting of Mn, Ni, Co, Pt, Pb, Cu, and Au: less than 2.50% in total, C: 0.0100% or less, sol. Al: 4.00% or less, P: 0.00% to 0.40%, S: 0.0400% or less, N: 0.0100% or less, Sn: 0.00% to 0.40%, Sb: 0.00% to 0.40%, Cr: 0.001% to 0.100%, B: 0.0000% to 0.0050%, O: 0.0000% to 0.0200%, one or more selected from the group consisting of Mg, Ca, Sr, Ba, Ce, La, Nd, Pr, Zn, and Cd: 0.0000% to 0.0100% in total, and a remainder of Fe and impurities. As the impurities, impurities that are contained in a raw material such as ore or a scrap or impurities that are contained during manufacturing steps are exemplary examples.

(Si: 1.50% to 4.00%)

Si increases the electric resistance to decrease the eddy-current loss to reduce the iron loss or increases the yield ratio to improve punching workability for forming cores. When the Si content is less than 1.50%, these effects cannot be sufficiently obtained. Therefore, the Si content is set to 1.50% or more. The Si content is preferably 2.00% or more, more preferably 2.10% or more, and still more preferably 2.30% or more.

On the other hand, when the Si content is more than 4.00%, the magnetic flux density decreases, the punching workability deteriorates or cold rolling becomes difficult due to an excessive increase in hardness. Therefore, the Si content is set to 4.00% or less.

(One or More Selected from Group Consisting of Mn, Ni, Co, Pt, Pb, Cu, and Au: Less than 2.50% in Total)

These elements are austenite (γ phase)-stabilizing elements, and, when these elements are contained in a large quantity, ferrite-austenite transformation (hereinafter, α-γ transformation) occurs during the heat treatment of the steel sheet. The effect of the non-oriented electrical steel sheet according to the present embodiment is considered to be exhibited by controlling the area and area ratio of a specific crystal orientation in a cross section parallel to the steel sheet surface; however, when α-γ transformation occurs during the heat treatment, the area and the area ratio significantly change due to the transformation, and it is not possible to obtain a predetermined metallographic structure. Therefore, the total of the amounts of one or more selected from the group consisting of Mn, Ni, Co, Pt, Pb, Cu, and Au is set to less than 2.50%. The total of the contents is preferably less than 2.00% and more preferably less than 1.50%. The lower limit of the total of the amounts of these elements is not particularly limited (may be 0.00%), but the Mn content is preferably set to 0.10% or more for a reason of suppressing the fine precipitation of MnS that degrades magnetic characteristics.

In addition, as a condition for preventing the occurrence of the α-γ transformation, the chemical composition is made to further satisfy the following condition. That is, when the Mn content (mass %) is indicated by [Mn], the Ni content (mass %) is indicated by [Ni], the Co content (mass %) is indicated by [Co], the Pt content (mass %) is indicated by [Pt], the Pb content (mass %) is indicated by [Pb], the Cu content (mass %) is indicated by [Cu], the Au content (mass %) is indicated by [Au], the Si content (mass %) is indicated by [Si], and the sol. Al content (mass %) is indicated by [sol. Al], the contents are made to satisfy Formula (1).

([Mn]+[Ni]+[Co]+[Pt]+[Pb]+[Cu]+[Au])−([Si]+[sol. Al])≤0.00% (1)

(C: 0.0100% or Less)

C increases the iron loss or causes magnetic aging. Therefore, the C content is preferably as small as possible. Such a phenomenon becomes significant when the C content exceeds 0.0100%. Therefore, the C content is set to 0.0100% or less. The lower limit of the C content is not particularly limited, but the C content is preferably set to 0.0005% or more based on the cost of a decarburization treatment at the time of refining.

(sol. Al: 4.00% or Less)

sol. Al increases the electric resistance to decrease the eddy-current loss to reduce the iron loss. sol. Al also contributes to improvement in the relative magnitude of a magnetic flux density B50 with respect to the saturated magnetic flux density. Here, the magnetic flux density B50 refers to a magnetic flux density in a magnetic field of 5000 A/m. When the sol. Al content is less than 0.0001%, these effects cannot be sufficiently obtained. In addition, Al also has a desulfurization-promoting effect in steelmaking. Therefore, in the case of obtaining the above-described effect, the sol. Al content is preferably set to 0.0001% or more. The sol. Al content is more preferably set to 0.30% or more.

On the other hand, when the sol. Al content is more than 4.00%, the magnetic flux density decreases or the yield ratio decreases, whereby the punching workability deteriorates. Therefore, the sol. Al content is set to 4.00% or less. The sol. Al content is preferably 2.50% or less and more preferably 1.50% or less.

(S: 0.0400% or Less)

S is not an essential element and is contained in steel, for example, as an impurity. S causes the precipitation of fine MnS and thereby inhibits recrystallization and the growth of crystal grains in annealing. Therefore, the S content is preferably as small as possible. An increase in the iron loss and a decrease in the magnetic flux density resulting from such inhibition of recrystallization and grain growth become significant when the S content is more than 0.0400%. Therefore, the S content is set to 0.0400% or less. The S content is preferably set to 0.0200% or less and more preferably set to 0.0100% or less. The lower limit of the S content is not particularly limited, but the S content is preferably set to 0.0003% or more based on the cost of a desulfurization treatment at the time of refining.

(N: 0.0100% or Less)

Similar to C, N degrades the magnetic characteristics, and thus the N content is preferably as small as possible. Therefore, the N content is set to 0.0100% or less. The lower limit of the N content is not particularly limited, but the N content is preferably set to 0.0010% or more based on the cost of a denitrification treatment at the time of refining.

(Sn: 0.00% to 0.40%, Sb: 0.00% to 0.40% and P: 0.00% to 0.40%)

When Sn or Sb is excessively contained, steel is embrittled. Therefore, the Sn content and the Sb content are both set to 0.40% or less. In addition, when P is excessively contained, the embrittlement of steel is caused. Therefore, the P content is set to 0.40% or less.

On the other hand, Sn and Sb have an effect of improving the texture after cold rolling or recrystallization to improve the magnetic flux density. In addition, P is an element effective for securing the hardness of the steel sheet after recrystallization. Therefore, these elements may be contained as necessary. In that case, one or more selected from the group consisting of 0.02% to 0.40% of Sn, 0.02% to 0.40% of Sb and 0.02% to 0.40% of P are preferably contained.

(Cr: 0.001% to 0.100%)

Cr bonds to oxygen in steel and forms Cr₂O₃. This Cr₂O₃ contributes to improvement in the texture. In order to obtain the above-described effect, the Cr content is set to 0.001% or more.

On the other hand, when the Cr content exceeds 0.100%, Cr₂O₃ inhibits grain growth during annealing, the grain sizes become fine, and an increase in iron loss is caused. Therefore, the Cr content is set to 0.100% or less.

(One or More Selected from the Group Consisting of Mg, Ca, Sr, Ba, Ce, La, Nd, Pr, Zn, and Cd: 0.0100% or Less in Total.)

Mg, Ca, Sr, Ba, Ce, La, Nd, Pr, Zn, and Cd react with S in molten steel during the casting of the molten steel to form the precipitate of a sulfide, an oxysulfide or both. Hereinafter, Mg, Ca, Sr, Ba, Ce, La, Nd, Pr, Zn, and Cd will be collectively referred to as “coarse precipitate forming elements” in some cases. The grain sizes in the precipitate of the coarse precipitate forming element are approximately 1 μm to 2 μm, which is significantly larger than the grain sizes (approximately 100 nm) in the fine precipitates of MnS, TiN, AlN, or the like. Therefore, these fine precipitates adhere to the precipitates of the coarse precipitate forming elements and are less likely to inhibit the growth of crystal grains in strain-induced boundary migration. In order to sufficiently obtain this effect, the total of the amounts of these coarse precipitate-forming elements is preferably 0.0005% or more.

On the other hand, when the total of the amounts of these elements exceeds 0.0100%, the total amount of the sulfide, the oxysulfide, or both becomes excessive, and the growth of crystal grains in strain-induced boundary migration is inhibited. Therefore, the amount of the coarse precipitate forming elements is set to 0.0100% or less in total.

(B: 0.0000% to 0.0050%)

B contributes to improvement in the texture in a small quantity. Therefore, B may be contained. In the case of obtaining the above-described effect, the B content is preferably set to 0.0001% or more.

On the other hand, when the B content exceeds 0.0050%, a compound of B inhibits grain growth during annealing, the grain sizes become fine, and an increase in iron loss is caused. Therefore, the B content is set to 0.0050% or less.

(O: 0.0000% to 0.0200%)

O bonds to Cr in steel and forms Cr₂O₃. This Cr₂O₃ contributes to improvement in the texture. Therefore, O may be contained. In the case of obtaining the above-described effect, the O content is preferably set to 0.0010% or more.

On the other hand, when the O content exceeds 0.0200%, Cr₂O₃ inhibits grain growth during annealing, the grain sizes become fine, and an increase in iron loss is caused. Therefore, the O content is set to 0.0200% or less.

Next, the sheet thickness of the non-oriented electrical steel sheet according to the present embodiment will be described. The thickness (sheet thickness) of the non-oriented electrical steel sheet according to the present embodiment is preferably 0.10 mm to 0.50 mm. When the thickness exceeds 0.50 mm, there are cases where it is not possible to obtain an excellent iron loss. Therefore, the thickness is preferably set to 0.50 mm or less. When the thickness is less than 0.10 mm, the influence of magnetic flux leakage from the surface of the non-oriented electrical steel sheet or the like becomes large, and there are cases where the magnetic characteristics deteriorate. In addition, when the thickness is less than 0.10 mm, there is a possibility that threading along an annealing line may become difficult or the number of non-oriented electrical steel sheets required for cores having a certain size may increase, which causes deterioration of productivity due to an increase in man-hours and an increase in the manufacturing cost. Therefore, the thickness is preferably set to 0.10 mm or more. More preferably, the thickness is 0.20 mm to 0.35 mm.

Next, the metallographic structure of the non-oriented electrical steel sheet according to the present embodiment will be described. Hereinafter, the metallographic structure of the non-oriented electrical steel sheet after skin pass rolling, the metallographic structure of the non-oriented electrical steel sheet after the first heat treatment, and the metallographic structure of the non-oriented electrical steel sheet after the second heat treatment will be described.

First, a metallographic structure to be specified and a method for specifying the same will be described. The metallographic structure to be specified in the present embodiment is a metallographic structure that is specified in a cross section parallel to the sheet surface of the steel sheet and is specified by the following procedure.

First, the steel sheet is polished so that the sheet thickness center is exposed, and a region of 2500 μm² or more on the polished surface (surface parallel to the steel sheet surface) is observed by EBSD (electron back scattering diffraction). As long as the total area is 2500 μm² or more, the observation may be performed at several sites in several divided small sections. The step intervals during measurement are desirably 50 to 100 nm. The following kinds of areas, KAM (Kernel average misorientation) values, and average grain sizes are obtained from the EBSD observation data by an ordinary method.
Sₜₒₜ: Total area (observed area)
S_{tyl}: Total area of orientated grains in which the Taylor factor M according to Formula (2) becomes more than 2.8
Sₜᵣₐ: Total area of orientated grains in which the Taylor factor M according to Formula (2) becomes 2.8 or less
S₁₀₀: Total area of {100} orientated grains
S₁₁₀: Total area of {110} orientated grains
K_{tyl}: Average KAM value of orientated grains in which the Taylor factor M according to Formula (2) becomes more than 2.8
Kₜᵣₐ: Average KAM value of orientated grains in which the Taylor factor M according to Formula (2) becomes 2.8 or less
K₁₀₀: Average KAM value of {100} orientated grains
K₁₁₀: Average KAM value of {110} orientated grains
dₐᵥₑ: Average grain size in observation region
d₁₀₀: Average grain size of {100} orientated grains
d_{tyl}: Average grain size of orientated grains in which the Taylor factor M according to Formula (2) becomes more than 2.8
dₜᵣₐ: Average grain size of orientated grains in which the Taylor factor M according to Formula (2) becomes 2.8 or less

Here, the orientation tolerance of crystal grains is set to 15°. In addition, even when orientated grains appear subsequently, the orientation tolerance is set to 15°.

Here, the Taylor factor M is assumed to follow Formula (2).

M=(cos ϕ×cos λ)⁻¹ (2)
ϕ: Angle formed by a stress vector and a slip direction vector of a crystal
λ: Angle formed by the stress vector and a normal vector of a slip plane of the crystal

The above-described Taylor factor M is a Taylor factor in the case of performing compressive deformation in the sheet thickness direction on an in-plane strain in a surface parallel to the sheet thickness direction and the rolling direction with an assumption that the slip deformation of a crystal occurs in a slip plane {110} and in a slip direction <111>. Hereinafter, unless particularly otherwise described, an average value of the Taylor factors according to Formula (2) obtained for all crystallographically equivalent crystals will be simply referred to as “Taylor factor.”

Next, in Embodiments 1 to 3 below, characteristics will be regulated by the above-described area, KAM value, and average grain size.

### Embodiment 1

First, the metallographic structure of the non-oriented electrical steel sheet after skin pass rolling will be described. This metallographic structure accumulates sufficient strain to cause strain-induced boundary migration and can be positioned as an initial stage state before strain-induced boundary migration occurs. The characteristics of the metallographic structure of the steel sheet after skin pass rolling are roughly regulated by an orientation for crystal grains in an intended orientation to develop and conditions regarding the strain sufficiently accumulated to cause strain-induced boundary migration.

In the non-oriented electrical steel sheet according to the present embodiment, the areas of predetermined orientated grains satisfy Formulas (3) to (5).

0.20≤S_{tyl}/Sₜₒₜ≤0.85 (3)

0.05≤S₁₀₀/Sₜₒₜ≤0.80 (4)

S₁₀₀/Sₜᵣₐ≥0.50 (5)

S_{tyl} is the abundance of an orientation in which the Taylor factor is sufficiently large. In the strain-induced boundary migration process, an orientation in which the Taylor factor is small and strain attributed to processing is less likely to accumulate preferentially grows while encroaching an orientation in which the Taylor factor is large and strain attributed to processing has accumulated. Therefore, in order to develop a special orientation by strain-induced boundary migration, a certain amount of S_{tyl} needs to be present. In the present embodiment, S_{tyl} is regulated as an area ratio to the total area S_{tyl}/Sₜₒₜ, and, in the present embodiment, the area ratio S_{tyl}/Sₜₒₜ is set to 0.20 or more. When the area ratio S_{tyl}/Sₜₒₜ is less than 0.20, an intended crystal orientation does not sufficiently develop by strain-induced boundary migration. The area ratio S_{tyl}/Sₜₒₜ is preferably 0.30 or more and more preferably 0.50 or more.

The upper limit of the area ratio S_{tyl}/Sₜₒₜ is associated with the abundance of crystal orientated grains that should be developed in a strain-induced boundary migration process to be described below, but the condition is not simply determined only by proportions of a preferentially-growing orientation and an orientation to be encroached. First, as described below, since the area ratio S₁₀₀/Sₜₒₜ of {100} orientated grains that should be developed by strain-induced boundary migration is 0.05 or more, the area ratio S_{tyl}/Sₜₒₜ becomes inevitably 0.95 or less. However, when the abundance of the area ratio S_{tyl}/Sₜₒₜ becomes excessive, preferential growth of the {100} orientated grains does not occur due to an association with strain to be described below. The association with the strain amount will be described in detail below; however, in the present embodiment, the area ratio S_{tyl}/Sₜₒₜ becomes 0.85 or less. The area ratio S_{tyl}/Sₜₒₜ is preferably 0.75 or less and more preferably 0.70 or less.

In the subsequent strain-induced boundary migration process, the {100} orientated grains are preferentially grown. A {100} orientation is one of orientations in which the Taylor factor is sufficiently small and strain attributed to processing is less likely to accumulate and is an orientation capable of preferentially growing in the strain-induced boundary migration process. In the present embodiment, the presence of the {100} orientated grains is essential, and, in the present embodiment, the area ratio S₁₀₀/Sₜₒₜ of the {100} orientated grains becomes 0.05 or more. When the area ratio S₁₀₀/Sₜₒₜ of the {100} orientated grains is less than 0.05, the {100} orientated grains do not sufficiently develop by subsequent strain-induced boundary migration. The area ratio S₁₀₀/Sₜₒₜ is preferably 0.10 or more and more preferably 0.20 or more.

The upper limit of the area ratio S₁₀₀/Sₜₒₜ is determined depending on the abundance of crystal orientated grains that should be encroached by strain-induced boundary migration. In the present embodiment, the area ratio S_{tyl}/Sₜₒₜ in the orientation in which the Taylor factor becomes more than 2.8, which is encroached by strain-induced boundary migration, is 0.20 or more, and thus the area ratio S₁₀₀/Sₜₒₜ becomes 0.80 or less. However, when the abundance of the {100} orientated grains before strain-induced boundary migration is small, the effect becomes significant, and it becomes possible to further develop the {100} orientated grains. In consideration of this, the area ratio S₁₀₀/Sₜₒₜ is preferably 0.60 or less, more preferably 0.50 or less, and still more preferably 0.40 or less.

As orientated grains that should be preferentially grown, the {100} orientated grains have been mainly described, but there are many other orientated grains which are an orientation in which, similar to the {100} orientated grains, the Taylor factor is sufficiently small and strain attributed to processing is less likely to accumulate and are capable of preferentially growing in strain-induced boundary migration. Such orientated grains compete with the {100} orientated grains that should be preferentially grown. On the other hand, these orientated grains do not have as many magnetization easy axis directions (<100> directions) as the {100} orientated grains in the steel sheet surface, and thus, when these orientations develop by strain-induced boundary migration, the magnetic characteristics deteriorate, which becomes disadvantageous. Therefore, in the present embodiment, it is regulated that the abundance ratio of the {100} orientated grains in the orientations in which the Taylor factor is sufficiently small and strain attributed to processing is less likely to accumulate is secured.

In the present invention, the area of the orientated grain in which the Taylor factor becomes 2.8 or less, including orientated grain considered to compete with the {100} orientated grains in strain-induced boundary migration, is indicated by Sₜᵣₐ. In addition, the area ratio S₁₀₀/Sₜᵣₐ is set to 0.50 or more as shown in Formula (5), and superiority in the growth of the {100} orientated grains is secured. When this area ratio S₁₀₀/Sₜᵣₐ is less than 0.50, the {100} orientated grains do not sufficiently develop by strain-induced boundary migration. The area ratio S₁₀₀/Sₜᵣₐ is preferably 0.80 or more and more preferably 0.90 or more. On the other hand, the upper limit of the area ratio S₁₀₀/Sₜᵣₐ does not need to be particularly limited, and the orientated grains in which the Taylor factor becomes 2.8 or less may be all the {100} orientated grains (that is, S₁₀₀/Sₜᵣₐ=1.00).

Furthermore, in the present embodiment, particularly, a relationship with the {110} orientated grains, which are known as an orientation in which grains are likely to grow by strain-induced boundary migration, is regulated. The {110} orientation is an orientation that is likely to develop relatively easily even in versatile methods in which grain sizes are increased in a hot-rolled steel sheet and grains are recrystallized by cold rolling or grains are recrystallized by cold rolling at a relatively low rolling reduction and should be particularly taken care of in the competition with the {100} orientated grains that should be preferentially grown. When the {110} orientated grains develop by strain-induced boundary migration, the steel sheet in-plane anisotropy of characteristics becomes extremely large, which becomes disadvantageous. Therefore, in the present embodiment, it is preferable to secure the superiority of the growth of the {100} orientated grains by controlling the area ratio S₁₀₀/S₁₁₀ of the {100} orientated grains to the {110} orientated grains to satisfy Formula (8).

S₁₀₀/S₁₁₀≥1.00 (8)

In order to more reliably avoid the careless development of the {110} orientated grains by strain-induced boundary migration, the area ratio S₁₀₀/S₁₁₀ is preferably 1.00 or more. The area ratio S₁₀₀/S₁₁₀ is more preferably 2.00 or more and still more preferably 4.00 or more. The upper limit of the area ratio S₁₀₀/S₁₁₀ does not need to be particularly limited, and the area ratio of the {110} orientated grains may be zero. That is, it is assumed that Formula (8) is satisfied even when the area ratio S₁₀₀/S₁₁₀ diverges to infinity.

In the present embodiment, more excellent magnetic characteristics can be obtained by combining strain to be described below in addition to the above-described crystal orientations. In the present embodiment, as a regulation regarding strain, Formula (6) needs to be satisfied.

K₁₀₀/K_{tyl}≤0.990 (6)

A requirement regarding strain is regulated by Formula (6). Formula (6) is the ratio of strain that is accumulated in the {100} orientated grains (average KAM value) to strain that is accumulated in the orientated grains in which the Taylor factor becomes more than 2.8 (average KAM value). Here, the KAM value is an orientation difference from an adjacent measurement point within the same grain, and the KAM value becomes high at a site where there is a large strain amount. From the crystallographic viewpoint, for example, in a case where compressive deformation in the sheet thickness direction is performed in a planar strain state in a surface parallel to the sheet thickness direction and the rolling direction, that is, in a case where a steel sheet is simply rolled, ordinarily, the ratio K₁₀₀/K_{tyl} of K₁₀₀ to K_{tyl} becomes smaller than 1. However, in reality, due to an influence of constraints by adjacent crystal grains, precipitates present in the crystal grains, and, furthermore, a macroscopic deformation fluctuation including contact with a tool (rolling roll or the like) during deformation, strain corresponding to a crystal orientation that is microscopically observed has various forms. Therefore, an influence of a purely geometrical orientation by the Taylor factor is less likely to appear. In addition, for example, even between grains have the same orientation, an extremely large fluctuation is formed depending on the grain sizes, the forms of the grains, the orientation or grain size of an adjacent grain, the state of a precipitate, the position in the sheet thickness direction, and the like. Furthermore, even in one crystal grain, the strain distribution significantly fluctuates depending on whether strain is present in the vicinity of the grain boundary or within the grain and the formation of a deformation band or the like.

In order to obtain excellent magnetic characteristics in the present embodiment in consideration of such fluctuations, K₁₀₀/K_{tyl} is set to 0.990 or less. When this K₁₀₀/K_{tyl} becomes more than 0.990, the specialty of a region that should be encroached is lost. Therefore, strain-induced boundary migration is less likely to occur. K₁₀₀/K_{tyl} is preferably 0.970 or less and more preferably 0.950 or less.

In the competition with the {100} orientated grains that should be preferentially grown, Formula (7) is preferably satisfied regarding a relationship with the orientated grains in which the Taylor factor becomes 2.8 or less.

K₁₀₀/Kₜᵣₐ<1.010 (7)

In order for the {100} orientated grains to preferentially grow, K₁₀₀/Kₜᵣₐ is preferably set to less than 1.010. This K₁₀₀/Kₜᵣₐ is also an index relating to competition between orientations in which strain is less likely to accumulate and which have a possibility of preferential growth, and, when K₁₀₀/Kₜᵣₐ is 1.010 or more, the priority of the {100} orientation in strain-induced boundary migration is not exhibited, and an intended crystal orientation does not develop. K₁₀₀/Kₜᵣₐ is more preferably 0.970 or less and still more preferably 0.950 or less.

In the competition with the {100} orientated grains that should be preferentially grown, it is also preferable to take strain into account in the same manner as the area regarding the relationship with the {110} orientated grains. In this relationship, it is preferable to secure the superiority of the growth of the {100} orientated grains by controlling the ratio K₁₀₀/K₁₁₀ of the average KAM values between the {100} orientated grains and the {110} orientated grains to satisfy Formula (9).

K₁₀₀/K₁₁₀<1.010 (9)

In order to more reliably avoid the careless development of the {110} orientated grains by strain-induced boundary migration, K₁₀₀/K₁₁₀ is preferably less than 1.010. K₁₀₀/K₁₁₀ is more preferably 0.970 or less and still more preferably 0.950 or less.

In Formula (9), in a case where there are no crystal grains having an orientation corresponding to the denominator, evaluation by a numerical value is not performed on the formula, and the formula is regarded as being satisfied. In the metallographic structure of the non-oriented electrical steel sheet in a state after the skin pass rolling of the present embodiment, the grain sizes are not particularly limited. This is because the relationship with the grain sizes is not so strong in a state where appropriate strain-induced boundary migration is caused by the subsequent first heat treatment. That is, whether or not intended appropriate strain-induced boundary migration occurs can be almost determined by the relationship of the abundance (area) in each crystal orientation and the relationship of the strain amount in each orientation in addition to the chemical composition of the steel sheet.

Here, when the grain sizes become too coarse, although grain growth is induced by strain, sufficient grain growth in a practical temperature range is less likely to occur. In addition, when the grain sizes become too coarse, deterioration of the magnetic characteristics also becomes difficult to avoid. Therefore, a practical average grain size is preferably set to 300 μm or less. The practical average grain size is more preferably 100 μm or less, still more preferably 50 μm or less, and particularly preferably 30 μm or less. As the grain sizes become finer, it is easier to recognize the development of an intended crystal orientation by strain-induced boundary migration when the crystal orientation and the distribution of strain have been appropriately controlled. However, when the grain size becomes too fine, it becomes difficult to form a difference in the strain amount in each crystal orientation due to constraints with adjacent grains in processing for imparting strain as described above. From this viewpoint, the average grain size is preferably 3 μm or more, more preferably 8 μm or more, and still more preferably 15 μm or more.

### Embodiment 2

Next, the metallographic structure of the non-oriented electrical steel sheet after strain-induced boundary migration is caused (and before strain-induced boundary migration is completed) by further performing the first heat treatment on the non-oriented electrical steel sheet after skin pass rolling will be described. In the non-oriented electrical steel sheet according to the present embodiment, at least a part of strain is released by strain-induced boundary migration, and the characteristics of the metallographic structure of the steel sheet after strain-induced boundary migration are regulated by crystal orientations, strain, and grain sizes.

In the non-oriented electrical steel sheet according to the present embodiment, the areas of predetermined orientated grains satisfy Formulas (10) to (12). These regulations are different in the numerical value ranges compared with Formulas (3) to (5) regarding the non-oriented electrical steel sheet after skin pass rolling. This is because, along with strain-induced boundary migration, the {100} orientated grains preferentially grow, the area thereof increases, the orientated grains in which the Taylor factor becomes more than 2.8 are mainly encroached by the {100} orientated grains, and the area thereof decreases.

S_{tyl}/Sₜₒₜ≤0.70 (10)

0.20≤S₁₀₀/Sₜₒₜ (11)

S₁₀₀/Sₜᵣₐ≥0.55 (12)

The upper limit of the area ratio S_{tyl}/Sₜₒₜ is determined as one of the parameters indicating the degree of progress of strain-induced boundary migration. When the area ratio S_{tyl}/Sₜₒₜ is more than 0.70, it is indicated that the crystal grains of the orientated grains in which the Taylor factor becomes more than 2.8 are not sufficiently encroached and the strain-induced boundary migration does not sufficiently occur. That is, since development of the {100} orientated grains that should be developed is not sufficient, the magnetic characteristics do not sufficiently improve. Therefore, in the present embodiment, the area ratio S_{tyl}/Sₜₒₜ is set to 0.70 or less. The area ratio S_{tyl}/Sₜₒₜ is preferably 0.60 or less and more preferably 0.50 or less. Since the area ratio S_{tyl}/Sₜₒₜ is preferably as small as possible, the lower limit does not need to be regulated and may be 0.00.

In addition, in the present embodiment, the area ratio S₁₀₀/Sₜₒₜ is set to 0.20 or more. The lower limit of the area ratio S₁₀₀/Sₜₒₜ is determined as one of the parameters indicating the degree of progress of strain-induced boundary migration, and, when the area ratio S₁₀₀/Sₜₒₜ is less than 0.20, development of the {100} orientated grains is not sufficient, and thus the magnetic characteristics do not sufficiently improve. The area ratio S₁₀₀/Sₜₒₜ is preferably 0.40 or more and more preferably 0.60 or more. Since the area ratio S₁₀₀/Sₜₒₜ is preferably as high as possible, the upper limit does not need to be regulated and may be 1.00.

Similar to Embodiment 1, a relationship between orientated grains that are considered to compete with the {100} orientated grains in strain-induced boundary migration and the {100} orientated grains is also important. In a case where the area ratio S₁₀₀/Sₜᵣₐ is large, the superiority of the growth of the {100} orientated grains is secured, and the magnetic characteristics become favorable. When this area ratio S₁₀₀/Sₜᵣₐ is less than 0.55, it indicates a state where the {100} orientated grains are not sufficiently developed by strain-induced boundary migration and the orientated grains in which the Taylor factor becomes more than 2.8 have been encroached by orientations in which the Taylor factor is small other than the {100} orientated grains. In this case, the in-plane anisotropy of the magnetic characteristics also becomes large. Therefore, in the present embodiment, the area ratio S₁₀₀/Sₜᵣₐ is set to 0.55 or more. The area ratio S₁₀₀/Sₜᵣₐ is preferably 0.65 or more and more preferably 0.75 or more. On the other hand, the upper limit of the area ratio S₁₀₀/Sₜᵣₐ does not need to be particularly limited, and the orientated grains in which the Taylor factor becomes 2.8 or less may be all the {100} orientated grains.

Furthermore, in the present embodiment, similar to Embodiment 1, a relationship with the {110} orientated grains is also regulated. In the present embodiment, it is preferable that the area ratio S₁₀₀/S₁₁₀ of the {100} orientated grains to the {110} orientated grains satisfies Formula (18), and superiority of the growth of the {100} orientated grains be secured.

S₁₀₀/S₁₁₀≥1.00 (18)

As shown in Formula (18), in the present embodiment, the area ratio S₁₀₀/S₁₁₀ is preferably 1.00 or more. When the {110} orientated grains develop by strain-induced boundary migration and this area ratio S₁₀₀/S₁₁₀ becomes less than 1.00, the anisotropy in the steel sheet surface becomes extremely large, which is likely to become disadvantageous in terms of characteristics. The area ratio S₁₀₀/S₁₁₀ is more preferably 2.00 or more and still more preferably 4.00 or more. The upper limit of the area ratio S₁₀₀/S₁₁₀ does not need to be particularly limited, and the area ratio of the {110} orientated grains may be zero. That is, it is assumed that Formula (18) is satisfied even when the area ratio S₁₀₀/S₁₁₀ diverges to infinity.

Next, a regulation regarding strain that should be satisfied in the present embodiment will be described. The strain amount in the non-oriented electrical steel sheet according to the present embodiment significantly decreases compared with the strain amount in the state after the skin pass rolling described in Embodiment 1 and is in a state of having a characteristic in the strain amount in each crystal orientation.

The regulation regarding strain in the present embodiment is different in the numerical value range compared with Formula (6) regarding the steel sheet after the skin pass rolling and satisfies Formula (13).

K₁₀₀/K_{tyl}≤1.010 (13)

When strain-induced boundary migration sufficiently progresses, a large part of strain in the steel sheet is in a released status, strain in each crystal orientation is made uniform, the fluctuation of strain becomes sufficiently small, and the ratio shown in Formula (13) becomes a value close to 1.

In order to obtain excellent magnetic characteristics in the present embodiment in consideration of such fluctuations, K₁₀₀/K_{tyl} is set to 1.010 or less. When the K₁₀₀/K_{tyl} is more than 1.010, since release of strain is not sufficient, particularly, reduction in the iron loss becomes insufficient. K₁₀₀/K_{tyl} is preferably 0.990 or less and more preferably 0.970 or less. Although the non-oriented electrical steel sheet according to the present embodiment is obtained by performing the first heat treatment on a steel sheet satisfying Formula (6), it is also conceivable that the value of Formula (13) may exceed 1.000 due to a measurement error or the like.

In the competition with the {100} orientated grains that should be preferentially grown, Formula (16) is preferably satisfied regarding a relationship with the orientated grains in which the Taylor factor becomes 2.8 or less.

K₁₀₀/Kₜᵣₐ<1.010 (16)

In order for the {100} orientated grains to preferentially grow, K₁₀₀/Kₜᵣₐ is preferably set to less than 1.010. When this K₁₀₀/Kₜᵣₐ is 1.010 or more, release of strain is not sufficient, and, in particular, reduction in the iron loss becomes insufficient. The first heat treatment is performed on the non-oriented electrical steel sheet satisfying Formula (7), whereby a non-oriented electrical steel sheet satisfying Formula (16) is obtained.

In Embodiment 1, it has been described that the relationship with strain in the {110} orientated grains is preferably taken into account. On the other hand, the present embodiment is a status where strain-induced boundary migration has sufficiently progressed and a large part of strain in the steel sheet has been released. Therefore, the value of K₁₁₀ corresponding to strain that is accumulated in the {110} orientated grains becomes a value at which strain has been released to approximately the same extent as K₁₀₀, and, similar to Formula (9), Formula (19) is preferably satisfied.

K₁₀₀/K₁₁₀<1.010 (19)

That is, similar to Formula (9), K₁₀₀/K₁₁₀ is preferably less than 1.010. When this K₁₀₀/K₁₁₀ is 1.010 or more, there are cases where release of strain is not sufficient and, in particular, reduction in the iron loss becomes insufficient. The first heat treatment is performed on the non-oriented electrical steel sheet satisfying Formula (9), whereby a non-oriented electrical steel sheet satisfying Formula (19) is obtained.

In Formula (13) and Formula (19), in a case where there are no crystal grains having an orientation corresponding to the denominator, evaluation by a numerical value is not performed on the formula, and the formula is regarded as being satisfied.

Next, a regulation regarding grain sizes that should be satisfied in the present embodiment will be described. In a metallographic structure in a status where strain-induced boundary migration has sufficiently progressed and a large part of strain has been released, grain sizes in each crystal orientation have a significant influence on the magnetic characteristics. Crystal grains in an orientation in which the crystal grains are preferentially grown by strain-induced boundary migration become coarse, and crystal grains in an orientation that is encroached by this become fine. In the present embodiment, the relationships between average grain sizes are set to satisfy Formula (14) and Formula (15).

d₁₀₀/dₐᵥₑ>1.00 (14)

d₁₀₀/d_{tyl}>1.00 (15)

These formulas indicate that the average grain size d₁₀₀ of the {100} orientated grains, which are preferentially grown orientation, is relatively large. These ratios in Formula (14) and Formula (15) are preferably 1.30 or more, more preferably 1.50 or more, and still more preferably 2.00 or more. The upper limits of these ratios are not particularly limited. Although the growth rate of the crystal grains in the orientation to be encroached is slow compared with that of the {100} orientated grains, the grains grow during the first heat treatment, and thus the ratios are less likely to become excessively large, and a practical upper limit is approximately 10.00.

In addition, in the present embodiment, Formula (17) is preferably satisfied.

d₁₀₀/dₜᵣₐ>1.00 (17)

This formula indicates that the average grain size d₁₀₀ of the {100} orientated grains, which are preferentially grown orientation, is relatively large. This ratio in Formula (17) is more preferably 1.30 or more, still more preferably 1.50 or more, and particularly preferably 2.00 or more. The upper limit of this ratio is not particularly limited. Although the growth rate of the crystal grains in the orientation to be encroached is slow compared with that of the {100} orientated grains, the grains grow during the first heat treatment, and thus the ratios are less likely to become excessively large, and a practical upper limit is approximately 10.00.

In addition, the range of the average grain size is not particularly limited; however, when the average grain size becomes too coarse, it also becomes difficult to avoid deterioration of the magnetic characteristics. Therefore, the practical average grain size of the {100} orientated grains, which are relatively coarse grains in the present embodiment, is preferably set to 500 μm or less. The average grain size of the {100} orientated grains is more preferably 400 μm or less, still more preferably 300 μm or less, and particularly preferably 200 μm or less. On the other hand, regarding the lower limit of the average grain size of the {100} orientated grains, with an assumption of a state where sufficient preferential growth of the {100} orientation is secured, the average grain size of the {100} orientated grains is preferably 40 μm or more, more preferably 60 μm or more, and still more preferably 80 μm or more.

In Formula (15), in a case where there are no crystal grains having an orientation corresponding to the denominator, evaluation by a numerical value is not performed on the formula, and the formula is regarded as being satisfied.

### Embodiment 3

In Embodiments 1 and 2, characteristics of a steel sheet have been regulated by specifying the strain in the steel sheet with the KAM value. In contrast, in the present embodiment, a steel sheet obtained by annealing the steel sheet according to Embodiment 1 or 2 for a sufficiently long time and, furthermore, growing grains will be regulated. Since strain-induced boundary migration is almost completed, and, as a result, strain is almost completely released, such a steel sheet becomes extremely preferable in terms of characteristics. That is, a steel sheet in which the {100} orientated grains are grown by strain-induced boundary migration and further normally grown by the second heat treatment until strain is almost completely released becomes a steel sheet in which accumulation in the {100} orientation is stronger. In the present embodiment, the crystal orientations and grain sizes of a steel sheet obtained by performing the second heat treatment using the steel sheet according to Embodiment 1 or 2 as a material (that is, a non-oriented electrical steel sheet obtained by performing the first heat treatment and then performing the second heat treatment on the non-oriented electrical steel sheet after skin pass rolling or a non-oriented electrical steel sheet obtained by performing the second heat treatment without the first heat treatment after skin pass rolling) will be described.

In the steel sheet obtained by performing the second heat treatment (non-oriented electrical steel sheet), the area of each kind of orientated grains satisfies Formulas (20) to (22). These regulations are different in the numerical value range compared with Formulas (3) to (5) relating to the above-described steel sheet after skin pass rolling and Formulas (10) to (12) relating to the steel sheet after strain-induced boundary migration by the first heat treatment. Along with strain-induced boundary migration and the subsequent second heat treatment, the {100} orientated grains further grow, the area thereof increases, the orientated grains in which the Taylor factor becomes more than 2.8 are mainly encroached by the {100} orientated grains, and the area thereof further decreases.

S_{tyl}/Sₜₒₜ<0.55 (20)

S₁₀₀/Sₜₒₜ>0.30 (21)

S₁₀₀/Sₜᵣₐ≥0.60 (22)

In the present embodiment, the area ratio S_{tyl}/Sₜₒₜ is set to less than 0.55. The total area S_{tyl} may be zero. The upper limit of the area ratio S_{tyl}/Sₜₒₜ is determined as one of the parameters indicating the degree of progress of the growth of the {100} orientated grains. When the area ratio S_{tyl}/Sₜₒₜ is 0.55 or more, it is indicated that the orientated grains in which the Taylor factor becomes more than 2.8 that should be encroached in the stage of strain-induced boundary migration are not sufficiently encroached. In this case, the magnetic characteristics do not sufficiently improve. The area ratio S_{tyl}/Sₜₒₜ is preferably 0.40 or less and more preferably 0.30 or less. Since the area ratio S_{tyl}/Sₜₒₜ is preferably as small as possible, the lower limit is not regulated and may be 0.00.

In addition, in the present embodiment, the area ratio S₁₀₀/Sₜₒₜ is set to more than 0.30. When the area ratio S₁₀₀/Sₜₒₜ is 0.30 or less, the magnetic characteristics do not sufficiently improve. The area ratio S₁₀₀/Sₜₒₜ is preferably 0.40 or more and more preferably 0.50 or more. A status where the area ratio S₁₀₀/Sₜₒₜ is 1.00 is a status where all crystal structures are the {100} orientated grains and no other orientated grains are present, and the present embodiment also covers this status.

Similar to Embodiments 1 and 2, a relationship between orientated grains that are considered to have competed with the {100} orientated grains in strain-induced boundary migration and the {100} orientated grains is also important. In a case where the area ratio S₁₀₀/Sₜᵣₐ is sufficiently large, even in a status of normal grain growth after strain-induced boundary migration, the superiority of the growth of the {100} orientated grains is secured, and the magnetic characteristics become favorable. When this area ratio S₁₀₀/Sₜᵣₐ is less than 0.60, the {100} orientated grains are not sufficiently developed by strain-induced boundary migration, the orientated grains having a small Taylor factor other than the {100} orientated grains have grown to a considerable extent in the status of normal grain growth after strain-induced boundary migration, and the in-plane anisotropy of the magnetic characteristics also become large. Therefore, in the present embodiment, the area ratio S₁₀₀/Sₜᵣₐ is set to 0.60 or more. The area ratio S₁₀₀/Sₜᵣₐ is preferably 0.70 or more and more preferably 0.80 or more. On the other hand, the upper limit of the area ratio S₁₀₀/Sₜᵣₐ does not need to be particularly limited, and the orientated grains in which the Taylor factor becomes 2.8 or less may be all the {100} orientated grains.

In a metallographic structure in a status where strain-induced boundary migration and subsequent normal grain growth have sufficiently progressed and almost all strain in a steel sheet has been released as well, grain sizes in each crystal orientation have a significant influence on the magnetic characteristics. The {100} orientated grains that have preferentially grown at the time of strain-induced boundary migration become coarse crystal grains even after normal grain growth. In the present embodiment, the relationships between average grain sizes are set to satisfy Formula (23) and Formula (24).

d₁₀₀/dₐᵥₑ≥0.95 (23)

d₁₀₀/d_{tyl}≥0.95 (24)

These formulas indicate that the average grain size d₁₀₀ of the {100} orientated grains is 0.95 times or more the average grain size of other grains. These ratios in Formula (23) and Formula (24) are preferably 1.00 or more, more preferably 1.10 or more, and still more preferably 1.20 or more. The upper limits of these ratios are not particularly limited. Although crystal grains other than the {100} orientated grains also grow during normal grain growth, at the time when normal grain growth begins, that is, at a time when strain-induced boundary migration ends, the {100} orientated grains are coarse and have a so-called size advantage. Since the coarsening of the {100} orientated grain even in the normal grain growth process is advantageous, the above-described ratios hold sufficiently characteristic ranges. Therefore, the practical upper limits are approximately 10.00. When any of these ratios exceeds 10.00, grains become duplex grains, and a problem in association with processing such as punching occurs in some cases.

Furthermore, it is preferable that the Formula (25) is also satisfied in relation to the average grain size.

d₁₀₀/dₜᵣₐ≥0.95 (25)

This formula indicates that the average grain size d₁₀₀ of the {100} orientated grains, which are a preferentially grown orientation, is relatively large. This ratio in Formula (25) is more preferably 1.00 or more, still more preferably 1.10 or more, and particularly preferably 1.20 or more. The upper limit of this ratio is not particularly limited. Although crystal grains other than the {100} orientated grains also grow during normal grain growth, at the time when normal grain growth begins, that is, at a time when strain-induced boundary migration ends, the {100} orientated grains are coarse and have a so-called size advantage. Since the coarsening of the {100} orientated grain even in the normal grain growth process is advantageous, the above-described ratios hold sufficiently characteristic ranges. Therefore, the practical upper limits are approximately 10.00. When any of these ratios exceeds 10.00, grains become duplex grains, and a problem in association with processing such as punching occurs in some cases.

In addition, the range of the average grain size is not particularly limited; however, when the average grain size becomes too coarse, it also becomes difficult to avoid deterioration of the magnetic characteristics. Therefore, similar to Embodiment 2, the practical average grain size of the {100} orientated grains, which are relatively coarse grains in the present embodiment, is preferably set to 500 μm or less. The average grain size of the {100} orientated grains is more preferably 400 μm or less, still more preferably 300 μm or less, and particularly preferably 200 μm or less. On the other hand, regarding the lower limit of the average grain size of the {100} orientated grains, with an assumption of a state where sufficient preferential growth of the {100} orientation is secured, the average grain size of the {100} orientated grains is preferably 40 μm or more, more preferably 60 μm or more, and still more preferably 80 μm or more.

In Formula (24), in a case where there are no crystal grains having an orientation corresponding to the denominator, evaluation by a numerical value is not performed on the formula, and the formula is regarded as being satisfied.

[Characteristics]

In the non-oriented electrical steel sheet according to the present embodiment, since the chemical composition and the metallographic structure are controlled as described above, excellent magnetic characteristics (low iron loss) can be obtained even after shearing.

In addition, in the case of considering application to motors, the anisotropy of the iron loss is preferably small. Therefore, W15/50 (C)/W15/50(L), which is a ratio of W15/50 in a C direction (width direction) to W15/50 in an L direction (rolling direction), is preferably less than 1.3.

Magnetic measurement may be performed by a measuring method described in JIS C 2550-1 (2011) and JIS C 2550-3 (2019) or may be performed by a measuring method described in JIS C 2556 (2015). In addition, in a case where the sample is fine and the measurement described in the above-described JIS is not possible, electromagnetic circuits may be measured using a device capable of measuring a 55 mm×55 mm test piece according to JIS C 2556 (2015) or a finer test piece.

[Manufacturing Method]

Next, a method for manufacturing the non-oriented electrical steel sheet according to the present embodiment will be described. The non-oriented electrical steel sheet according to the present embodiment is obtained by manufacturing steps including a hot rolling step, a hot-rolled sheet annealing step, a cold rolling step, an intermediate annealing step, and a skin pass rolling step.

In addition, another non-oriented electrical steel sheet according to the present embodiment is obtained by manufacturing steps including a hot rolling step, a hot-rolled sheet annealing step, a cold rolling step, an intermediate annealing step, a skin pass rolling step, and a first heat treatment.

In addition, still another non-oriented electrical steel sheet according to the present embodiment is obtained by manufacturing methods including a hot rolling step, a hot-rolled sheet annealing step, a cold rolling step, an intermediate annealing step, a skin pass rolling step, a first heat treatment step that is performed as necessary, and a second heat treatment step.

[Hot Rolling Step]

First, a steel material having the above-described chemical composition is heated and hot-rolled. The steel material is, for example, a slab that is manufactured by normal continuous casting. For example, the slab heating temperature during hot rolling is around 1150° C. (1100° C. to 1200° C.), the finish rolling temperature is around 850° C. (750° C. to 950° C.), and the coiling temperature is around 600° C. (500° C. to 700° C.).

[Hot-Rolled Sheet Annealing Step]

After that, on the steel sheet after the hot rolling (hot-rolled steel sheet), for example, hot-rolled sheet annealing is performed at higher than 1000° C. to 1100° C. for 1 to 100 seconds. When the hot-rolled sheet annealing temperature is 1000° C. or lower, the formation of {111} orientated grains is promoted more than {100} orientated grains, which makes it difficult to obtain a preferable texture.

[Cold Rolling Step]

Next, on the hot-rolled steel sheet, pickling and cold rolling are performed. In the cold rolling, the rolling reduction is preferably set to 90% to 95%. When the rolling reduction is smaller than 90%, the number of the {111} orientated grains having inferior magnetic characteristics increases during recrystallization.

[Intermediate Annealing Step]

On the steel sheet after the cold rolling (cold-rolled steel sheet), intermediate annealing is performed. In the present embodiment, for example, intermediate annealing is performed at a temperature of 700° C. to 900° C. for 1 second to 100 seconds. When the grain sizes before cold rolling are 200 μm or more and cold rolling is performed at a rolling reduction of 90%, many {100} orientated grains are preferentially recrystallized in the rolled structure. When the temperature of the intermediate annealing is too lower, recrystallization does not occur, the {100} orientated grains are not sufficiently grown, and there are cases where the magnetic flux density does not become high. In addition, when the temperature of the intermediate annealing is higher than 900° C., the crystal grains become too large and are less likely to grow during the subsequent skin pass rolling and strain-induced boundary migration, and it becomes difficult to grow the {100} orientated grains. Therefore, the temperature in the intermediate annealing is preferably set to 700° C. to 900° C.

[Skin Pass Rolling Step]

On the steel sheet after the intermediate annealing, skin pass rolling is performed. When rolling is performed in a state where the number of the {100} crystal grains is large as described above, the {100} crystal grains further grow. The rolling reduction of the skin pass rolling is preferably 5% to 25%.

In a case where the non-oriented electrical steel sheet is made to have the above-described distribution of strain, when the rolling reduction (%) of the cold rolling is indicated by Rm, and the rolling reduction (%) at the time of the skin pass rolling is indicated by Rs, the rolling reductions of the cold rolling and the skin pass rolling are more preferably adjusted such that 90<Rm<95 and 5<Rs<20 are satisfied.

[First Heat Treatment Step]

Subsequently, a first heat treatment for promoting strain-induced boundary migration is performed. The first heat treatment is preferably performed at 700° C. to 950° C. for 1 second to 100 seconds.

When the heat treatment temperature is lower than 700° C., strain-induced boundary migration does not occur. In addition, at higher than 950° C., not only strain-induced boundary migration but also normal grain growth occurs, and it becomes impossible to obtain the metallographic structure described in Embodiment 2.

In addition, when the heat treatment time (holding time) is longer than 100 seconds, the production efficiency significantly drops, which is not realistic. Since it is not industrially easy to set the holding time to shorter than 1 second, the holding time is set to 1 second or longer.

[Second Heat Treatment Step]

The second heat treatment is preferably performed for 1 second to 100 seconds within a temperature range of 950° C. to 1050° C. or performed for longer than 1000 seconds within a temperature range of 700° C. to 900° C. The second heat treatment may be performed on the steel sheet after the skin pass rolling step for which the first heat treatment is skipped or may be performed on the steel sheet after the first heat treatment step.

When the heat treatments are performed within the above-described temperature range for the above-described time, in a case where the first heat treatment has been skipped, normal grain growth occurs after strain-induced boundary migration, and, depending on the conditions of the first heat treatment, there are cases where strain-induced boundary migration occurs in the subsequent second heat treatment.

The non-oriented electrical steel sheet according to the present embodiment can be manufactured as described above. However, this manufacturing method is an example of the method for manufacturing the non-oriented electrical steel sheet according to the present embodiment and does not limit manufacturing methods.

### EXAMPLES

Next, the non-oriented electrical steel sheet of the present invention will be specifically described while describing examples. The examples to be described below are simply examples of the non-oriented electrical steel sheet of the present invention, and the non-oriented electrical steel sheet of the present invention is not limited to the following examples.

### First Example

Molten steel was cast, thereby producing ingots having chemical compositions shown in Table 1A below. Here, the column “Left side of Formula (1)” indicates the values of the left side of Formula (1) described above. After that, the produced ingots were hot-rolled by being heated up to 1150° C. and rolled such that the sheet thicknesses became as shown in Table 1B. In addition, after the end of finish rolling, the hot-rolled steel sheets were cooled with water and coiled. The temperatures (finish temperatures) in a stage of the final pass of the finish rolling at this time were 830° C., and the coiling temperatures were within a range of 500° C. to 700° C.

Next, hot-rolled sheet annealing was performed on the hot-rolled steel sheets under conditions shown in Table 1B for 30 seconds, scales were removed by pickling, and cold rolling was performed at rolling reductions shown in Table 1B. In addition, intermediate annealing was performed in a non-oxidizing atmosphere at 800° C. for 30 seconds. Next, the second round of cold rolling (skin pass rolling) was performed at rolling reductions shown in Table 1B. Although not shown in the table, the average grain sizes after the skin pass rolling were in a range of 25 to 30 μm.

Next, in order to investigate the texture, a part of each of the steel sheets was cut, the cut test piece was processed to reduce the thickness to ½, and EBSD observation (step intervals: 100 nm) was performed on the processed surface (surface parallel to the steel sheet surface) in the above-described manner. The areas and average KAM values of kinds shown in Table 2 were obtained by EBSD observation.

In addition, as a second heat treatment, annealing was performed on the steel sheets at 800° C. for 2 hours. From each of the steel sheets after the second heat treatment, 55 mm×55 mm sample pieces were collected as measurement samples. The samples were collected using a shearing machine. Additionally, as magnetic characteristics, the iron losses W10/400 (the average value of energy losses generated in the rolling direction and in the width direction in the test piece during excitation at a maximum magnetic flux density of 1.0 T and a frequency of 400 Hz), W15/50 (C) (the value of an energy loss generated in the width direction in the test piece during excitation at a maximum magnetic flux density of 1.5 T and a frequency of 50 Hz), and W15/50 (L) (the value of an energy loss generated in the rolling direction in the test piece during excitation at a maximum magnetic flux density of 1.5 T and a frequency of 50 Hz) were measured according to JIS C 2556 (2015).

In addition, W15/50 (C) was divided by W15/50 (L) to obtain W15/50 (C)/W15/50 (L).

The measurement results are shown in Table 2.

TABLE 1A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Left |
| | | | | | | | | | | | | | | | | | side |
| | | | | | | | | | | | | | | | | | of |
| | | | | | | | | | | | | | | | | | For- |
| | | | | | | | | | | | | | | | | | mula |
| No. | C | Si | sol. Al | S | N | Mn | Ni | Co | Pt | Pb | Cu | Au | Cr | Mg | B | O | (1) |
| 101 | 0.0009 | 3.20 | 0.59 | 0.0019 | 0.0018 | 0.21 | — | — | — | — | — | — | 0.003 | — | — | — | −3.58 |
| 102 | 0.0010 | 3.19 | 0.60 | 0.0021 | 0.0021 | — | 0.21 | — | — | — | — | — | 0.002 | — | — | — | −3.59 |
| 103 | 0.0010 | 3.19 | 0.59 | 0.0020 | 0.0019 | — | — | 0.20 | — | — | — | — | 0.004 | — | — | — | −3.58 |
| 104 | 0.0010 | 3.20 | 0.61 | 0.0020 | 0.0021 | — | — | — | 0.20 | — | — | — | 0.004 | — | — | — | −3.60 |
| 105 | 0.0009 | 3.20 | 0.59 | 0.0022 | 0.0021 | — | — | — | — | 0.20 | — | — | 0.003 | — | — | — | −3.59 |
| 106 | 0.0009 | 3.21 | 0.59 | 0.0018 | 0.0016 | — | — | — | — | — | 0.19 | — | 0.003 | — | — | — | −3.61 |
| 107 | 0.0011 | 3.19 | 0.60 | 0.0021 | 0.0022 | — | — | — | — | — | — | 0.19 | 0.004 | — | — | — | −3.60 |
| 108 | 0.0010 | 2.01 | 0.31 | 0.0022 | 0.0024 | 2.40 | — | — | — | — | — | — | 0.003 | — | — | — | 0.09 |
| 109 | 0.0009 | 3.20 | 0.59 | 0.0019 | 0.0019 | 0.20 | — | — | — | — | — | — | 0.003 | — | — | — | −3.59 |
| 110 | 0.0009 | 3.20 | 0.61 | 0.0018 | 0.0017 | 0.20 | — | — | — | — | — | — | 0.002 | — | — | — | −3.61 |
| 111 | 0.0011 | 3.21 | 0.59 | 0.0020 | 0.0020 | 0.20 | — | — | — | — | — | — | 0.003 | — | — | — | −3.60 |
| 112 | 0.0010 | 3.19 | 0.59 | 0.0019 | 6.0019 | 0.21 | — | — | — | — | — | — | 0.003 | — | — | — | −3.58 |
| 113 | 0.0009 | 3.19 | 0.59 | 0.0018 | 0.0018 | 0.21 | — | — | — | — | — | — | 0.002 | — | — | — | −3.58 |
| 114 | 0.0011 | 3.19 | 0.60 | 0.0018 | 0.0019 | 0.19 | — | — | — | — | — | — | 0.003 | — | — | — | −3.60 |
| 115 | 0.0008 | 3.19 | 0.60 | 0.0020 | 0.0016 | 0.22 | — | — | — | — | — | — | 0.003 | — | — | — | −3.57 |
| 116 | 0.0011 | 3.20 | 0.60 | 0.0019 | 0.0019 | 0.20 | — | — | — | — | — | — | 0.002 | — | — | — | −3.60 |
| 117 | 0.0010 | 3.19 | 0.58 | 0.0018 | 0.0019 | 0.22 | — | — | — | — | — | — | 0.003 | — | — | — | −3.56 |
| 118 | 0.0011 | 3.19 | 0.58 | 0.0017 | 0.0017 | 0.21 | — | — | — | — | — | — | 0.004 | — | — | — | −3.57 |
| 119 | 0.0010 | 3.21 | 0.60 | 0.0020 | 0.0018 | 0.21 | — | — | — | — | — | — | 0.003 | — | — | — | −3.60 |
| 120 | 0.0010 | 3.19 | 0.59 | 0.0019 | 0.0019 | 0.21 | — | — | — | — | — | — | 0.003 | — | — | — | −3.57 |
| 121 | 0.0008 | 3.21 | 0.60 | 0.0018 | 0.0016 | 0.21 | — | — | — | — | — | — | 0.003 | — | — | — | −3.60 |
| 122 | 0.0010 | 3.20 | 0.60 | 0.0018 | 0.0019 | 0.20 | — | — | — | — | — | — | 0.004 | — | — | — | −3.59 |
| 123 | 0.0009 | 3.20 | 0.60 | 0.0020 | 0.0019 | 0.21 | — | — | — | — | — | — | 0.004 | — | — | — | −3.60 |
| 124 | 0.0085 | 3.23 | 0.60 | 0.0017 | 0.0021 | 0.21 | — | — | — | — | — | — | 0.003 | — | — | — | −3.62 |
| 125 | 0.0008 | 1.61 | 0.60 | 0.0020 | 0.0019 | 0.22 | | | | | | | 0.003 | | | | 1.99 |
| 126 | 0.0008 | 3.90 | 0.59 | 0.0017 | 0.0020 | 0.21 | — | — | — | — | — | — | 0.003 | — | — | — | −4.28 |
| 127 | 0.0011 | 3.22 | 0.00 | 0.0021 | 0.0019 | 0.22 | — | — | — | — | — | — | 0.004 | — | — | — | −3.00 |
| 128 | 0.0008 | 3.23 | 2.80 | 0.0018 | 0.0019 | 0.22 | — | — | — | — | — | — | 0.004 | — | — | — | −5.81 |
| 129 | 0.0010 | 3.23 | 0.60 | 0.0003 | 0.0019 | 0.21 | — | — | — | — | — | — | 0.003 | — | — | — | −3.62 |
| 130 | 0.0008 | 3.23 | 0.60 | 0.0090 | 0.0021 | 0.22 | — | — | — | — | — | — | 0.004 | — | — | — | −3.60 |
| 131 | 0.0011 | 3.22 | 0.60 | 0.0018 | 0.0093 | 0.21 | — | — | — | — | — | — | 0.004 | — | — | — | −3.61 |
| 132 | 0.0008 | 3.23 | 0.61 | 0.0018 | 0.0021 | 0.21 | — | — | — | — | — | — | 0.004 | 0.0005 | — | — | −3.63 |
| 133 | 0.0008 | 3.22 | 0.61 | 0.0351 | 0.0020 | 0.21 | — | — | — | — | — | — | 0.004 | 0.0093 | — | — | −3.62 |
| 134 | 0.0009 | 3.22 | 0.60 | 0.0020 | 0.0018 | 0.22 | — | — | — | — | — | — | 0.001 | — | — | — | −3.60 |
| 135 | 0.0008 | 3.22 | 0.61 | 0.0017 | 0.0020 | 0.23 | — | — | — | — | — | — | 0.094 | — | — | — | −3.60 |
| 136 | 0.0009 | 3.23 | 0.61 | 0.0019 | 0.0022 | 0.22 | — | — | — | — | — | — | 0.003 | — | — | — | −3.61 |
| 137 | 0.0009 | 3.21 | 2.80 | 0.0018 | 0.0020 | 2.40 | — | — | — | — | — | — | 0.003 | — | — | — | −3.62 |
| 138 | 0.0008 | 3.19 | 0.59 | 0.0020 | 0.0019 | 0.21 | — | — | — | — | — | — | 0.002 | — | 0.0002 | — | −3.58 |
| 139 | 0.0009 | 3.19 | 0.60 | 0.0017 | 0.0016 | 0.21 | — | — | — | — | — | — | 0.003 | — | 0.0045 | — | −3.58 |
| 140 | 0.0008 | 3.20 | 0.60 | 0.0018 | 0.0019 | 0.21 | — | — | — | — | — | — | 0.003 | — | | 0.0013 | −3.58 |
| 141 | 0.0009 | 3.21 | 0.59 | 0.0018 | 0.0019 | 0.21 | — | — | — | — | — | — | 0.002 | — | — | 0.0170 | −3.58 |
| 142 | 0.0118 | 3.22 | 0.60 | 0.0020 | 0.0019 | 0.20 | — | — | — | — | — | — | 0.002 | — | — | — | −3.62 |
| 143 | 0.0008 | 1.40 | 0.60 | 0.0018 | 0.0018 | 0.20 | — | — | — | — | — | — | 0.002 | — | — | — | −1.80 |
| 144 | 0.0011 | 4.21 | 0.60 | 0.0017 | 0.0020 | 0.20 | — | — | — | — | — | — | 0.003 | — | — | — | −4.61 |
| 145 | 0.0009 | 3.23 | 4.20 | 0.0017 | 0.0020 | 0.20 | — | — | — | — | — | — | 0.003 | — | — | — | −7.23 |
| 146 | 0.0011 | 3.22 | 0.61 | 0.0450 | 0.0020 | 0.21 | — | — | — | — | — | — | 0.004 | — | — | — | −3.62 |
| 147 | 0.0010 | 3.23 | 0.61 | 0.0019 | 0.0119 | 0.21 | — | — | — | — | — | — | 0.003 | — | — | — | −3.63 |
| 148 | 0.0008 | 3.23 | 0.60 | 0.0017 | 0.0021 | 0.21 | — | — | — | — | — | — | 0.000 | — | — | — | −3.62 |
| 149 | 0.0009 | 3.22 | 0.60 | 0.0018 | 0.0020 | 0.22 | — | — | — | — | — | — | 0.119 | — | — | — | −3.61 |
| 150 | 0.0010 | 3.22 | 0.61 | 0.0017 | 0.0018 | 2.60 | — | — | — | — | — | — | 0.004 | — | — | — | −1.24 |
| 151 | 0.0009 | 3.20 | 0.59 | 0.0017 | 0.0018 | 0.21 | — | — | — | — | — | — | 0.002 | — | — | — | −3.58 |

TABLE 1B

| | After hot | Hot-rolled sheet | | | |
|---|---|---|---|---|---|
| | rolling | annealing | | | |
| | Sheet | Annealing | Rolling reduction (%) | | |
| | thickness | temperature | Cold | Skin pass | |
| No. | (mm) | (° C.) | rolling | rolling | Note |
| 101 | 2.50 | 1050 | 92 | 10 | Invention Example |
| 102 | 2.50 | 1050 | 92 | 10 | Invention Example |
| 103 | 2.50 | 1050 | 92 | 10 | Invention Example |
| 104 | 2.50 | 1050 | 92 | 10 | Invention Example |
| 105 | 2.50 | 1050 | 92 | 10 | Invention Example |
| 106 | 2.50 | 1050 | 92 | 10 | Invention Example |
| 107 | 2.50 | 1050 | 92 | 10 | Invention Example |
| 108 | 2.50 | 1050 | 92 | 10 | Comparative Example |
| 109 | 2.50 | 850 | 92 | 10 | Comparative Example |
| 110 | 1.33 | 850 | 85 | 10 | Comparative Example |
| 111 | 0.50 | 1050 | 60 | 10 | Comparative Example |
| 112 | 2.50 | 1050 | 92 | 3 | Comparative Example |
| 113 | 2.50 | 1050 | 92 | 15 | Invention Example |
| 114 | 2.50 | 1050 | 92 | 25 | Invention Example |
| 115 | 2.50 | 1002 | 92 | 10 | Invention Example |
| 116 | 2.50 | 1100 | 92 | 10 | Invention Example |
| 117 | 2.50 | 950 | 92 | 10 | Comparative Example |
| 118 | 2.50 | 1050 | 95 | 10 | Invention Example |
| 119 | 2.50 | 1050 | 97 | Cracking | Comparative Example |
| | | | | occurs during | |
| | | | | cold rolling | |
| 120 | 2.50 | 1050 | 88 | 10 | Comparative Example |
| 121 | 2.50 | 1050 | 92 | 5 | Invention Example |
| 122 | 2.50 | 1100 | 95 | 20 | Invention Example |
| 123 | 2.50 | 1150 | 95 | 30 | Comparative Example |
| 124 | 2.50 | 1050 | 92 | 10 | Invention Example |
| 125 | 2.50 | 1050 | 92 | 10 | Invention Example |
| 126 | 2.50 | 1050 | 92 | 10 | Invention Example |
| 127 | 2.50 | 1050 | 92 | 10 | Invention Example |
| 128 | 2.50 | 1050 | 92 | 10 | Invention Example |
| 129 | 2.50 | 1050 | 92 | 10 | Invention Example |
| 130 | 2.50 | 1050 | 92 | 10 | Invention Example |
| 131 | 2.50 | 1050 | 92 | 10 | Invention Example |
| 132 | 2.50 | 1050 | 92 | 10 | Invention Example |
| 133 | 2.50 | 1050 | 92 | 10 | Invention Example |
| 134 | 2.50 | 1050 | 92 | 10 | Invention Example |
| 135 | 2.50 | 1050 | 92 | 10 | Invention Example |
| 136 | 2.50 | 1050 | 92 | 10 | Invention Example |
| 137 | 2.50 | 1050 | 92 | 10 | Invention Example |
| 138 | 2.50 | 1050 | 92 | 10 | Invention Example |
| 139 | 2.50 | 1050 | 92 | 10 | Invention Example |
| 140 | 2.50 | 1050 | 92 | 10 | Invention Example |
| 141 | 2.50 | 1050 | 92 | 10 | Invention Example |
| 142 | 2.50 | 1050 | 92 | 10 | Comparative Example |
| 143 | 2.50 | 1050 | 92 | 10 | Comparative Example |
| 144 | 2.50 | 1050 | 92 | Cracking | Comparative Example |
| | | | | occurs during | |
| | | | | cold rolling | |
| 145 | 2.50 | 1050 | 92 | Cracking | Comparative Example |
| | | | | occurs during | |
| | | | | cold rolling | |
| 146 | 2.50 | 1050 | 92 | 10 | Comparative Example |
| 147 | 2.50 | 1050 | 92 | 10 | Comparative Example |
| 148 | 2.50 | 1050 | 92 | 10 | Comparative Example |
| 149 | 2.50 | 1050 | 92 | 10 | Comparative Example |
| 150 | 2.50 | 1050 | 92 | Cracking | Comparative Example |
| | | | | occurs during | |
| | | | | cold rolling | |
| 151 | 2.50 | 1010 | 90 | 10 | Invention Example |

TABLE 2

| | | | | | | | | | | | | After second | | |
|---|---|---|---|---|---|---|---|---|---|---|---|---|---|---|
| | EBSD observation result after skin pass rolling | | | | | | | | | | | heat treatment | | |
| | | | | | S [symbol] / | S₁₀₀/ | S₁₀₀/ | K₁₀₀/ | K₁₀₀/ | S₁₀₀/ | K₁₀₀/ | W10/400 | W15/50(C)/ | |
| No. | K [symbol] | K [symbol] | K₁₀₀ | K₁₁₀ | S [symbol] | S [symbol] | S [symbol] | K [symbol] | K [symbol] | S₁₁₀ | K₁₁₀ | (W/kg) | W15/50(L) | Note |
| 101 | 0.371 | 0.364 | 0.363 | 0.365 | 0.72 | 0.15 | 0.72 | 0.980 | 0.997 | 5.581 | 0.996 | 10.5 | 1.08 | Invention |
| | | | | | | | | | | | | | | Example |
| 102 | 0.372 | 0.363 | 0.362 | 0.365 | 0.74 | 0.14 | 0.73 | 0.975 | 0.998 | 5.599 | 0.993 | 10.5 | 1.10 | Invention |
| | | | | | | | | | | | | | | Example |
| 103 | 0.371 | 0.363 | 0.364 | 0.365 | 0.74 | 0.16 | 0.71 | 0.981 | 1.002 | 5.580 | 0.996 | 10.6 | 1.11 | Invention |
| | | | | | | | | | | | | | | Example |
| 104 | 0.370 | 0.363 | 0.364 | 0.364 | 0.73 | 0.16 | 0.72 | 0.983 | 1.002 | 5.613 | 1.000 | 10.6 | 1.08 | Invention |
| | | | | | | | | | | | | | | Example |
| 105 | 0.371 | 0.363 | 0.363 | 0.366 | 0.74 | 0.16 | 0.72 | 0.978 | 1.000 | 5.596 | 0.993 | 10.5 | 1.08 | Invention |
| | | | | | | | | | | | | | | Example |
| 106 | 0.371 | 0.363 | 0.362 | 0.365 | 0.72 | 0.15 | 0.71 | 0.976 | 0.998 | 5.595 | 0.994 | 10.4 | 1.09 | Invention |
| | | | | | | | | | | | | | | Example |
| 107 | 0.370 | 0.364 | 0.363 | 0.366 | 0.73 | 0.15 | 0.73 | 0.980 | 0.997 | 5.592 | 0.992 | 10.6 | 1.09 | Invention |
| | | | | | | | | | | | | | | Example |
| 108 | 0.370 | 0.364 | 0.363 | 0.365 | 0.89 | 0.03 | 0.71 | 0.979 | 0.996 | 1.505 | 0.994 | 15.6 | 1.39 | Comparative |
| | | | | | | | | | | | | | | Example |
| 109 | 0.372 | 0.363 | 0.363 | 0.365 | 0.88 | 0.15 | 0.72 | 0.978 | 0.999 | 5.582 | 0.994 | 12.2 | 1.39 | Comparative |
| | | | | | | | | | | | | | | Example |
| 110 | 0.371 | 0.363 | 0.363 | 0.364 | 0.72 | 0.02 | 0.72 | 0.977 | 0.999 | 5.586 | 0.996 | 12.4 | 1.40 | Comparative |
| | | | | | | | | | | | | | | Example |
| 111 | 0.371 | 0.364 | 0.364 | 0.364 | 0.73 | 0.16 | 0.24 | 0.980 | 1.001 | 0.287 | 0.998 | 12.3 | 1.39 | Comparative |
| | | | | | | | | | | | | | | Example |
| 112 | 0.362 | 0.364 | 0.363 | 0.365 | 0.72 | 0.15 | 0.73 | 1.003 | 0.995 | 5.584 | 0.994 | 12.4 | 1.40 | Comparative |
| | | | | | | | | | | | | | | Example |
| 113 | 0.371 | 0.355 | 0.365 | 0.366 | 0.73 | 0.14 | 0.72 | 0.985 | 1.027 | 5.607 | 0.998 | 11.3 | 1.12 | Invention |
| | | | | | | | | | | | | | | Example |
| 114 | 0.371 | 0.366 | 0.362 | 0.357 | 0.73 | 0.15 | 0.72 | 0.976 | 0.990 | 5.602 | 1.015 | 11.2 | 1.13 | Invention |
| | | | | | | | | | | | | | | Example |
| 115 | 0.370 | 0.365 | 0.365 | 0.364 | 0.72 | 0.14 | 0.72 | 0.987 | 1.001 | 5.580 | 1.003 | 10.7 | 1.07 | Invention |
| | | | | | | | | | | | | | | Example |
| 116 | 0.371 | 0.364 | 0.361 | 0.365 | 0.72 | 0.16 | 0.72 | 0.975 | 0.993 | 5.582 | 0.991 | 10.4 | 1.08 | Invention |
| | | | | | | | | | | | | | | Example |
| 117 | 0.370 | 0.362 | 0.362 | 0.365 | 0.87 | 0.14 | 0.72 | 0.979 | 0.999 | 5.582 | 0.990 | 12.0 | 1.42 | Comparative |
| | | | | | | | | | | | | | | Example |
| 118 | 0.371 | 0.365 | 0.362 | 0.365 | 0.73 | 0.15 | 0.71 | 0.974 | 0.991 | 5.582 | 0.990 | 9.0 | 1.10 | Invention |
| | | | | | | | | | | | | | | Example |
| 119 | Not evaluated since cracking occurs during cold rolling | | | | | | | | | | | | | Comparative |
| | | | | | | | | | | | | | | Example |
| 120 | 0.373 | 0.364 | 0.364 | 0.365 | 0.73 | 0.15 | 0.23 | 0.976 | 0.998 | 0.288 | 0.997 | 12.3 | 1.38 | Comparative |
| | | | | | | | | | | | | | | Example |
| 121 | 0.369 | 0.365 | 0.361 | 0.365 | 0.73 | 0.15 | 0.73 | 0.980 | 0.990 | 5.579 | 0.991 | 10.6 | 1.11 | Invention |
| | | | | | | | | | | | | | | Example |
| 122 | 0.371 | 0.365 | 0.362 | 0.364 | 0.23 | 0.74 | 0.72 | 0.975 | 0.992 | 5.580 | 0.994 | 10.5 | 1.11 | Invention |
| | | | | | | | | | | | | | | Example |
| 123 | 0.370 | 0.365 | 0.364 | 0.365 | 0.17 | 0.82 | 0.72 | 0.984 | 0.996 | 5.582 | 0.998 | 12.4 | 1.38 | Comparative |
| | | | | | | | | | | | | | | Example |
| 124 | 0.370 | 0.366 | 0.363 | 0.364 | 0.73 | 0.14 | 0.73 | 0.982 | 0.993 | 5.580 | 1.000 | 10.7 | 1.10 | Invention |
| | | | | | | | | | | | | | | Example |
| 125 | 0.371 | 0.362 | 0.364 | 0.366 | 0.73 | 0.14 | 0.72 | 0.982 | 1.004 | 5.583 | 0.995 | 10.8 | 1.08 | Invention |
| | | | | | | | | | | | | | | Example |
| 126 | 0.370 | 0.364 | 0.361 | 0.366 | 0.72 | 0.14 | 0.73 | 0.978 | 0.992 | 5.582 | 0.988 | 10.1 | 1.10 | Invention |
| | | | | | | | | | | | | | | Example |
| 127 | 0.372 | 0.365 | 0.364 | 0.367 | 0.73 | 0.15 | 0.72 | 0.978 | 0.997 | 5.580 | 0.993 | 10.8 | 1.07 | Invention |
| | | | | | | | | | | | | | | Example |
| 128 | 0.370 | 0.363 | 0.363 | 0.364 | 0.72 | 0.14 | 0.72 | 0.984 | 1.002 | 5.582 | 0.998 | 10.2 | 1.08 | Invention |
| | | | | | | | | | | | | | | Example |
| 129 | 0.370 | 0.363 | 0.363 | 0.363 | 0.71 | 0.14 | 0.73 | 0.981 | 1.000 | 5.581 | 1.001 | 10.1 | 1.10 | Invention |
| | | | | | | | | | | | | | | Example |
| 130 | 0.370 | 0.364 | 0.362 | 0.366 | 0.72 | 0.15 | 0.71 | 0.978 | 0.994 | 5.581 | 0.988 | 10.7 | 1.08 | Invention |
| | | | | | | | | | | | | | | Example |
| 131 | 0.369 | 0.366 | 0.365 | 0.365 | 0.72 | 0.15 | 0.71 | 0.988 | 0.998 | 5.581 | 1.000 | 10.8 | 1.13 | Invention |
| | | | | | | | | | | | | | | Example |
| 132 | 0.370 | 0.366 | 0.364 | 0.365 | 0.72 | 0.15 | 0.72 | 0.983 | 0.996 | 5.582 | 0.998 | 10.6 | 1.09 | Invention |
| | | | | | | | | | | | | | | Example |
| 133 | 0.369 | 0.363 | 0.362 | 0.366 | 0.73 | 0.16 | 0.73 | 0.980 | 0.998 | 5.582 | 0.989 | 10.5 | 1.07 | Invention |
| | | | | | | | | | | | | | | Example |
| 134 | 0.371 | 0.363 | 0.362 | 0.363 | 0.72 | 0.15 | 0.72 | 0.975 | 0.997 | 5.579 | 0.998 | 10.7 | 1.08 | Invention |
| | | | | | | | | | | | | | | Example |
| 135 | 0.371 | 0.364 | 0.365 | 0.363 | 0.72 | 0.15 | 0.72 | 0.981 | 1.001 | 5.581 | 1.005 | 10.3 | 1.10 | Invention |
| | | | | | | | | | | | | | | Example |
| 136 | 0.372 | 0.364 | 0.363 | 0.363 | 0.73 | 0.16 | 0.72 | 0.974 | 0.996 | 5.580 | 0.999 | 10.6 | 1.09 | Invention |
| | | | | | | | | | | | | | | Example |
| 137 | 0.370 | 0.364 | 0.363 | 0.363 | 0.71 | 0.15 | 0.72 | 0.980 | 0.998 | 5.581 | 0.998 | 9.9 | 1.10 | Invention |
| | | | | | | | | | | | | | | Example |
| 138 | 0.372 | 0.363 | 0.365 | 0.365 | 0.73 | 0.14 | 0.72 | 0.981 | 1.005 | 5.583 | 0.999 | 10.3 | 1.10 | Invention |
| | | | | | | | | | | | | | | Example |
| 139 | 0.371 | 0.366 | 0.362 | 0.364 | 0.72 | 0.14 | 0.73 | 0.975 | 0.990 | 5.581 | 0.993 | 10.5 | 1.11 | Invention |
| | | | | | | | | | | | | | | Example |
| 140 | 0.370 | 0.365 | 0.364 | 0.366 | 0.71 | 0.16 | 0.72 | 0.983 | 0.997 | 5.582 | 0.995 | 10.1 | 1.09 | Invention |
| | | | | | | | | | | | | | | Example |
| 141 | 0.371 | 0.364 | 0.362 | 0.364 | 0.72 | 0.14 | 0.71 | 0.976 | 0.996 | 5.581 | 0.994 | 10.5 | 1.12 | Invention |
| | | | | | | | | | | | | | | Example |
| 142 | 0.369 | 0.364 | 0.362 | 0.365 | 0.88 | 0.03 | 0.71 | 0.980 | 0.993 | 1.506 | 0.992 | 15.6 | 1.42 | Comparative |
| | | | | | | | | | | | | | | Example |
| 143 | 0.370 | 0.365 | 0.363 | 0.366 | 0.89 | 0.02 | 0.71 | 0.982 | 0.996 | 1.504 | 0.992 | 15.6 | 1.39 | Comparative |
| | | | | | | | | | | | | | | Example |
| 144 | Not evaluated since cracking occurs during cold rolling | | | | | | | | | | | | | Comparative |
| | | | | | | | | | | | | | | Example |
| 145 | Not evaluated since cracking occurs during cold rolling | | | | | | | | | | | | | Comparative |
| | | | | | | | | | | | | | | Example |
| 146 | 0.371 | 0.364 | 0.361 | 0.364 | 0.88 | 0.03 | 0.72 | 0.974 | 0.992 | 1.507 | 0.993 | 15.7 | 1.41 | Comparative |
| | | | | | | | | | | | | | | Example |
| 147 | 0.369 | 0.366 | 0.363 | 0.364 | 0.88 | 0.04 | 0.72 | 0.985 | 0.993 | 1.505 | 0.999 | 15.7 | 1.42 | Comparative |
| | | | | | | | | | | | | | | Example |
| 148 | 0.369 | 0.363 | 0.364 | 0.367 | 0.89 | 0.02 | 0.72 | 0.988 | 1.004 | 1.504 | 0.994 | 15.6 | 1.40 | Comparative |
| | | | | | | | | | | | | | | Example |
| 149 | 0.369 | 0.364 | 0.362 | 0.364 | 0.88 | 0.03 | 0.72 | 0.981 | 0.994 | 1.506 | 0.993 | 15.6 | 1.40 | Comparative |
| | | | | | | | | | | | | | | Example |
| 150 | Not evaluated since cracking occurs during cold rolling | | | | | | | | | | | | | Comparative |
| | | | | | | | | | | | | | | Example |
| 151 | 0.369 | 0.365 | 0.364 | 0.366 | 0.73 | 0.09 | 0.75 | 0.987 | 0.996 | 0.901 | 0.995 | 10.4 | 1.18 | Invention |
| | | | | | | | | | | | | | | Example |

[symbol]

indicates data missing or illegible when filed

Underlined values in Table 1A, Table 1B, and Table 2 indicate conditions deviating from the scope of the present invention. In all of No. 101 to No. 107, No. 113 to No. 116, No. 118, No. 121, No. 122, No. 124 to No. 141, and No. 151, which are invention examples, the iron losses W10/400 were favorable values.

On the other hand, in No. 108, which is a comparative example, the Mn concentration was high, and the value of the left side of Formula (1) was more than 0.00 (a composition that underwent α-γ transformation), which made the area ratio S_{tyl}/Sₜₒₜ and the area ratio S₁₀₀/Sₜₒₜ each deviate from the range of Formula (3) or Formula (4). As a result, the iron loss W10/400 was high.

In No. 109 to No. 112, No. 117, No. 120, and No. 123, which are comparative examples, since at least any of the temperature in the hot-rolled sheet annealing, the rolling reduction in the cold rolling, and the rolling reduction in the skin pass rolling was not optimal, any of Formula (3) to Formula (6) was not satisfied, and, as a result, the iron losses W10/400 were high.

In addition, in No. 119, which is a comparative example, since the rolling reduction of the cold rolling was too high, cracking occurred, and the process could not proceed to the subsequent steps.

In No. 142 to No. 150, since the chemical compositions were outside the scope of the present invention, Formula (3) and Formula (4) were not satisfied, and the iron losses W10/400 became high or cracking occurred during the cold rolling.

### Second Example

Molten steel was cast, thereby producing ingots having chemical compositions shown in Table 3A. Here, the column “Left side of Formula (1)” indicates the values of the left side of Formula (1) described above. After that, the produced ingots were hot-rolled by being heated up to 1150° C. and rolled such that the sheet thicknesses became as shown in Table 3B. In addition, after the end of finish rolling, the hot-rolled steel sheets were cooled with water and coiled. The temperatures (finish temperatures) in a stage of the final pass of the finish rolling at this time were 830° C., and the coiling temperatures were within a range of 500° C. to 700° C.

Next, hot-rolled sheet annealing was performed on the hot-rolled steel sheets under conditions shown in Table 3B for 30 seconds, scales were removed by pickling, and cold rolling was performed at rolling reductions shown in Table 3B. In addition, intermediate annealing was performed in a non-oxidizing atmosphere at annealing temperatures shown in Table 3B for 30 seconds. Next, the second round of cold rolling (skin pass rolling) was performed at rolling reductions shown in Table 3B.

In order to investigate the textures after the skin pass rolling, a part of each of the steel sheets was cut, the cut test piece was processed to reduce the thickness to ½, and EBSD observation (step intervals: 100 nm) was performed on the processed surface in the above-described manner. S_{tyl}/Sₜᵣₐ, S₁₀₀/Sₜₒₜ, S₁₀₀/Sₜᵣₐ, and K₁₀₀/K_{tyl} were obtained from the area and average KAM value of each kind of the orientated grains obtained by EBSD observation.

In addition, on the steel sheets after the skin pass rolling, a first heat treatment was performed under conditions shown in Table 3B. After the first heat treatment, in order to investigate the textures, a part of each of the steel sheets was cut, the cut test piece was processed to reduce the thickness to ½, and EBSD observation was performed on the processed surface. The areas, average KAM values, and average grain sizes of kinds shown in Table 4 were obtained by EBSD observation.

In addition, as a second heat treatment, annealing was performed on the steel sheets at a temperature of 800° C. for 2 hours. From each of the steel sheets after the second heat treatment, 55 mm×55 mm sample pieces were collected as measurement samples. The samples were collected using a shearing machine. In addition, as the magnetic characteristics, the iron losses W10/400 (average value of the rolling direction and the width direction), W15/50 (C), and W15/50 (L) were measured in the same manner as in First Example, and W15/50 (C)/W15/50 (L) were obtained. The measurement results are shown in Table 4.

TABLE 3A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Left |
| | | | | | | | | | | | | | | | | | side |
| | | | | | | | | | | | | | | | | | of |
| | | | | | | | | | | | | | | | | | For- |
| | | | | | | | | | | | | | | | | | mula |
| No. | C | Si | sol. Al | S | N | Mn | Ni | Co | Pt | Pb | Cu | Au | Cr | Mg | B | O | (1) |
| 201 | 0.0010 | 3.20 | 0.61 | 0.0017 | 0.0018 | 0.21 | — | — | — | — | — | — | 0.003 | — | — | — | −3.60 |
| 202 | 0.0011 | 3.20 | 0.60 | 0.0020 | 0.0023 | — | 0.20 | — | — | — | — | — | 0.003 | — | — | — | −3.60 |
| 203 | 0.0010 | 3.19 | 0.60 | 0.0019 | 0.0018 | — | — | 0.20 | — | — | — | — | 0.003 | — | — | — | −3.59 |
| 204 | 0.0011 | 3.20 | 0.59 | 0.0022 | 0.0023 | — | — | — | 0.19 | — | — | — | 0.003 | — | — | — | −3.60 |
| 205 | 0.0010 | 3.19 | 0.59 | 0.0021 | 0.0020 | — | — | — | — | 0.21 | — | — | 0.003 | — | — | — | −3.58 |
| 206 | 0.0009 | 3.21 | 0.60 | 0.0019 | 0.0019 | — | — | — | — | — | 0.20 | — | 0.003 | — | — | — | −3.61 |
| 207 | 0.0009 | 3.19 | 0.61 | 0.0022 | 0.0023 | — | — | — | — | — | — | 0.21 | 0.003 | — | — | — | −3.59 |
| 208 | 0.0009 | 2.00 | 0.31 | 0.0020 | 0.0018 | 2.39 | — | — | — | — | — | — | 0.003 | — | — | — | 0.09 |
| 209 | 0.0011 | 3.21 | 0.60 | 0.0020 | 0.0021 | 0.21 | — | — | — | — | — | — | 0.003 | — | — | — | −3.60 |
| 210 | 0.0011 | 3.20 | 0.59 | 0.0021 | 0.0024 | 0.20 | — | — | — | — | — | — | 0.003 | — | — | — | −3.60 |
| 211 | 0.0009 | 3.21 | 0.60 | 0.0018 | 0.0020 | 0.21 | — | — | — | — | — | — | 0.003 | — | — | — | −3.60 |
| 212 | 0.0010 | 3.19 | 0.61 | 0.0019 | 0.0017 | 0.19 | — | — | — | — | — | — | 0.003 | — | — | — | −3.60 |
| 213 | 0.0010 | 3.20 | 0.60 | 0.0020 | 0.0019 | 0.20 | — | — | — | — | — | — | 0.003 | — | — | — | −3.60 |
| 214 | 0.0011 | 3.21 | 0.59 | 0.0018 | 0.0021 | 0.19 | — | — | — | — | — | — | 0.003 | — | — | — | −3.61 |
| 215 | 0.0009 | 3.20 | 0.61 | 0.0018 | 0.0018 | 0.20 | — | — | — | — | — | — | 0.003 | — | — | — | −3.60 |
| 216 | 0.0011 | 3.21 | 0.60 | 0.0018 | 0.0017 | 0.20 | — | — | — | — | — | — | 0.003 | — | — | — | −3.60 |
| 217 | 0.0008 | 3.19 | 0.60 | 0.0017 | 0.0018 | 0.21 | — | — | — | — | — | — | 0.003 | — | — | — | −3.59 |
| 218 | 0.0010 | 3.20 | 0.61 | 0.0016 | 0.0019 | 0.21 | — | — | — | — | — | — | 0.002 | — | — | — | −3.60 |
| 220 | 0.0085 | 3.21 | 0.60 | 0.0017 | 0.0020 | 0.22 | — | — | — | — | — | — | 0.003 | — | — | — | −3.60 |
| 221 | 0.0009 | 1.59 | 0.60 | 0.0017 | 0.0022 | 0.22 | — | — | — | — | — | — | 0.002 | — | — | — | −1.98 |
| 222 | 0.0008 | 3.91 | 0.60 | 0.0019 | 0.0021 | 0.22 | — | — | — | — | — | — | 0.004 | — | — | — | −4.29 |
| 223 | 0.0010 | 3.22 | 0.00 | 0.0019 | 0.0022 | 0.22 | — | — | — | — | — | — | 0.004 | — | — | — | −3.00 |
| 224 | 0.0008 | 3.23 | 2.80 | 0.0017 | 0.0019 | 0.22 | — | — | — | — | — | — | 0.002 | — | — | — | −5.81 |
| 225 | 0.0010 | 3.22 | 0.61 | 0.0004 | 0.0020 | 0.22 | — | — | — | — | — | — | 0.002 | — | — | — | −3.61 |
| 226 | 0.0010 | 3.23 | 0.60 | 0.0091 | 0.0020 | 0.22 | — | — | — | — | — | — | 0.003 | — | — | — | −3.61 |
| 227 | 0.0010 | 3.21 | 0.61 | 0.0019 | 0.0093 | 0.22 | — | — | — | — | — | — | 0.003 | — | — | — | −3.61 |
| 228 | 0.0009 | 3.22 | 0.61 | 0.0020 | 0.0020 | 0.22 | — | — | — | — | — | — | 0.002 | 0.0005 | — | — | −3.61 |
| 229 | 0.0011 | 3.23 | 0.61 | 0.0349 | 0.0020 | 0.22 | — | — | — | — | — | — | 0.002 | 0.0093 | — | — | −3.62 |
| 230 | 0.0009 | 3.22 | 0.61 | 0.0020 | 0.0021 | 0.22 | — | — | — | — | — | — | 0.001 | — | — | — | −3.61 |
| 231 | 0.0009 | 3.22 | 0.61 | 0.0019 | 0.0020 | 0.22 | — | — | — | — | — | — | 0.093 | — | — | — | −3.61 |
| 232 | 0.0011 | 3.22 | 0.61 | 0.0019 | 0.0018 | 0.22 | — | — | — | — | — | — | 0.003 | — | — | — | −3.61 |
| 233 | 0.0008 | 3.23 | 2.80 | 0.0018 | 0.0020 | 2.40 | — | — | — | — | — | — | 0.003 | — | — | — | −3.63 |
| 234 | 0.0011 | 3.21 | 0.59 | 0.0020 | 0.0017 | 0.21 | — | — | — | — | — | — | 0.004 | — | 0.0002 | — | −3.59 |
| 235 | 0.0010 | 3.20 | 0.58 | 0.0020 | 0.0017 | 0.21 | — | — | — | — | — | — | 0.003 | — | 0.0045 | — | −3.57 |
| 236 | 0.0008 | 3.20 | 0.58 | 0.0019 | 0.0017 | 0.21 | — | — | — | — | — | — | 0.002 | — | — | 0.0013 | −3.58 |
| 237 | 0.0008 | 3.19 | 0.60 | 0.0018 | 0.0020 | 0.21 | — | — | — | — | — | — | 0.003 | — | — | 0.0170 | −3.58 |
| 238 | 0.0120 | 3.23 | 3.23 | 0.0020 | 0.0021 | 0.21 | — | — | — | — | — | — | 0.003 | — | — | — | −3.61 |
| 239 | 0.0009 | 1.40 | 0.60 | 0.0018 | 0.0021 | 0.21 | — | — | — | — | — | — | 0.003 | — | — | — | −1.79 |
| 240 | 0.0009 | 4.19 | 0.60 | 0.0017 | 0.0020 | 0.21 | — | — | — | — | — | — | 0.003 | — | — | — | −4.58 |
| 241 | 0.0010 | 3.22 | 4.20 | 0.0018 | 0.0019 | 0.21 | — | — | — | — | — | — | 0.002 | — | — | — | −7.21 |
| 242 | 0.0008 | 3.22 | 0.60 | 0.0451 | 0.0018 | 0.21 | — | — | — | — | — | — | 0.003 | — | — | — | −3.61 |
| 243 | 0.0009 | 3.23 | 0.59 | 0.0019 | 0.0120 | 0.21 | — | — | — | — | — | — | 0.004 | — | — | — | −3.61 |
| 244 | 0.0007 | 3.23 | 0.61 | 0.0019 | 0.0019 | 0.21 | — | — | — | — | — | — | 0.000 | — | — | — | −3.63 |
| 245 | 0.0010 | 3.22 | 0.61 | 0.0018 | 0.0018 | 0.21 | — | — | — | — | — | — | 0.120 | — | — | — | −3.62 |
| 246 | 0.0008 | 3.22 | 0.60 | 0.0019 | 0.0020 | 2.60 | — | — | — | — | — | — | 0.004 | — | — | — | −1.22 |
| 247 | 0.0011 | 3.21 | 0.61 | 0.0017 | 0.0018 | 0.21 | — | — | — | — | — | — | 0.003 | — | — | — | −3.61 |
| 248 | 0.0010 | 3.21 | 0.60 | 0.0015 | 0.0017 | 0.21 | — | — | — | — | — | — | 0.003 | — | — | — | −3.60 |
| 249 | 0.0012 | 3.20 | 0.60 | 0.0016 | 0.0018 | 0.21 | — | — | — | — | — | — | 0.002 | — | — | — | −3.59 |
| 250 | 0.0011 | 3.20 | 0.61 | 0.0017 | 0.0016 | 0.21 | — | — | — | — | — | — | 0.003 | — | — | — | −3.61 |

TABLE 3B

| | | Hot-rolled | | | | | | | | | | |
|---|---|---|---|---|---|---|---|---|---|---|---|---|
| | After hot | sheet | | | Intermediate | | | | | | | |
| | colling | annealing | Rolling | | annealing | EBSD observation result | | | | First heat treatment | | |
| | Sheet | Annealing | reduction (%) | | Annealing | after skin pass rolling | | | | Annealing | Annealing | |
| | thickness | temperature | Cold | Skin pass | temperature | S [symbol] / | S₁₀₀/ | S₁₀₀/ | K₁₀₀/ | temperature | time | |
| No. | (mm) | (° C.) | rolling | rolling | (° C.) | S [symbol] | S [symbol] | S [symbol] | K [symbol] | (° C.) | (s) | Note |
| 201 | 2.50 | 1050 | 92 | 10 | 800 | 0.73 | 0.15 | 0.73 | 0.983 | 800 | 30 | Invention |
| | | | | | | | | | | | | Example |
| 202 | 2.50 | 1050 | 92 | 10 | 800 | 0.74 | 0.15 | 0.73 | 0.974 | 800 | 30 | Invention |
| | | | | | | | | | | | | Example |
| 203 | 2.50 | 1050 | 92 | 10 | 800 | 0.74 | 0.15 | 0.72 | 0.984 | 800 | 30 | Invention |
| | | | | | | | | | | | | Example |
| 204 | 2.50 | 1050 | 92 | 10 | 800 | 0.72 | 0.15 | 0.72 | 0.983 | 800 | 30 | Invention |
| | | | | | | | | | | | | Example |
| 205 | 2.50 | 1050 | 92 | 10 | 800 | 0.74 | 0.15 | 0.72 | 0.977 | 800 | 30 | Invention |
| | | | | | | | | | | | | Example |
| 206 | 2.50 | 1050 | 92 | 10 | 800 | 0.72 | 0.15 | 0.71 | 0.976 | 800 | 30 | Invention |
| | | | | | | | | | | | | Example |
| 207 | 2.50 | 1050 | 92 | 10 | 800 | 0.72 | 0.14 | 0.72 | 0.981 | 800 | 30 | Invention |
| | | | | | | | | | | | | Example |
| 208 | 2.50 | 1050 | 92 | 10 | 800 | 0.89 | 0.03 | 0.72 | 0.981 | 800 | 30 | Comparative |
| | | | | | | | | | | | | Example |
| 209 | 2.50 | 850 | 92 | 10 | 800 | 0.88 | 0.15 | 0.71 | 0.977 | 800 | 30 | Comparative |
| | | | | | | | | | | | | Example |
| 210 | 1.33 | 850 | 85 | 10 | 800 | 0.72 | 0.01 | 0.71 | 0.974 | 800 | 30 | Comparative |
| | | | | | | | | | | | | Example |
| 211 | 0.50 | 1050 | 60 | 10 | 800 | 0.73 | 0.15 | 0.24 | 0.978 | 800 | 30 | Comparative |
| | | | | | | | | | | | | Example |
| 212 | 2.50 | 1050 | 92 | 3 | 800 | 0.73 | 0.14 | 0.72 | 1.002 | 800 | 30 | Comparative |
| | | | | | | | | | | | | Example |
| 213 | 2.50 | 1050 | 92 | 10 | 800 | 0.72 | 0.14 | 0.72 | 0.978 | 690 | 1 | Comparative |
| | | | | | | | | | | | | Example |
| 214 | 2.50 | 1050 | 92 | 10 | 950 | 0.73 | 0.01 | 0.72 | 0.978 | 800 | 30 | Comparative |
| | | | | | | | | | | | | Example |
| 215 | 2.50 | 1050 | 92 | 15 | 800 | 0.71 | 0.14 | 0.72 | 0.981 | 800 | 30 | Invention |
| | | | | | | | | | | | | Example |
| 216 | 2.50 | 1050 | 92 | 25 | 800 | 0.73 | 0.16 | 0.72 | 0.977 | 800 | 30 | Invention |
| | | | | | | | | | | | | Example |
| 217 | 2.50 | 1050 | 92 | 10 | 800 | 0.72 | 0.14 | 0.73 | 0.980 | 750 | 30 | Invention |
| | | | | | | | | | | | | Example |
| 218 | 2.50 | 1050 | 92 | 10 | 800 | 0.72 | 0.15 | 0.73 | 0.979 | 950 | 30 | Invention |
| | | | | | | | | | | | | Example |
| 220 | 2.50 | 1050 | 92 | 10 | 800 | 0.73 | 0.14 | 0.73 | 0.980 | 800 | 30 | Invention |
| | | | | | | | | | | | | Example |
| 221 | 2.50 | 1050 | 92 | 10 | 800 | 0.72 | 0.16 | 0.73 | 0.982 | 800 | 30 | Invention |
| | | | | | | | | | | | | Example |
| 222 | 2.50 | 1050 | 92 | 10 | 800 | 0.72 | 0.15 | 0.72 | 0.982 | 800 | 30 | Invention |
| | | | | | | | | | | | | Example |
| 223 | 2.50 | 1050 | 92 | 10 | 800 | 0.72 | 0.15 | 0.72 | 0.980 | 800 | 30 | Invention |
| | | | | | | | | | | | | Example |
| 224 | 2.50 | 1050 | 92 | 10 | 800 | 0.72 | 0.15 | 0.72 | 0.977 | 800 | 30 | Invention |
| | | | | | | | | | | | | Example |
| 225 | 2.50 | 1050 | 92 | 10 | 800 | 0.72 | 0.15 | 0.71 | 0.982 | 800 | 30 | Invention |
| | | | | | | | | | | | | Example |
| 226 | 2.50 | 1050 | 92 | 10 | 800 | 0.72 | 0.15 | 0.73 | 0.980 | 800 | 30 | Invention |
| | | | | | | | | | | | | Example |
| 227 | 2.50 | 1050 | 92 | 10 | 800 | 0.73 | 0.14 | 0.73 | 0.982 | 800 | 30 | Invention |
| | | | | | | | | | | | | Example |
| 228 | 2.50 | 1050 | 92 | 10 | 800 | 0.71 | 0.15 | 0.73 | 0.981 | 800 | 30 | Invention |
| | | | | | | | | | | | | Example |
| 229 | 2.50 | 1050 | 92 | 10 | 800 | 0.73 | 0.16 | 0.71 | 0.981 | 800 | 30 | Invention |
| | | | | | | | | | | | | Example |
| 230 | 2.50 | 1050 | 92 | 10 | 800 | 0.71 | 0.15 | 0.73 | 0.981 | 800 | 30 | Invention |
| | | | | | | | | | | | | Example |
| 231 | 2.50 | 1050 | 92 | 10 | 800 | 0.72 | 0.15 | 0.73 | 0.978 | 800 | 30 | Invention |
| | | | | | | | | | | | | Example |
| 232 | 2.50 | 1050 | 92 | 10 | 800 | 0.73 | 0.15 | 0.73 | 0.983 | 800 | 30 | Invention |
| | | | | | | | | | | | | Example |
| 233 | 2.50 | 1050 | 92 | 10 | 800 | 0.72 | 0.15 | 0.73 | 0.982 | 800 | 30 | In vention |
| | | | | | | | | | | | | Example |
| 234 | 2.50 | 1050 | 92 | 10 | 800 | 0.73 | 0.14 | 0.71 | 0.979 | 800 | 30 | Invention |
| | | | | | | | | | | | | Example |
| 235 | 2.50 | 1050 | 92 | 10 | 800 | 0.71 | 0.15 | 0.73 | 0.977 | 800 | 30 | Invention |
| | | | | | | | | | | | | Example |
| 236 | 2.50 | 1050 | 92 | 10 | 800 | 0.72 | 0.15 | 0.73 | 0.981 | 800 | 30 | Invention |
| | | | | | | | | | | | | Example |
| 237 | 2.50 | 1050 | 92 | 10 | 800 | 0.72 | 0.14 | 0.73 | 0.980 | 800 | 30 | Invention |
| | | | | | | | | | | | | Example |
| 238 | 2.50 | 1050 | 92 | 10 | 800 | 0.90 | 0.02 | 0.71 | 0.980 | 800 | 30 | Comparative |
| | | | | | | | | | | | | Example |
| 239 | 2.50 | 1050 | 92 | 10 | 800 | 0.89 | 0.04 | 0.71 | 0.982 | 800 | 30 | Comparative |
| | | | | | | | | | | | | Example |
| 240 | 2.50 | 1050 | 92 | Cracking occurs during cold rolling | | | | | | | | Comparative |
| | | | | | | | | | | | | Example |
| 241 | 2.50 | 1050 | 92 | Cracking occurs during cold rolling | | | | | | | | Comparative |
| | | | | | | | | | | | | Example |
| 242 | 2.50 | 1050 | 92 | 10 | 800 | 0.89 | 0.02 | 0.71 | 0.977 | 800 | 30 | Comparative |
| | | | | | | | | | | | | Example |
| 243 | 2.50 | 1050 | 92 | 10 | 800 | 0.88 | 0.03 | 0.71 | 0.979 | 800 | 30 | Comparative |
| | | | | | | | | | | | | Example |
| 244 | 2.50 | 1050 | 92 | 10 | 800 | 0.90 | 0.03 | 0.72 | 0.977 | 800 | 30 | Comparative |
| | | | | | | | | | | | | Example |
| 245 | 2.50 | 1050 | 92 | 10 | 800 | 0.89 | 0.02 | 0.72 | 0.978 | 800 | 30 | Comparative |
| | | | | | | | | | | | | Example |
| 246 | 2.50 | 1050 | 92 | Cracking occurs during cold rolling | | | | | | | | Comparative |
| | | | | | | | | | | | | Example |
| 247 | 2.50 | 1050 | 92 | 10 | 800 | 0.72 | 0.14 | 0.73 | 0.980 | 900 | 30 | Invention |
| | | | | | | | | | | | | Example |
| 248 | 2.50 | 1050 | 92 | 10 | 800 | 0.72 | 0.15 | 0.71 | 0.979 | 720 | 30 | Invention |
| | | | | | | | | | | | | Example |
| 249 | 1.80 | 1050 | 90 | 10 | 800 | 0.71 | 0.15 | 0.72 | 0.977 | 800 | 30 | Invention |
| | | | | | | | | | | | | Example |
| 250 | 2.50 | 1050 | 92 | 10 | 800 | 0.73 | 0.14 | 0.73 | 0.981 | 800 | 5 | Invention |
| | | | | | | | | | | | | Example |

[symbol]

indicates data missing or illegible when filed

TABLE 4

| | EBSD observation result after first heat treatment | | | | | | | | |
|---|---|---|---|---|---|---|---|---|---|
| | | | | | S [symbol] / | S₁₀₀/ | S₁₀₀/ | K₁₀₀/ | d₁₀₀/ |
| No. | K [symbol] | K [symbol] | K₁₀₀ | K₁₁₀ | S [symbol] | S [symbol] | S [symbol] | K [symbol] | d [symbol] |
| 201 | 0.208 | 0.204 | 0.200 | 0.201 | 0.64 | 0.28 | 0.85 | 0.962 | 1.30 |
| 202 | 0.208 | 0.205 | 0.201 | 0.201 | 0.65 | 0.29 | 0.84 | 0.968 | 1.30 |
| 203 | 0.208 | 0.204 | 0.201 | 0.202 | 0.65 | 0.28 | 0.85 | 0.966 | 1.29 |
| 204 | 0.208 | 0.203 | 0.201 | 0.203 | 0.65 | 0.28 | 0.86 | 0.966 | 1.31 |
| 205 | 0.208 | 0.205 | 0.201 | 0.202 | 0.65 | 0.28 | 0.86 | 0.965 | 1.30 |
| 206 | 0.207 | 0.205 | 0.201 | 0.202 | 0.64 | 0.28 | 0.85 | 0.969 | 1.30 |
| 207 | 0.207 | 0.204 | 0.200 | 0.202 | 0.66 | 0.29 | 0.85 | 0.966 | 1.30 |
| 208 | 0.207 | 0.205 | 0.201 | 0.203 | 0.88 | 0.04 | 0.85 | 0.969 | 1.28 |
| 209 | 0.208 | 0.204 | 0.201 | 0.201 | 0.84 | 0.29 | 0.84 | 0.968 | 1.28 |
| 210 | 0.209 | 0.205 | 0.201 | 0.202 | 0.66 | 0.02 | 0.85 | 0.964 | 1.30 |
| 211 | 0.208 | 0.204 | 0.201 | 0.201 | 0.65 | 0.28 | 0.24 | 0.963 | 1.30 |
| 212 | 0.196 | 0.203 | 0.202 | 0.203 | 0.65 | 0.28 | 0.86 | 1.028 | 1.31 |
| 213 | 0.209 | 0.204 | 0.200 | 0.203 | 0.64 | 0.28 | 0.85 | 0.959 | 0.78 |
| 214 | 0.208 | 0.204 | 0.200 | 0.202 | 0.65 | 0.29 | 0.85 | 0.965 | 1.31 |
| 215 | 0.207 | 0.204 | 0.201 | 0.202 | 0.65 | 0.28 | 0.84 | 0.970 | 1.30 |
| 216 | 0.209 | 0.204 | 0.200 | 0.201 | 0.65 | 0.27 | 0.86 | 0.957 | 1.31 |
| 217 | 0.211 | 0.205 | 0.202 | 0.200 | 0.65 | 0.29 | 0.85 | 0.958 | 1.29 |
| 218 | 0.208 | 0.206 | 0.198 | 0.199 | 0.64 | 0.29 | 0.85 | 0.955 | 1.29 |
| 220 | 0.210 | 0.202 | 0.200 | 0.204 | 0.65 | 0.28 | 0.86 | 0.951 | 1.30 |
| 221 | 0.210 | 0.204 | 0.199 | 0.202 | 0.65 | 0.28 | 0.85 | 0.948 | 1.30 |
| 222 | 0.207 | 0.204 | 0.198 | 0.203 | 0.65 | 0.29 | 0.84 | 0.956 | 1.29 |
| 223 | 0.209 | 0.207 | 0.198 | 0.204 | 0.64 | 0.28 | 0.85 | 0.948 | 1.30 |
| 224 | 0.209 | 0.206 | 0.203 | 0.200 | 0.64 | 0.29 | 0.85 | 0.972 | 1.29 |
| 225 | 0.211 | 0.207 | 0.202 | 0.200 | 0.65 | 0.28 | 0.84 | 0.957 | 1.30 |
| 226 | 0.207 | 0.203 | 0.201 | 0.199 | 0.64 | 0.28 | 0.85 | 0.968 | 1.29 |
| 227 | 0.207 | 0.207 | 0.199 | 0.200 | 0.64 | 0.29 | 0.85 | 0.961 | 1.29 |
| 228 | 0.208 | 0.201 | 0.200 | 0.199 | 0.65 | 0.28 | 0.84 | 0.964 | 1.30 |
| 229 | 0.206 | 0.203 | 0.199 | 0.200 | 0.65 | 0.28 | 0.84 | 0.965 | 1.30 |
| 230 | 0.206 | 0.201 | 0.199 | 0.201 | 0.65 | 0.29 | 0.85 | 0.965 | 1.29 |
| 231 | 0.206 | 0.204 | 0.199 | 0.204 | 0.65 | 0.29 | 0.85 | 0.967 | 1.30 |
| 232 | 0.206 | 0.207 | 0.201 | 0.202 | 0.65 | 0.28 | 0.85 | 0.975 | 1.29 |
| 233 | 0.209 | 0.207 | 0.199 | 0.198 | 0.65 | 0.28 | 0.84 | 0.955 | 1.29 |
| 234 | 0.207 | 0.201 | 0.202 | 0.203 | 0.64 | 0.29 | 0.85 | 0.978 | 1.30 |
| 235 | 0.210 | 0.202 | 0.198 | 0.202 | 0.64 | 0.28 | 0.85 | 0.946 | 1.30 |
| 236 | 0.208 | 0.205 | 0.203 | 0.202 | 0.65 | 0.28 | 0.85 | 0.975 | 1.29 |
| 237 | 0.206 | 0.204 | 0.198 | 0.201 | 0.65 | 0.27 | 0.86 | 0.963 | 1.29 |
| 238 | 0.206 | 0.208 | 0.199 | 0.204 | 0.87 | 0.04 | 0.86 | 0.965 | 1.27 |
| 239 | 0.205 | 0.206 | 0.200 | 0.204 | 0.88 | 0.04 | 0.85 | 0.973 | 1.29 |
| 240 | Not evaluated since cracking occurs during cold rolling | | | | | | | | |
| 241 | Not evaluated since cracking occurs during cold rolling | | | | | | | | |
| 242 | 0.208 | 0.205 | 0.198 | 0.205 | 0.87 | 0.04 | 0.86 | 0.953 | 1.28 |
| 243 | 0.206 | 0.206 | 0.199 | 0.200 | 0.88 | 0.05 | 0.85 | 0.967 | 1.29 |
| 244 | 0.206 | 0.206 | 0.200 | 0.205 | 0.87 | 0.03 | 0.84 | 0.972 | 1.29 |
| 245 | 0.208 | 0.207 | 0.200 | 0.203 | 0.88 | 0.04 | 0.85 | 0.964 | 1.29 |
| 246 | Not evaluated since cracking occurs during cold rolling | | | | | | | | |
| 247 | 0.210 | 0.198 | 0.202 | 0.201 | 0.64 | 0.28 | 0.84 | 0.962 | 1.30 |
| 248 | 0.205 | 0.204 | 0.201 | 0.203 | 0.65 | 0.28 | 0.84 | 6.980 | 1.31 |
| 249 | 0.206 | 6.201 | 0.201 | 0.200 | 0.50 | 0.20 | 0.84 | 0.977 | 1.30 |
| 250 | 0.207 | 0.204 | 0.199 | 0.197 | 0.66 | 0.29 | 0.84 | 0.962 | 1.30 |

| | EBSD observation result | | | | | Second | | |
|---|---|---|---|---|---|---|---|---|
| | after first heat treatment | | | | | heat treatment | | |
| | d₁₀₀/ | K₁₀₀/ | d₁₀₀/ | S₁₀₀/ | K₁₀₀/ | W10/400 | W15/50(C)/ | |
| No. | d [symbol] | K [symbol] | d [symbol] | S₁₁₀ | K₁₁₀ | (W/kg) | W15/50(L) | Note |
| 201 | 1.49 | 0.982 | 1.09 | 6.79 | 0.994 | 10.5 | 1.11 | Invention |
| | | | | | | | | Example |
| 202 | 1.50 | 0.984 | 1.11 | 6.81 | 1.001 | 10.6 | 1.12 | In vention |
| | | | | | | | | Example |
| 203 | 1.51 | 0.983 | 1.10 | 6.79 | 0.995 | 10.5 | 1.08 | Invention |
| | | | | | | | | Example |
| 204 | 1.51 | 0.988 | 1.11 | 6.81 | 0.990 | 10.5 | 1.12 | Invention |
| | | | | | | | | Example |
| 205 | 1.51 | 0.982 | 1.09 | 6.80 | 0.998 | 10.6 | 1.07 | In vention |
| | | | | | | | | Example |
| 206 | 1.51 | 0.980 | 1.09 | 6.82 | 0.992 | 10.5 | 1.11 | Invention |
| | | | | | | | | Example |
| 207 | 1.51 | 0.981 | 1.10 | 6.79 | 0.990 | 10.4 | 1.12 | Invention |
| | | | | | | | | Example |
| 208 | 1.48 | 0.983 | 1.10 | 1.51 | 0.992 | 15.5 | 1.41 | Comparative |
| | | | | | | | | Example |
| 209 | 1.49 | 0.988 | 1.09 | 6.80 | 0.999 | 12.4 | 1.41 | Comparative |
| | | | | | | | | Example |
| 210 | 1.51 | 0.984 | 1.09 | 6.81 | 1.000 | 12.3 | 1.42 | Comparative |
| | | | | | | | | Example |
| 211 | 1.51 | 0.985 | 1.09 | 0.30 | 0.995 | 12.3 | 1.41 | Comparative |
| | | | | | | | | Example |
| 212 | 1.49 | 0.995 | 1.11 | 6.79 | 0.996 | 12.2 | 1.38 | Comparative |
| | | | | | | | | Example |
| 213 | 1.51 | 0.979 | 1.11 | 6.80 | 0.986 | 12.4 | 1.41 | Comparative |
| | | | | | | | | Example |
| 214 | 0.90 | 0.983 | 1.10 | 6.82 | 0.994 | 12.4 | 1.38 | Comparative |
| | | | | | | | | Example |
| 215 | 1.49 | 0.984 | 1.08 | 6.81 | 0.994 | 11.3 | 1.08 | Invention |
| | | | | | | | | Example |
| 216 | 1.50 | 0.981 | 1.10 | 6.80 | 0.995 | 11.3 | 1.08 | Invention |
| | | | | | | | | Example |
| 217 | 1.49 | 0.985 | 1.10 | 6.78 | 1.009 | 10.6 | 1.12 | Invention |
| | | | | | | | | Example |
| 218 | 1.49 | 0.963 | 1.09 | 6.79 | 0.999 | 10.5 | 1.08 | Invention |
| | | | | | | | | Example |
| 220 | 1.49 | 0.988 | 1.09 | 6.79 | 0.980 | 10.7 | 1.09 | Invention |
| | | | | | | | | Example |
| 221 | 1.48 | 0.974 | 1.08 | 6.79 | 0.984 | 10.8 | 1.11 | Invention |
| | | | | | | | | Example |
| 222 | 1.48 | 0.968 | 1.10 | 6.79 | 0.974 | 10.2 | 1.11 | Invention |
| | | | | | | | | Example |
| 223 | 1.49 | 0.958 | 1.10 | 6.80 | 0.972 | 10.7 | 1.07 | Invention |
| | | | | | | | | Example |
| 224 | 1.48 | 0.986 | 1.09 | 6.80 | 1.013 | 10.3 | 1.09 | Invention |
| | | | | | | | | Example |
| 225 | 1.49 | 0.978 | 1.10 | 6.79 | 1.008 | 10.1 | 1.10 | Invention |
| | | | | | | | | Example |
| 226 | 1.48 | 0.990 | 1.10 | 6.79 | 1.006 | 10.8 | 1.10 | Invention |
| | | | | | | | | Example |
| 227 | 1.49 | 0.962 | 1.10 | 6.79 | 0.995 | 10.9 | 1.07 | Invention |
| | | | | | | | | Example |
| 228 | 1.49 | 0.994 | 1.10 | 6.79 | 1.005 | 10.5 | 1.08 | Invention |
| | | | | | | | | Example |
| 229 | 1.48 | 0.981 | 1.10 | 6.78 | 0.994 | 10.6 | 1.12 | Invention |
| | | | | | | | | Example |
| 230 | 1.49 | 0.986 | 1.09 | 6.79 | 0.990 | 10.5 | 1.10 | Invention |
| | | | | | | | | Example |
| 231 | 1.49 | 0.976 | 1.09 | 6.79 | 0.976 | 10.1 | 1.07 | Invention |
| | | | | | | | | Example |
| 232 | 1.50 | 0.972 | 1.09 | 6.78 | 0.994 | 10.5 | 1.12 | Invention |
| | | | | | | | | Example |
| 233 | 1.48 | 0.964 | 1.09 | 6.79 | 1.005 | 9.9 | 1.11 | Invention |
| | | | | | | | | Example |
| 234 | 1.49 | 1.006 | 1.09 | 6.79 | 0.999 | 10.1 | 1.11 | Invention |
| | | | | | | | | Example |
| 235 | 1.49 | 0.981 | 1.09 | 6.80 | 0.983 | 10.6 | 1.07 | Invention |
| | | | | | | | | Example |
| 236 | 1.49 | 0.990 | 1.09 | 6.79 | 1.006 | 10.3 | 1.12 | Invention |
| | | | | | | | | Example |
| 237 | 1.50 | 0.973 | 1.10 | 6.80 | 0.983 | 10.6 | 1.12 | Invention |
| | | | | | | | | Example |
| 238 | 1.48 | 0.959 | 1.10 | 1.52 | 0.974 | 15.5 | 1.42 | Comparative |
| | | | | | | | | Example |
| 239 | 1.49 | 0.967 | 1.11 | 1.51 | 0.977 | 15.6 | 1.41 | Comparative |
| | | | | | | | | Example |
| 240 | Not evaluated since cracking occurs during cold rolling | | | | | | | Comparative |
| | | | | | | | | Example |
| 241 | Not evaluated since cracking occurs during cold rolling | | | | | | | Comparative |
| | | | | | | | | Example |
| 242 | 1.48 | 0.967 | 1.10 | 1.51 | 0.968 | 15.6 | 1.38 | Comparative |
| | | | | | | | | Example |
| 243 | 1.48 | 0.964 | 1.11 | 1.51 | 0.992 | 15.6 | 1.39 | Comparative |
| | | | | | | | | Example |
| 244 | 1.47 | 0.970 | 1.10 | 1.50 | 0.977 | 15.5 | 1.42 | Comparative |
| | | | | | | | | Example |
| 245 | 1.49 | 0.969 | 1.11 | 1.52 | 0.987 | 15.6 | 1.37 | Comparative |
| | | | | | | | | Example |
| 246 | Not evaluated since cracking occurs during cold rolling | | | | | | | Comparative |
| | | | | | | | | Example |
| 247 | 1.50 | 1.017 | 1.10 | 6.81 | 1.002 | 10.4 | 1.20 | Invention |
| | | | | | | | | Example |
| 248 | 1.49 | 0.988 | 0.99 | 6.80 | 0.993 | 10.4 | 1.23 | Invention |
| | | | | | | | | Example |
| 249 | 1.50 | 0.999 | 1.09 | 0.98 | 1.006 | 10.5 | 1.22 | Invention |
| | | | | | | | | Example |
| 250 | 1.49 | 0.973 | 1.10 | 6.79 | 1.008 | 10.4 | 1.23 | Invention |
| | | | | | | | | Example |

[symbol]

indicates data missing or illegible when filed

Underlined values in Table 3A, Table 3B, and Table 4 indicate conditions deviating from the scope of the present invention. In all of No. 201 to No. 207, No. 215 to No. 237, and No. 247 to No. 250, which are invention examples, the iron losses W10/400 were favorable values.

On the other hand, in No. 208, which is a comparative example, the Mn concentration was high, and the value of the left side of Formula (1) was more than 0.00 (a composition that underwent α-γ transformation), which made the area ratio S_{tyl}/Sₜₒₜ and the area ratio S₁₀₀/Sₜₒₜ each deviate from the range of Formula (10) or Formula (11). As a result, the iron loss W10/400 was high. In No. 209 to No. 214, which are comparative examples, since at least any of the temperature in the hot-rolled sheet annealing, the temperature in the intermediate annealing, the rolling reduction in the cold rolling, the rolling reduction in the skin pass rolling, and the temperature in the first heat treatment was not optimal, any of Formula (10) to Formula (15) was not satisfied, and, as a result, the iron losses W10/400 were high.

In addition, in No. 238 to No. 246, which are comparative examples, since the chemical compositions were outside the scope of the present invention, Formula (10) and Formula (11) were not satisfied, and the iron losses W10/400 became high or cracking occurred during the cold rolling.

### Third Example

Molten steel was cast, thereby producing ingots having chemical compositions shown in Table 5A. Here, the column “Left side of Formula (1)” indicates the values of the left side of Formula (1) described above. After that, the produced ingots were hot-rolled by being heated up to 1150° C. and rolled such that the sheet thicknesses became as shown in Table 5B. In addition, after the end of finish rolling, the hot-rolled steel sheets were cooled with water and coiled. The temperatures (finish temperatures) in a stage of the final pass of the finish rolling at this time were 830° C., and the coiling temperatures were within a range of 500° C. to 700° C.

Next, hot-rolled sheet annealing was performed on the hot-rolled steel sheets under conditions shown in Table 5B for 30 seconds, scales were removed by pickling, and cold rolling was performed at rolling reductions shown in Table 5B. In addition, intermediate annealing was performed in a non-oxidizing atmosphere at 800° C. for 30 seconds. Next, the second round of cold rolling (skin pass rolling) was performed at rolling reductions shown in Table 5B.

In order to investigate the textures after the skin pass rolling, a part of each of the steel sheets was cut, the cut test piece was processed to reduce the thickness to ½, and EBSD observation (step intervals: 100 nm) was performed on the processed surface in the above-described manner S_{tyl}/Sₜₒₜ, S₁₀₀/Sₜₒₜ, S₁₀₀/Sₜᵣₐ, and K₁₀₀/K_{tyl} were obtained from the area and average KAM value of each kind of the orientated grains obtained by EBSD observation.

In addition, on the steel sheets after the skin pass rolling, a second heat treatment was performed under conditions shown in Table 5B without a first heat treatment. After the second heat treatment, in order to investigate the textures, a part of each of the steel sheets was cut, the cut test piece was processed to reduce the thickness to ½, and EBSD observation was performed on the processed surface. The areas and average grain sizes of kinds shown in Table 6 were obtained by EBSD observation.

In addition, after the second heat treatment, from each of the steel sheets after the second heat treatment, 55 mm×55 mm sample pieces were collected as measurement samples. The samples were collected using a shearing machine. In addition, as the magnetic characteristics, the iron losses W10/400 (average value of the rolling direction and the width direction), W15/50 (C), and W15/50 (L) were measured in the same manner as in First Example, and W15/50 (C)/W15/50 (L) were obtained. The measurement results are shown in Table 6.

TABLE 5A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Left |
| | | | | | | | | | | | | | | | | | side |
| | | | | | | | | | | | | | | | | | of |
| | | | | | | | | | | | | | | | | | For- |
| | | | | | | | | | | | | | | | | | mula |
| No. | C | Si | sol. Al | S | N | Mn | Ni | Co | Pt | Pb | Cu | Au | Cr | Mg | B | O | (1) |
| 301 | 0.0010 | 3.21 | 0.59 | 0.0020 | 0.0020 | 0.20 | — | — | — | — | — | — | 0.003 | — | — | — | −3.60 |
| 302 | 0.0010 | 3.20 | 0.61 | 0.0022 | 0.0021 | 0.20 | — | — | — | — | — | — | 0.003 | — | — | — | −3.61 |
| 303 | 0.0009 | 3.20 | 0.60 | 0.0020 | 0.0020 | — | 0.20 | — | — | — | — | — | 0.003 | — | — | — | −3.60 |
| 304 | 0.0009 | 3.20 | 0.60 | 0.0021 | 0.0021 | — | — | 0.21 | — | — | — | — | 0.004 | — | — | — | −3.60 |
| 305 | 0.0010 | 3.21 | 0.61 | 0.0021 | 0.0023 | — | — | — | 0.21 | — | — | — | 0.004 | — | — | — | −3.61 |
| 306 | 0.0009 | 3.20 | 0.59 | 0.0019 | 0.0020 | — | — | — | — | 0.20 | — | — | 0.004 | — | — | — | −3.60 |
| 307 | 0.0011 | 3.21 | 0.60 | 0.0022 | 0.0022 | — | — | — | — | — | 0.20 | — | 0.003 | — | — | — | −3.61 |
| 308 | 0.0010 | 3.20 | 0.60 | 0.0021 | 0.0023 | — | — | — | — | — | — | 0.21 | 0.004 | — | — | — | −3.59 |
| 309 | 0.0009 | 2.00 | 0.31 | 0.0018 | 0.0019 | 2.41 | — | — | — | — | — | — | 0.003 | — | — | — | 0.10 |
| 310 | 0.0009 | 3.19 | 0.60 | 0.0017 | 0.0017 | 0.19 | — | — | — | — | — | — | 0.003 | — | — | — | −3.60 |
| 311 | 0.0011 | 3.21 | 0.59 | 0.0019 | 0.0022 | 0.20 | — | — | — | — | — | — | 0.003 | — | — | — | −3.60 |
| 312 | 0.0009 | 3.20 | 0.59 | 0.0020 | 0.0021 | 0.20 | — | — | — | — | — | — | 0.002 | — | — | — | −3.60 |
| 313 | 0.0010 | 3.20 | 0.59 | 0.0018 | 0.0017 | 0.19 | — | — | — | — | — | — | 0.003 | — | — | — | −3.60 |
| 314 | 0.0010 | 3.21 | 0.59 | 0.0020 | 0.0020 | 0.19 | — | — | — | — | — | — | 0.002 | — | — | — | −3.61 |
| 315 | 0.0012 | 3.20 | 0.60 | 0.0018 | 0.0018 | 0.20 | — | — | — | — | — | — | 0.003 | — | — | — | −3.60 |
| 316 | 0.0083 | 3.22 | 0.61 | 0.0017 | 0.0020 | 0.21 | — | — | — | — | — | — | 0.003 | — | — | — | −3.61 |
| 317 | 0.0010 | 1.60 | 0.60 | 0.0018 | 0.0020 | 0.21 | — | — | — | — | — | — | 0.002 | — | — | — | −1.99 |
| 318 | 0.0010 | 3.91 | 0.61 | 0.0018 | 0.0019 | 0.22 | — | — | — | — | — | — | 0.003 | — | — | — | −4.29 |
| 319 | 0.0010 | 3.22 | 0.01 | 0.0017 | 0.0021 | 0.22 | — | — | — | — | — | — | 0.002 | — | — | — | −3.01 |
| 320 | 0.0008 | 3.21 | 2.80 | 0.0019 | 0.0019 | 0.22 | — | — | — | — | — | — | 0.002 | — | — | — | −5.80 |
| 321 | 0.0009 | 3.22 | 0.60 | 0.0006 | 0.0021 | 0.21 | — | — | — | — | — | — | 0.004 | — | — | — | −3.61 |
| 322 | 0.0008 | 3.23 | 0.60 | 0.0092 | 0.0019 | 0.22 | — | — | — | — | — | — | 0.003 | — | — | — | −3.61 |
| 323 | 0.0008 | 3.21 | 0.60 | 0.0020 | 0.0093 | 0.21 | — | — | — | — | — | — | 0.002 | — | — | — | −3.61 |
| 324 | 0.0008 | 3.22 | 0.60 | 0.0017 | 0.0021 | 0.23 | — | — | — | — | — | — | 0.004 | 0.0005 | — | — | −3.59 |
| 325 | 0.0008 | 3.23 | 0.61 | 0.0351 | 0.0019 | 0.22 | — | — | — | — | — | — | 0.004 | 0.0091 | — | — | −3.62 |
| 326 | 0.0009 | 3.22 | 0.61 | 0.0018 | 0.0019 | 0.21 | — | — | — | — | — | — | 0.001 | — | — | — | −3.63 |
| 327 | 0.0008 | 3.22 | 0.60 | 0.0020 | 0.0018 | 0.22 | — | — | — | — | — | — | 0.093 | — | — | — | −3.60 |
| 328 | 0.0011 | 3.23 | 0.60 | 0.0017 | 0.0018 | 0.21 | — | — | — | — | — | — | 0.004 | — | — | — | −3.62 |
| 329 | 0.0008 | 3.21 | 2.80 | 0.0018 | 0.0022 | 2.40 | — | — | — | — | — | — | 0.003 | — | — | — | −3.62 |
| 330 | 0.0010 | 3.21 | 0.59 | 0.0019 | 0.0019 | 0.20 | — | — | — | — | — | — | 0.003 | — | 0.0002 | — | −3.60 |
| 331 | 0.0011 | 3.20 | 0.59 | 0.0020 | 0.0018 | 0.22 | — | — | — | — | — | — | 0.004 | — | 0.0044 | — | −3.58 |
| 332 | 00011 | 3.21 | 0.59 | 0.0020 | 0.0020 | 0.22 | — | — | — | — | — | — | 0.004 | — | — | 0.0016 | −3.58 |
| 333 | 0.0008 | 3.19 | 0.59 | 0.0018 | 0.0017 | 0.22 | — | — | — | — | — | — | 0.003 | — | — | 0.0169 | −3.57 |
| 334 | 0.0120 | 3.22 | 0.60 | 0.0019 | 0.0018 | 0.21 | — | — | — | — | — | — | 0.002 | — | — | — | −3.61 |
| 335 | 0.0010 | 1.40 | 0.60 | 0.0020 | 0.0019 | 0.22 | — | — | — | — | — | — | 0.003 | — | — | — | −1.78 |
| 336 | 0.0008 | 4.21 | 0.60 | 0.0018 | 0.0018 | 0.20 | — | — | — | — | — | — | 0.002 | — | — | — | −4.61 |
| 338 | 0.0010 | 3.22 | 4.19 | 0.0018 | 0.0019 | 0.20 | — | — | — | — | — | — | 0.004 | — | — | — | −7.20 |
| 339 | 0.0008 | 3.22 | 0.61 | 0.0451 | 0.0020 | 0.21 | — | — | — | — | — | — | 0.004 | — | — | — | −3.62 |
| 340 | 0.0011 | 3.22 | 0.61 | 0.0020 | 0.0121 | 0.20 | — | — | — | — | — | — | 0.004 | — | — | — | −3.63 |
| 341 | 0.0008 | 3.23 | 0.61 | 0.0017 | 0.0022 | 0.21 | — | — | — | — | — | — | 0.000 | — | — | — | −3.63 |
| 342 | 0.0010 | 3.22 | 0.59 | 0.0019 | 0.0021 | 0.21 | — | — | — | — | — | — | 0.121 | — | — | — | −3.60 |
| 343 | 0.0008 | 3.21 | 0.60 | 0.0018 | 0.0021 | 2.60 | — | — | — | — | — | — | 0.003 | — | — | — | −1.21 |
| 344 | 0.0011 | 3.21 | 0.58 | 0.0020 | 0.0018 | 0.20 | — | — | — | — | — | — | 0.003 | — | — | — | −3.60 |

TABLE 5B

| | After hot | Hot-rolled sheet | | | | | | | Second heat | | |
|---|---|---|---|---|---|---|---|---|---|---|---|
| | rolling | annealing | Rolling | | EBSD observation result | | | | treatment | | |
| | Sheet | Annealing | reduction (%) | | after skin pass rolling | | | | Annealing | Annealing | |
| | thickness | temperature | Cold | Skin pass | S [symbol] / | S₁₀₀/ | S₁₀₀/ | K₁₀₀/ | temperature | time | |
| | (mm) | (° C.) | rolling | rolling | S [symbol] | S [symbol] | S [symbol] | K [symbol] | (° C.) | (s) | Note |
| 301 | 2.50 | 1050 | 92 | 10 | 0.72 | 0.15 | 0.72 | 0.977 | 1050 | 30 | Invention |
| | | | | | | | | | | | Example |
| 302 | 2.50 | 1050 | 92 | 10 | 0.72 | 0.16 | 0.72 | 0.981 | 800 | 7200 | Invention |
| | | | | | | | | | | | Example |
| 303 | 2.50 | 1050 | 92 | 10 | 0.73 | 0.15 | 0.73 | 0.975 | 1050 | 30 | Invention |
| | | | | | | | | | | | Example |
| 304 | 2.50 | 1050 | 92 | 10 | 0.74 | 0.16 | 0.72 | 0.982 | 1050 | 30 | Invention |
| | | | | | | | | | | | Example |
| 305 | 2.50 | 1050 | 92 | 10 | 0.73 | 0.15 | 0.72 | 0.986 | 1050 | 30 | Invention |
| | | | | | | | | | | | Example |
| 306 | 2.50 | 1050 | 92 | 10 | 0.74 | 0.16 | 0.72 | 0.980 | 1050 | 30 | Invention |
| | | | | | | | | | | | Example |
| 307 | 2.50 | 1050 | 92 | 10 | 0.73 | 0.16 | 0.70 | 0.978 | 1050 | 30 | Invention |
| | | | | | | | | | | | Example |
| 308 | 2.50 | 1050 | 92 | 10 | 0.72 | 0.15 | 0.73 | 0.979 | 1050 | 30 | Invention |
| | | | | | | | | | | | Example |
| 309 | 2.50 | 1050 | 92 | 10 | 0.90 | 0.03 | 0.72 | 0.977 | 1050 | 30 | Comparative. |
| | | | | | | | | | | | Example |
| 310 | 2.50 | 850 | 92 | 10 | 0.88 | 0.15 | 0.71 | 0.977 | 1050 | 30 | Comparative. |
| | | | | | | | | | | | Example |
| 311 | 1.33 | 850 | 85 | 10 | 0.72 | 0.02 | 0.71 | 0.977 | 1050 | 30 | Comparative |
| | | | | | | | | | | | Example |
| 312 | 0.50 | 1050 | 60 | 10 | 0.73 | 0.15 | 0.24 | 0.981 | 1050 | 30 | Comparative. |
| | | | | | | | | | | | Example |
| 313 | 1.33 | 850 | 85 | 15 | 0.73 | 0.01 | 0.71 | 0.978 | 1050 | 30 | Comparative. |
| | | | | | | | | | | | Example |
| 314 | 1.33 | 850 | 85 | 20 | 0.73 | 0.02 | 0.72 | 0.979 | 1050 | 30 | Comparative |
| | | | | | | | | | | | Example |
| 315 | 1.33 | 850 | 85 | 25 | 0.72 | 0.01 | 0.72 | 0.978 | 1050 | 30 | Comparative |
| | | | | | | | | | | | Example |
| 316 | 2.50 | 1050 | 92 | 10 | 0.73 | 0.16 | 0.73 | 0.977 | 1050 | 30 | Invention |
| | | | | | | | | | | | Example |
| 317 | 2.50 | 1050 | 92 | 10 | 0.72 | 0.15 | 0.72 | 0.978 | 1050 | 30 | Invention |
| | | | | | | | | | | | Example |
| 318 | 2.50 | 1050 | 92 | 10 | 0.71 | 0.14 | 0.72 | 0.980 | 1050 | 30 | Invention |
| | | | | | | | | | | | Example |
| 319 | 2.50 | 1050 | 92 | 10 | 0.73 | 0.16 | 0.73 | 0.979 | 1050 | 30 | Invention |
| | | | | | | | | | | | Example |
| 320 | 2.50 | 1050 | 92 | 10 | 0.73 | 0.14 | 0.72 | 0.978 | 1050 | 30 | Invention |
| | | | | | | | | | | | Example |
| 321 | 2.50 | 1050 | 92 | 10 | 0.73 | 0.15 | 0.72 | 0.980 | 1050 | 30 | Invention |
| | | | | | | | | | | | Example |
| 322 | 2.50 | 1050 | 92 | 10 | 0.73 | 0.14 | 0.73 | 0.978 | 1050 | 30 | Invention |
| | | | | | | | | | | | Example |
| 323 | 2.50 | 1050 | 92 | 10 | 0.71 | 0.14 | 0.71 | 0.982 | 1050 | 30 | Invention |
| | | | | | | | | | | | Example |
| 324 | 2.50 | 1050 | 92 | 10 | 0.73 | 0.14 | 0.72 | 0.980 | 1050 | 30 | Invention |
| | | | | | | | | | | | Example |
| 325 | 2.50 | 1050 | 92 | 10 | 0.72 | 0.14 | 0.72 | 0.981 | 1050 | 30 | Invention |
| | | | | | | | | | | | Example |
| 326 | 2.50 | 1050 | 92 | 10 | 0.73 | 0.14 | 0.72 | 0.981 | 1050 | 30 | Invention |
| | | | | | | | | | | | Example |
| 327 | 2.50 | 1050 | 92 | 10 | 0.72 | 0.15 | 0.71 | 0.980 | 1050 | 30 | Invention |
| | | | | | | | | | | | Example |
| 328 | 2.50 | 1050 | 92 | 10 | 0.71 | 0.15 | 0.71 | 0.979 | 1050 | 30 | Invention |
| | | | | | | | | | | | Example |
| 329 | 2.50 | 1050 | 92 | 10 | 0.72 | 0.14 | 0.73 | 0.980 | 1050 | 30 | Invention |
| | | | | | | | | | | | Example |
| 330 | 2.50 | 1050 | 92 | 10 | 0.72 | 0.15 | 0.72 | 0.978 | 1050 | 30 | Invention |
| | | | | | | | | | | | Example |
| 331 | 2.50 | 1050 | 92 | 10 | 0.71 | 0.15 | 0.73 | 0.980 | 1050 | 30 | Invention |
| | | | | | | | | | | | Example |
| 332 | 2.50 | 1050 | 92 | 10 | 0.73 | 0.15 | 0.72 | 0.981 | 1050 | 30 | Invention |
| | | | | | | | | | | | Example |
| 333 | 2.50 | 1050 | 92 | 10 | 0.73 | 0.16 | 0.71 | 0.982 | 1050 | 30 | Invention |
| | | | | | | | | | | | Example |
| 334 | 2.50 | 1050 | 92 | 10 | 0.89 | 0.03 | 0.72 | 0.977 | 1050 | 30 | Comparative |
| | | | | | | | | | | | Example |
| 335 | 2.50 | 1050 | 92 | 10 | 0.88 | 0.02 | 0.71 | 0.977 | 1050 | 30 | Comparative |
| | | | | | | | | | | | Example |
| 336 | 2.50 | 1050 | 92 | Cracking occurs during cold rolling | | | | | | | Comparative. |
| | | | | | | | | | | | Example |
| 338 | 2.50 | 1050 | 92 | Cracking occurs during cold rolling | | | | | | | Comparative |
| | | | | | | | | | | | Example |
| 339 | 2.50 | 1050 | 92 | 10 | 0.90 | 0.03 | 0.72 | 0.982 | 1050 | 30 | Comparative |
| | | | | | | | | | | | Example |
| 340- | 2.50 | 1050 | 92 | 10 | 0.88 | 0.02 | 0.71 | 0.981 | 1050 | 30 | Comparative |
| | | | | | | | | | | | Example |
| 341 | 2.50 | 1050 | 92 | 10 | 0.88 | 0.03 | 0.72 | 0.977 | 1050 | 30 | Comparative |
| | | | | | | | | | | | Example |
| 342 | 2.50 | 1050 | 92 | 10 | 0.89 | 0.04 | 0.72 | 0.982 | 1050 | 30 | Comparative |
| | | | | | | | | | | | Example |
| 343 | 2.50 | 1050 | 92 | Cracking occurs during cold rolling | | | | | | | Comparative |
| | | | | | | | | | | | Example |
| 344 | 2.50 | 1050 | 92 | 10 | 0.71 | 0.14 | 0.73 | 0.977 | 9.70 | 30 | Invention. |
| | | | | | | | | | | | Example |

[symbol]

indicates data missing or illegible when filed

TABLE 6

| | EBSD observation result | | | | | | Second | | |
|---|---|---|---|---|---|---|---|---|---|
| | after second heat treatment | | | | | | heat treatment | | |
| | S [symbol] / | S₁₀₀/ | S₁₀₀/ | d₁₀₀/ | d₁₀₀/ | d₁₀₀/ | W10/400 | W15/50(C)/ | |
| No. | S [symbol] | S [symbol] | S [symbol] | d [symbol] | d [symbol] | d [symbol] | (W/kg) | W15/50(L) | Note |
| 301 | 0.46 | 0.34 | 0.77 | 1.02 | 1.04 | 0.98 | 10.6 | 1.09 | Invention |
| | | | | | | | | | Example |
| 302 | 0.44 | 0.35 | 0.76 | 1.02 | 1.05 | 0.98 | 10.5 | 1.12 | Invention |
| | | | | | | | | | Example |
| 303 | 0.44 | 0.35 | 0.73 | 1.02 | 1.05 | 0.98 | 10.4 | 1.09 | Invention |
| | | | | | | | | | Example |
| 304 | 0.43 | 0.36 | 0.74 | 1.02 | 1.04 | 0.98 | 10.6 | 1.13 | Invention |
| | | | | | | | | | Example |
| 305 | 0.45 | 0.37 | 0.76 | 1.03 | 1.04 | 0.98 | 10.5 | 1.11 | Invention |
| | | | | | | | | | Example |
| 306 | 0.45 | 0.37 | 0.75 | 1.03 | 1.04 | 0.98 | 10.6 | 1.08 | Invention |
| | | | | | | | | | Example |
| 307 | 0.43 | 0.36 | 0.77 | 1.03 | 1.04 | 0.99 | 10.5 | 1.10 | Invention |
| | | | | | | | | | Example |
| 308 | 0.47 | 0.36 | 0.75 | 1.01 | 1.04 | 0.98 | 10.5 | 1.13 | Invention |
| | | | | | | | | | Example |
| 309 | 0.85 | 0.02 | 0.76 | 1.02 | 1.03 | 0.98 | 15.5 | 1.39 | Comparative |
| | | | | | | | | | Example |
| 310 | 0.81 | 0.33 | 0.74 | 1.01 | 1.04 | 0.99 | 12.3 | 1.42 | Comparative |
| | | | | | | | | | Example |
| 311 | 0.46 | 0.04 | 0.74 | 1.02 | 1.05 | 0.99 | 12.2 | 1.43 | Comparative |
| | | | | | | | | | Example |
| 312 | 0.46 | 0.15 | 0.25 | 1.03 | 1.05 | 0.99 | 12.3 | 1.39 | Comparative |
| | | | | | | | | | Example |
| 313 | 0.77 | 0.13 | 0.75 | 0.94 | 1.03 | 0.98 | 12.3 | 1.40 | Comparative |
| | | | | | | | | | Example |
| 314 | 0.76 | 0.13 | 0.73 | 1.03 | 0.93 | 0.98 | 12.2 | 1.40 | Comparative |
| | | | | | | | | | Example |
| 315 | 0.76 | 0.13 | 0.76 | 1.01 | 1.05 | 0.93 | 12.2 | 1.41 | Comparative |
| | | | | | | | | | Example |
| 316 | 0.47 | 0.36 | 0.78 | 1.01 | 1.04 | 0.98 | 10.8 | 1.08 | Invention |
| | | | | | | | | | Example |
| 317 | 0.45 | 0.34 | 0.78 | 1.00 | 1.04 | 0.98 | 10.8 | 1.08 | Invention |
| | | | | | | | | | Example |
| 318 | 0.46 | 0.33 | 0.75 | 1.03 | 1.02 | 0.98 | 10.2 | 1.11 | Invention |
| | | | | | | | | | Example |
| 319 | 0.45 | 0.34 | 0.79 | 1.03 | 1.05 | 0.98 | 10.8 | 1.13 | Invention |
| | | | | | | | | | Example |
| 320 | 0.48 | 0.36 | 0.76 | 1.02 | 1.03 | 0.98 | 10.2 | 1.08 | Invention |
| | | | | | | | | | Example |
| 321 | 0.44 | 0.35 | 0.76 | 1.03 | 1.02 | 0.99 | 10.2 | 1.08 | Invention |
| | | | | | | | | | Example |
| 322 | 0.46 | 0.35 | 0.78 | 1.04 | 1.06 | 0.99 | 10.8 | 1.10 | Invention |
| | | | | | | | | | Example |
| 323 | 0.47 | 0.33 | 0.76 | 1.02 | 1.02 | 0.99 | 10.8 | 1.10 | Invention |
| | | | | | | | | | Example |
| 324 | 0.44 | 0.36 | 0.79 | 1.03 | 1.05 | 0.98 | 10.5 | 1.09 | Invention |
| | | | | | | | | | Example |
| 325 | 0.49 | 0.36 | 0.78 | 1.00 | 1.03 | 0.98 | 10.5 | 1.09 | Invention |
| | | | | | | | | | Example |
| 326 | 0.47 | 0.35 | 0.76 | 1.03 | 1.05 | 0.98 | 10.6 | 1.08 | Invention |
| | | | | | | | | | Example |
| 327 | 0.45 | 0.35 | 0.77 | 1.03 | 1.04 | 0.98 | 10.2 | 1.10 | Invention |
| | | | | | | | | | Example |
| 328 | 0.46 | 0.33 | 0.78 | 1.02 | 1.02 | 0.98 | 10.5 | 1.09 | Invention. |
| | | | | | | | | | Example |
| 329 | 0.47 | 0.33 | 0.77 | 1.03 | 1.02 | 0.99 | 9.9 | 1.12 | Invention |
| | | | | | | | | | Example |
| 330 | 0.47 | 0.36 | 0.76 | 1.00 | 1.03 | 0.98 | 10.2 | 1.10 | Invention |
| | | | | | | | | | Example |
| 331 | 0.44 | 0.33 | 0.78 | 1.02 | 1.03 | 0.99 | 10.5 | 1.12 | Invention |
| | | | | | | | | | Example |
| 332 | 0.44 | 0.36 | 0.77 | 1.00 | 1.06 | 0.98 | 10.2 | 1.10 | Invention |
| | | | | | | | | | Example |
| 333 | 0.48 | 0.34 | 0.78 | 1.01 | 1.04 | 0.98 | 10.5 | 1.09 | Invention |
| | | | | | | | | | Example |
| 334 | 0.86 | 0.01 | 0.75 | 1.03 | 1.03 | 0.99 | 15.5 | 1.38 | Comparative |
| | | | | | | | | | Example |
| 335 | 0.86 | 0.01 | 0.76 | 1.01 | 1.02 | 0.99 | 15.5 | 1.38 | Comparative |
| | | | | | | | | | Example |
| 336 | Not evaluated since cracking occurs during cold rolling | | | | | | | | Comparative |
| | | | | | | | | | Example |
| 338 | Not evaluated since cracking occurs during cold rolling | | | | | | | | Comparative |
| | | | | | | | | | Example |
| 339 | 0.85 | 0.03 | 0.75 | 1.03 | 1.05 | 0.98 | 15.5 | 1.40 | Comparative |
| | | | | | | | | | Example |
| 340 | 0.84 | 0.00 | 0.75 | 1.00 | 1.03 | 0.99 | 15.5 | 1.41 | Comparative |
| | | | | | | | | | Example |
| 341 | 0.85 | 0.00 | 0.76 | 1.02 | 1.05 | 0.98 | 15.5 | 1.40 | Comparative |
| | | | | | | | | | Example |
| 342 | 0.85 | 0.02 | 0.75 | 1.03 | 1.05 | 0.99 | 15.5 | 1.41 | Comparative |
| | | | | | | | | | Example |
| 343 | Not evaluated since cracking occurs during cold colling | | | | | | | | Comparative |
| | | | | | | | | | Example |
| 344 | 0.45 | 0.35 | 0.79 | 1.00 | 1.03 | 0.93 | 10.6 | 1.12 | Invention |
| | | | | | | | | | Example |

[symbol]

indicates data missing or illegible when filed

Underlined values in Table 5A, Table 5B, and Table 6 indicate conditions deviating from the scope of the present invention. In all of No. 301 to No. 308, No. 316 to No. 333, and No. 344, which are invention examples, the iron losses W10/400 were favorable values.

On the other hand, in No. 309, which is a comparative example, the Mn concentration was high, and the value of the left side of Formula (1) was more than 0.00 (a composition that underwent α-γ transformation), which made S_{tyl}/Sₜₒₜ and S₁₀₀/Sₜₒₜ each deviate from the range of Formula (20) or Formula (21). As a result, the iron loss W10/400 was high.

In No. 310 to No. 315, which are comparative examples, since the temperature in the hot-rolled sheet annealing and/or the rolling reduction in the cold rolling were not optimal, at least one of Formula (20) to Formula (24) was not satisfied, and, as a result, the iron losses W10/400 were high.

In addition, in No. 334 to No. 343, which are comparative examples, since the chemical compositions were outside the scope of the present invention, Formula (20) and Formula (21) were not satisfied, and the iron losses W10/400 became high or cracking occurred during the cold rolling.

### Fourth Example

Molten steel was cast, thereby producing ingots having chemical compositions shown in Table 7A. Here, the column “Left side of Formula (1)” indicates the values of the left side of Formula (1) described above. After that, the produced ingots were hot-rolled by being heated up to 1150° C. and rolled such that the sheet thicknesses became as shown in Table 7B. In addition, after the end of finish rolling, the hot-rolled steel sheets were cooled with water and coiled. The temperatures (finish temperatures) in a stage of the final pass of the finish rolling at this time were 830° C., and the coiling temperatures were within a range of 500° C. to 700° C.

Next, hot-rolled sheet annealing was performed on the hot-rolled steel sheets under conditions shown in Table 7B for 30 seconds, scales were removed by pickling, and cold rolling was performed at rolling reductions shown in Table 7B. In addition, intermediate annealing was performed in a non-oxidizing atmosphere at 800° C. for 30 seconds. Next, the second round of cold rolling (skin pass rolling) was performed at rolling reductions shown in Table 7B.

Next, a first heat treatment was performed under conditions of 800° C. and 30 seconds.

After the first heat treatment, in order to investigate the texture, a part of each of the steel sheets was cut, the cut test piece was processed to reduce the thickness to ½, and EBSD observation (step intervals: 100 nm) was performed on the processed surface. The areas, average KAM values, and average grain sizes of the orientated grains were obtained by EBSD observation, and S_{tyl}/Sₜₒₜ, S₁₀₀/Sₜₒₜ, S₁₀₀/Sₜᵣₐ, K₁₀₀/K_{tyl}, d₁₀₀/dₐᵥₑ, and d₁₀₀/d_{tyl} were obtained.

In addition, on the steel sheets after the first heat treatment, a second heat treatment was performed under conditions shown in Table 7B. After the second heat treatment, in order to investigate the textures, a part of each of the steel sheets was cut, the cut test piece was processed to reduce the thickness to ½, and EBSID observation was performed on the processed surface. The areas and average grain sizes of kinds shown in Table 8 were obtained by EBSD observation.

In addition, after the second heat treatment, from each of the steel sheets after the second heat treatment, 55 mm×55 mm sample pieces were collected as measurement samples. The samples were collected using a shearing machine. In addition, as the magnetic characteristics, the iron losses W10/400 (average value of the rolling direction and the width direction), W15/50 (C), and W15/50 (L) were measured in the same manner as in First Example, and W15/50 (C)/W15/50 (L) were obtained. The measurement results are shown in Table 8.

TABLE 7A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Left |
| | | | | | | | | | | | | | | | | | side |
| | | | | | | | | | | | | | | | | | of |
| | | | | | | | | | | | | | | | | | For- |
| | | | | | | | | | | | | | | | | | mula |
| No. | C | Si | sol. Al | S | N | Mn | Ni | Co | Pt | Pb | Cu | Au | Cr | Mg | B | O | (1) |
| 401 | 0.0009 | 3.19 | 0.59 | 0.0019 | 0.0019 | 0.19 | — | — | — | — | — | — | 0.003 | — | — | — | −3.59 |
| 402 | 0.0011 | 3.20 | 0.60 | 0.0023 | 0.0021 | 0.19 | — | — | — | — | — | — | 0.004 | — | — | — | −3.61 |
| 403 | 0.0010 | 3.20 | 0.61 | 0.0021 | 0.0022 | — | 0.20 | — | — | — | — | — | 0.003 | — | — | — | −3.60 |
| 404 | 0.0010 | 3.21 | 0.61 | 0.0021 | 0.0021 | — | — | 0.21 | — | — | — | — | 0.004 | — | — | — | −3.61 |
| 405 | 0.0009 | 3.21 | 0.61 | 0.0020 | 0.0023 | — | — | — | 0.19 | — | — | — | 0.003 | — | — | — | −3.62 |
| 406 | 0.0008 | 3.20 | 0.60 | 0.0018 | 0.0017 | — | — | — | — | 0.21 | — | — | 0.004 | — | — | — | −3.60 |
| 407 | 0.0011 | 3.20 | 0.60 | 0.0020 | 0.0021 | — | — | — | — | — | 0.20 | — | 0.002 | — | — | — | −3.60 |
| 408 | 0.0010 | 3.20 | 0.61 | 0.0022 | 0.0020 | — | — | — | — | — | — | 0.19 | 0.003 | — | — | — | −3.62 |
| 409 | 0.0009 | 2.00 | 0.32 | 0.0020 | 0.0018 | 2.40 | — | — | — | — | — | — | 0.002 | — | — | — | 0.08 |
| 410 | 0.0010 | 3.20 | 0.61 | 0.0018 | 0.0019 | 0.20 | — | — | — | — | — | — | 0.002 | — | — | — | −3.61 |
| 411 | 0.0010 | 3.19 | 0.60 | 0.0022 | 0.0019 | 0.19 | — | — | — | — | — | — | 0.003 | — | — | — | −3.60 |
| 412 | 0.0010 | 3.19 | 0.59 | 0.0019 | 0.0019 | 0.19 | — | — | — | — | — | — | 0.003 | — | — | — | −3.59 |
| 413 | 0.0010 | 3.20 | 0.60 | 0.0018 | 0.0020 | 0.19 | — | — | — | — | — | — | 0.004 | — | — | — | −3.60 |
| 414 | 0.0010 | 3.19 | 0.60 | 0.0020 | 0.0022 | 0.20 | — | — | — | — | — | — | 0.004 | — | — | — | −3.60 |
| 415 | 0.0011 | 3.20 | 0.60 | 0.0017 | 0.0016 | 0.20 | — | — | — | — | — | — | 0.003 | — | — | — | −3.59 |
| 416 | 0.0009 | 3.19 | 0.59 | 0.0019 | 0.0019 | 0.19 | — | — | — | — | — | — | 0.004 | — | — | — | −3.59 |
| 417 | 0.0009 | 3.19 | 0.59 | 0.0019 | 0.0019 | 0.19 | — | — | — | — | — | — | 0.003 | — | — | — | −3.59 |
| 418 | 0.0009 | 3.19 | 0.59 | 0.0019 | 0.0019 | 0.19 | — | — | — | — | — | — | 0.002 | — | — | — | −3.59 |
| 419 | 0.0009 | 3.19 | 0.59 | 0.0019 | 0.0019 | 0.19 | — | — | — | — | — | — | 0.002 | — | — | — | −3.59 |
| 420 | 0.0010 | 3.20 | 0.60 | 0.0018 | 0.0020 | 0.19 | — | — | — | — | — | — | 0.002 | — | — | — | −3.60 |
| 421 | 0.0085 | 3.23 | 0.61 | 0.0021 | 0.0020 | 0.23 | — | — | — | — | — | — | 0.004 | — | — | — | −3.59 |
| 422 | 0.0009 | 1.59 | 0.59 | 0.0021 | 0.0021 | 0.22 | — | — | — | — | — | — | 0.003 | — | — | — | −3.39 |
| 423 | 0.0008 | 3.90 | 0.60 | 0.0018 | 0.0018 | 0.22 | — | — | — | — | — | — | 0.003 | — | — | — | −3.59 |
| 424 | 0.0009 | 3.22 | 0.00 | 0.0020 | 0.0020 | 0.21 | — | — | — | — | — | — | 0.003 | — | — | — | −3.59 |
| 425 | 0.0011 | 3.23 | 2.81 | 0.0019 | 0.0021 | 0.22 | — | — | — | — | — | — | 0.003 | — | — | — | −3.59 |
| 426 | 0.0008 | 3.22 | 0.60 | 0.0005 | 0.0021 | 0.21 | — | — | — | — | — | — | 0.004 | — | — | — | −3.59 |
| 427 | 0.0009 | 3.22 | 0.61 | 0.0093 | 0.0021 | 0.21 | — | — | — | — | — | — | 0.002 | — | — | — | −3.59 |
| 428 | 0.0009 | 3.23 | 0.61 | 0.0017 | 0.0093 | 0.21 | — | — | — | — | — | — | 0.004 | — | — | — | −3.59 |
| 429 | 0.0008 | 3.23 | 0.60 | 0.0018 | 0.0019 | 0.21 | — | — | — | — | — | — | 0.002 | 0.0005 | — | — | −3.59 |
| 430 | 0.0008 | 3.22 | 0.60 | 0.0348 | 0.0018 | 0.21 | — | — | — | — | — | — | 0.003 | 0.0094 | — | — | −3.59 |
| 431 | 0.0009 | 3.23 | 0.61 | 0.0018 | 0.0020 | 0.21 | — | — | — | — | — | — | 0.001 | — | — | — | −3.59 |
| 432 | 0.0007 | 3.22 | 0.59 | 0.0019 | 0.0018 | 0.23 | — | — | — | — | — | — | 0.094 | — | — | — | −3.59 |
| 433 | 0.0011 | 3.23 | 0.61 | 0.0020 | 0.0022 | 0.21 | — | — | — | — | — | — | 0.003 | — | — | — | −3.59 |
| 434 | 0.0011 | 3.22 | 2.79 | 0.0018 | 0.0021 | 2.40 | — | — | — | — | — | — | 0.002 | — | — | — | −3.59 |
| 435 | 0.0009 | 3.20 | 0.60 | 0.0019 | 0.0017 | 0.21 | — | — | — | — | — | — | 0.002 | — | 0.0002 | — | −3.59 |
| 436 | 0.0011 | 3.20 | 0.59 | 0.0017 | 0.0018 | 0.20 | — | — | — | — | — | — | 0.003 | — | 0.0043 | — | −3.59 |
| 437 | 0.0010 | 3.20 | 0.59 | 0.0020 | 0.0019 | 0.20 | — | — | — | — | — | — | 0.002 | — | — | 0.0013 | −3.59 |
| 438 | 0.0008 | 3.19 | 0.60 | 0.0018 | 0.0017 | 0.22 | — | — | — | — | — | — | 0.003 | — | — | 0.0169 | −3.59 |
| 439 | 0.0122 | 3.22 | 0.61 | 0.0019 | 0.0020 | 0.21 | — | — | — | — | — | — | 0.002 | — | — | — | −3.59 |
| 440 | 0.0010 | 1.40 | 0.60 | 0.0019 | 0.0021 | 0.22 | — | — | — | — | — | — | 0.004 | — | — | — | −3.59 |
| 441 | 0.0010 | 4.20 | 0.60 | 0.0020 | 0.0019 | 0.21 | — | — | — | — | — | — | 0.002 | — | — | — | −3.59 |
| 442 | 0.0008 | 3.21 | 4.19 | 0.0017 | 0.0021 | 0.20 | — | — | — | — | — | — | 0.004 | — | — | — | −3.59 |
| 443 | 0.0009 | 3.21 | 0.60 | 0.0450 | 0.0020 | 0.22 | — | — | — | — | — | — | 0.003 | — | — | — | −3.59 |
| 444 | 0.0011 | 3.23 | 0.60 | 0.0017 | 0.0119 | 0.21 | — | — | — | — | — | — | 0.003 | — | — | — | −3.59 |
| 445 | 0.0010 | 3.22 | 0.60 | 0.0017 | 0.0022 | 0.21 | — | — | — | — | — | — | 0.000 | — | — | — | −3.59 |
| 446 | 0.0011 | 3.23 | 0.60 | 0.0020 | 0.0020 | 0.22 | — | — | — | — | — | — | 0.120 | — | — | — | −3.59 |
| 447 | 0.0011 | 3.23 | 0.60 | 0.0020 | 0.0019 | 2.59 | — | — | — | — | — | — | 0.003 | — | — | — | −3.59 |
| 448 | 0.0010 | 3.20 | 0.58 | 0.0018 | 0.0021 | 0.20 | — | — | — | — | — | — | 0.003 | — | — | — | −3.59 |

TABLE 7B

| | | Hot-rolled | | | | | | | | | | | |
|---|---|---|---|---|---|---|---|---|---|---|---|---|---|
| | After hot | sheet | | | | | | | | | Second heat | | |
| | rolling | annealing | Rolling | | EBSD observation result | | | | | | treatment | | |
| | Sheet | Annealing | reduction (%) | | after first heat treatment | | | | | | Annealing | Annealing | |
| | thickness | temperature | Cold | Skin pass | S [symbol] / | S₁₀₀/ | S₁₀₀/ | K₁₀₀/ | d₁₀₀/ | d₁₀₀/ | temperature | time | |
| No. | (mm) | (° C.) | rolling | rolling | S [symbol] | S [symbol] | S [symbol] | K [symbol] | d [symbol] | d [symbol] | (° C.) | (s) | Note |
| 401 | 2.50 | 1050 | 92 | 10 | 0.65 | 0.28 | 0.85 | 0.959 | 1.30 | 1.49 | 1050 | 30 | Invention |
| | | | | | | | | | | | | | Example |
| 402 | 2.50 | 1050 | 92 | 10 | 0.65 | 0.27 | 0.85 | 0.959 | 1.30 | 1.49 | 800 | 7200 | Invention |
| | | | | | | | | | | | | | Example |
| 403 | 2.50 | 1050 | 92 | 10 | 0.64 | 0.28 | 0.84 | 0.969 | 1.29 | 1.49 | 1050 | 30 | Invention |
| | | | | | | | | | | | | | Example |
| 404 | 2.50 | 1050 | 92 | 10 | 0.64 | 0.28 | 0.85 | 0.964 | 1.29 | 1.51 | 1050 | 30 | Invention |
| | | | | | | | | | | | | | Example |
| 405 | 2.50 | 1050 | 92 | 10 | 0.65 | 0.28 | 0.86 | 0.966 | 1.31 | 1.50 | 1050 | 30 | Invention |
| | | | | | | | | | | | | | Example |
| 406 | 2.50 | 1050 | 92 | 10 | 0.65 | 0.28 | 0.86 | 0.964 | 1.30 | 1.52 | 1050 | 30 | Invention |
| | | | | | | | | | | | | | Example |
| 407 | 2.50 | 1050 | 92 | 10 | 0.65 | 0.29 | 0.86 | 0.966 | 1.29 | 1.51 | 1050 | 30 | Invention |
| | | | | | | | | | | | | | Example |
| 408 | 2.50 | 1050 | 92 | 10 | 0.66 | 0.29 | 0.85 | 0.968 | 1.29 | 1.50 | 1050 | 30 | Invention |
| | | | | | | | | | | | | | Example |
| 409 | 2.50 | 1050 | 92 | 10 | 0.88 | 0.03 | 0.85 | 0.969 | 1.28 | 1.49 | 1050 | 30 | Comparative |
| | | | | | | | | | | | | | Example |
| 410 | 2.50 | 850 | 92 | 10 | 0.85 | 0.28 | 0.84 | 0.968 | 1.28 | 1.48 | 1050 | 30 | Comparative |
| | | | | | | | | | | | | | Example |
| 411 | 1.33 | 850 | 85 | 10 | 0.66 | 0.02 | 0.85 | 0.964 | 1.30 | 1.51 | 1050 | 30 | Comparative |
| | | | | | | | | | | | | | Example |
| 412 | 0.50 | 1050 | 60 | 10 | 0.66 | 0.29 | 0.25 | 0.961 | 1.31 | 1.51 | 1050 | 30 | Comparative |
| | | | | | | | | | | | | | Example |
| 413 | 1.33 | 850 | 85 | 15 | 0.64 | 0.28 | 0.85 | 1.030 | 1.31 | 1.49 | 1050 | 30 | Comparative |
| | | | | | | | | | | | | | Example |
| 414 | 1.33 | 850 | 85 | 20 | 0.65 | 0.27 | 0.85 | 0.961 | 0.79 | 1.51 | 1050 | 30 | Comparative |
| | | | | | | | | | | | | | Example |
| 415 | 1.33 | 850 | 85 | 25 | 0.64 | 0.28 | 0.84 | 0.967 | 1.30 | 0.90 | 1050 | 30 | Comparative |
| | | | | | | | | | | | | | Example |
| 416 | 2.50 | 1050 | 92 | 10 | 0.64 | 0.28 | 0.86 | 0.961 | 1.30 | 1.49 | 940 | 30 | Comparative |
| | | | | | | | | | | | | | Example |
| 417 | 2.50 | 1050 | 92 | 10 | 0.64 | 0.29 | 0.85 | 0.961 | 1.29 | 1.49 | 1070 | 30 | Comparative |
| | | | | | | | | | | | | | Example |
| 418 | 2.50 | 1050 | 92 | 10 | 0.64 | 0.29 | 0.85 | 0.960 | 1.30 | 1.48 | 680 | 7200 | Comparative |
| | | | | | | | | | | | | | Example |
| 419 | 2.50 | 1050 | 92 | 10 | 0.65 | 0.28 | 0.85 | 0.963 | 1.30 | 1.48 | 930 | 7200 | Comparative |
| | | | | | | | | | | | | | Example |
| 420 | 1.33 | 850 | 84 | 15 | 0.65 | 0.28 | 0.86 | 1.029 | 1.31 | 1.49 | 1050 | 30 | Comparative |
| | | | | | | | | | | | | | Example |
| 421 | 2.50 | 1050 | 92 | 10 | 0.65 | 0.28 | 0.85 | 0.962 | 1.29 | 1.49 | 1050 | 30 | Invention |
| | | | | | | | | | | | | | Example |
| 422 | 2.50 | 1050 | 92 | 10 | 0.64 | 0.29 | 0.85 | 0.961 | 1.30 | 1.49 | 1050 | 30 | Invention |
| | | | | | | | | | | | | | Example |
| 423 | 2.50 | 1050 | 92 | 10 | 0.64 | 0.28 | 0.84 | 0.959 | 1.30 | 1.49 | 1050 | 30 | Invention |
| | | | | | | | | | | | | | Example |
| 424 | 2.50 | 1050 | 92 | 10 | 0.64 | 0.29 | 0.84 | 0.963 | 1.29 | 1.48 | 1050 | 30 | Invention |
| | | | | | | | | | | | | | Example |
| 425 | 2.50 | 1050 | 92 | 10 | 0.64 | 0.28 | 0.84 | 0.961 | 1.30 | 1.50 | 1050 | 30 | Invention |
| | | | | | | | | | | | | | Example |
| 426 | 2.50 | 1050 | 92 | 10 | 0.65 | 0.28 | 0.85 | 0.960 | 1.30 | 1.48 | 1050 | 30 | Invention |
| | | | | | | | | | | | | | Example |
| 427 | 2.50 | 1050 | 92 | 10 | 0.65 | 0.28 | 0.86 | 0.963 | 1.29 | 1.48 | 1050 | 30 | Invention |
| | | | | | | | | | | | | | Example |
| 428 | 2.50 | 1050 | 92 | 10 | 0.64 | 0.28 | 0.85 | 0.959 | 1.29 | 1.49 | 1050 | 30 | Invention |
| | | | | | | | | | | | | | Example |
| 429 | 2.50 | 1050 | 92 | 10 | 0.64 | 0.28 | 0.85 | 0.963 | 1.29 | 1.49 | 1050 | 30 | Invention |
| | | | | | | | | | | | | | Example |
| 430 | 2.50 | 1050 | 92 | 10 | 0.65 | 0.29 | 0.85 | 0.962 | 1.30 | 1.49 | 1050 | 30 | Invention |
| | | | | | | | | | | | | | Example |
| 431 | 2.50 | 1050 | 92 | 10 | 0.64 | 0.28 | 0.84 | 0.959 | 1.30 | 1.49 | 1050 | 30 | Invention |
| | | | | | | | | | | | | | Example |
| 432 | 2.50 | 1050 | 92 | 10 | 0.64 | 0.29 | 0.85 | 0.964 | 1.30 | 1.49 | 1050 | 30 | Invention |
| | | | | | | | | | | | | | Example |
| 433 | 2.50 | 1050 | 92 | 10 | 0.64 | 0.29 | 0.86 | 0.962 | 1.29 | 1.48 | 1050 | 30 | Invention |
| | | | | | | | | | | | | | Example |
| 434 | 2.50 | 1050 | 92 | 10 | 0.64 | 0.29 | 0.86 | 0.959 | 1.29 | 1.49 | 1050 | 30 | Invention |
| | | | | | | | | | | | | | Example |
| 435 | 2.50 | 1050 | 92 | 10 | 0.65 | 0.28 | 0.85 | 0.959 | 1.29 | 1.49 | 1050 | 30 | Invention |
| | | | | | | | | | | | | | Example |
| 436 | 2.50 | 1050 | 92 | 10 | 0.65 | 0.29 | 0.85 | 0.961 | 1.30 | 1.49 | 1050 | 30 | Invention |
| | | | | | | | | | | | | | Example |
| 437 | 2.50 | 1050 | 92 | 10 | 0.65 | 0.28 | 0.85 | 0.964 | 1.29 | 1.48 | 1050 | 30 | Invention |
| | | | | | | | | | | | | | Example |
| 438 | 2.50 | 1050 | 92 | 10 | 0.64 | 0.29 | 0.84 | 0.963 | 1.30 | 1.49 | 1050 | 30 | Invention |
| | | | | | | | | | | | | | Example |
| 439 | 2.50 | 1050 | 92 | 10 | 0.88 | 0.04 | 0.86 | 0.972 | 1.29 | 1.49 | 1050 | 30 | Comparative |
| | | | | | | | | | | | | | Example |
| 440 | 2.50 | 1050 | 92 | 10 | 0.89 | 0.04 | 0.84 | 0.970 | 1.29 | 1.48 | 1050 | 30 | Comparative |
| | | | | | | | | | | | | | Example |
| 441 | 2.50 | 1050 | 92 | Cracking occurs during cold rolling | | | | | | | | | Comparative |
| | | | | | | | | | | | | | Example |
| 442 | 2.50 | 1050 | 92 | Cracking occurs during cold rolling | | | | | | | | | Comparative |
| | | | | | | | | | | | | | Example |
| 443 | 2.50 | 1050 | 92 | 10 | 0.89 | 0.04 | 0.85 | 0.972 | 1.28 | 1.47 | 1050 | 30 | Comparative |
| | | | | | | | | | | | | | Example |
| 444 | 2.50 | 1050 | 92 | 10 | 0.89 | 0.03 | 5.85 | 0.968 | 1.28 | 1.48 | 1050 | 30 | Comparative |
| | | | | | | | | | | | | | Example |
| 445 | 2.50 | 1050 | 92 | 10 | 0.88 | 0.03 | 0.86 | 0.967 | 1.28 | 1.48 | 1050 | 30 | Comparative |
| | | | | | | | | | | | | | Example |
| 446 | 2.50 | 1050 | 92 | 10 | 0.88 | 0.03 | 0.85 | 0.968 | 1.29 | 1.49 | 1050 | 30 | Comparative |
| | | | | | | | | | | | | | Example |
| 447 | 2.50 | 1050 | 92 | Cracking occurs during cold rolling | | | | | | | | | Comparative |
| | | | | | | | | | | | | | Example |
| 448 | 2.50 | 1050 | 92 | 10 | 0.64 | 0.29 | 0.85 | 0.959 | 1.29 | 1.48 | 1050 | 30 | Invention |
| | | | | | | | | | | | | | Example |

[symbol]

indicates data missing or illegible when filed

TABLE 8

| | EBSD observation result | | | | | | Second | | |
|---|---|---|---|---|---|---|---|---|---|
| | after second heat treatment | | | | | | heat treatment | | |
| | S [symbol] / | S₁₀₀/ | S₁₀₀/ | d₁₀₀/ | d₁₀₀/ | d₁₀₀/ | W10/400 | W15/50(C)/ | |
| No. | S [symbol] | S [symbol] | S [symbol] | d [symbol] | d [symbol] | d [symbol] | (W/kg) | W15/50(L) | Note |
| 401 | 0.43 | 0.35 | 0.74 | 1.03 | 1.04 | 0.98 | 10.5 | 1.11 | Invention |
| | | | | | | | | | Example |
| 402 | 0.44 | 0.35 | 0.74 | 1.02 | 1.04 | 0.98 | 10.6 | 1.10 | Invention |
| | | | | | | | | | Example |
| 403 | 0.44 | 0.34 | 0.76 | 1.01 | 1.03 | 0.98 | 10.5 | 1.10 | Invention |
| | | | | | | | | | Example |
| 404 | 0.46 | 0.33 | 0.74 | 1.03 | 1.04 | 0.99 | 10.5 | 1.08 | Invention |
| | | | | | | | | | Example |
| 405 | 0.44 | 0.34 | 0.77 | 1.02 | 1.04 | 0.99 | 10.4 | 1.12 | Invention |
| | | | | | | | | | Example |
| 406 | 0.45 | 0.35 | 0.76 | 1.02 | 1.05 | 0.99 | 10.5 | 1.11 | Invention |
| | | | | | | | | | Example |
| 407 | 0.45 | 0.37 | 0.75 | 1.02 | 1.05 | 0.99 | 10.6 | 1.12 | Invention |
| | | | | | | | | | Example |
| 408 | 0.43 | 0.37 | 0.73 | 1.02 | 1.03 | 0.98 | 10.5 | 1.09 | Invention |
| | | | | | | | | | Example |
| 409 | 0.82 | 0.05 | 0.73 | 1.02 | 1.04 | 0.99 | 15.6 | 1.38 | Comparative |
| | | | | | | | | | Example |
| 410 | 0.81 | 0.35 | 0.74 | 1.02 | 1.03 | 0.98 | 12.4 | 1.43 | Comparative |
| | | | | | | | | | Example |
| 411 | 0.47 | 0.02 | 0.74 | 1.02 | 1.04 | 0.98 | 12.3 | 1.41 | Comparative |
| | | | | | | | | | Example |
| 412 | 0.44 | 0.18 | 0.25 | 1.02 | 1.04 | 0.98 | 12.4 | 1.40 | Comparative |
| | | | | | | | | | Example |
| 413 | 0.76 | 0.13 | 0.75 | 0.95 | 1.04 | 0.98 | 12.2 | 1.38 | Comparative |
| | | | | | | | | | Example |
| 414 | 0.74 | 0.11 | 0.73 | 1.03 | 0.93 | 0.99 | 12.3 | 1.38 | Comparative |
| | | | | | | | | | Example |
| 415 | 0.74 | 0.12 | 0.75 | 1.01 | 1.03 | 0.92 | 12.4 | 1.41 | Comparative |
| | | | | | | | | | Example |
| 416 | 0.82 | 0.06 | 0.73 | 1.02 | 1.04 | 0.99 | 15.6 | 1.42 | Comparative |
| | | | | | | | | | Example |
| 417 | 0.81 | 0.35 | 0.74 | 1.02 | 1.03 | 0.98 | 12.4 | 1.40 | Comparative |
| | | | | | | | | | Example |
| 418 | 0.82 | 0.05 | 0.73 | 1.02 | 1.04 | 0.99 | 15.6 | 1.38 | Comparative |
| | | | | | | | | | Example |
| 419 | 0.81 | 0.35 | 0.74 | 1.02 | 1.03 | 0.98 | 12.4 | 1.39 | Comparative |
| | | | | | | | | | Example |
| 420 | 0.76 | 0.13 | 0.75 | 0.94 | 1.04 | 0.98 | 12.2 | 1.43 | Comparative |
| | | | | | | | | | Example |
| 421 | 0.43 | 0.34 | 0.73 | 1.02 | 1.04 | 0.98 | 10.5 | 1.13 | Invention |
| | | | | | | | | | Example |
| 422 | 0.43 | 0.34 | 0.75 | 1.03 | 1.04 | 0.98 | 10.5 | 1.09 | Invention |
| | | | | | | | | | Example |
| 423 | 0.44 | 0.35 | 0.74 | 1.03 | 1.05 | 0.98 | 10.5 | 1.11 | Invention |
| | | | | | | | | | Example |
| 424 | 0.43 | 0.36 | 0.75 | 1.03 | 1.04 | 0.98 | 10.4 | 1.12 | Invention |
| | | | | | | | | | Example |
| 425 | 0.43 | 0.35 | 0.73 | 1.04 | 1.05 | 0.97 | 10.6 | 1.10 | Invention |
| | | | | | | | | | Example |
| 426 | 0.43 | 0.34 | 0.73 | 1.02 | 1.04 | 0.98 | 10.5 | 1.08 | Invention |
| | | | | | | | | | Example |
| 427 | 0.44 | 0.35 | 0.73 | 1.03 | 1.04 | 0.99 | 10.6 | 1.13 | Invention |
| | | | | | | | | | Example |
| 428 | 0.44 | 0.34 | 0.74 | 1.03 | 1.04 | 0.99 | 10.5 | 1.11 | Invention |
| | | | | | | | | | Example |
| 429 | 0.43 | 0.36 | 0.73 | 1.03 | 1.04 | 0.98 | 10.5 | 1.11 | Invention |
| | | | | | | | | | Example |
| 430 | 0.43 | 0.34 | 0.74 | 1.02 | 1.04 | 0.98 | 10.4 | 1.12 | Invention |
| | | | | | | | | | Example |
| 431 | 0.43 | 0.34 | 0.73 | 1.02 | 1.05 | 0.98 | 10.5 | 1.07 | Invention |
| | | | | | | | | | Example |
| 432 | 0.43 | 0.34 | 0.73 | 1.03 | 1.04 | 0.98 | 10.5 | 1.13 | Invention |
| | | | | | | | | | Example |
| 433 | 0.43 | 0.35 | 0.73 | 1.03 | 1.05 | 0.98 | 10.5 | 1.09 | Invention |
| | | | | | | | | | Example |
| 434 | 0.44 | 0.35 | 0.73 | 1.02 | 1.04 | 0.98 | 10.4 | 1.12 | Invention |
| | | | | | | | | | Example |
| 435 | 0.43 | 0.35 | 0.74 | 1.03 | 1.04 | 0.98 | 10.6 | 1.09 | Invention |
| | | | | | | | | | Example |
| 436 | 0.43 | 0.35 | 0.75 | 1.03 | 1.05 | 0.97 | 10.4 | 1.10 | Invention |
| | | | | | | | | | Example |
| 437 | 0.44 | 0.34 | 0.73 | 1.02 | 1.04 | 0.99 | 10.5 | 1.09 | Invention |
| | | | | | | | | | Example |
| 438 | 0.43 | 0.34 | 0.73 | 1.03 | 1.05 | 0.99 | 10.4 | 1.13 | Invention |
| | | | | | | | | | Example |
| 439 | 0.83 | 0.05 | 0.74 | 1.03 | 1.03 | 0.98 | 15.5 | 1.41 | Comparative |
| | | | | | | | | | Example |
| 440 | 0.81 | 0.04 | 0.74 | 1.01 | 1.04 | 0.99 | 15.6 | 1.38 | Comparative |
| | | | | | | | | | Example |
| 441 | Not evaluated since cracking occurs during cold rolling | | | | | | | | Comparative |
| | | | | | | | | | Example |
| 442 | Not evaluated since cracking occurs during cold rolling | | | | | | | | Comparative |
| | | | | | | | | | Example |
| 443 | 0.82 | 0.05 | 0.74 | 1.01 | 1.03 | 0.98 | 15.6 | 1.37 | Comparative |
| | | | | | | | | | Example |
| 444 | 0.82 | 0.05 | 0.74 | 1.02 | 1.04 | 0.99 | 15.7 | 1.42 | Comparative |
| | | | | | | | | | Example |
| 445 | 0.83 | 0.04 | 0.74 | 1.01 | 1.03 | 0.98 | 15.6 | 1.43 | Comparative |
| | | | | | | | | | Example |
| 446 | 0.81 | 0.04 | 0.74 | 1.02 | 1.04 | 0.99 | 15.7 | 1.42 | Comparative |
| | | | | | | | | | Example |
| 447 | Not evaluated since cracking occurs during cold rolling | | | | | | | | Comparative |
| | | | | | | | | | Example |
| 448 | 0.44 | 0.35 | 0.73 | 1.02 | 1.05 | 0.94 | 10.6 | 1.21 | Invention |
| | | | | | | | | | Example |

[symbol]

indicates data missing or illegible when filed

Underlined values in Table 7A, Table 7B, and Table 8 indicate conditions deviating from the scope of the present invention. In all of No. 401 to No. 408, No. 421 to No. 438, and No. 448, which are invention examples, the iron losses W10/400 were favorable values.

On the other hand, in No. 409, which is a comparative example, the Mn concentration was high, and the value of the left side of Formula (1) was more than 0.00 (a composition that underwent α-γ transformation), which made S_{tyl}/Sₜₒₜ and S₁₀₀/Sₜₒₜ each deviate from the range of Formula (20) or Formula (21). As a result, the iron loss W10/400 was high. In No. 410 to No. 420, which are comparative examples, since the temperature in the hot-rolled sheet annealing and/or the rolling reduction in the cold rolling were not optimal, at least one of Formula (20) to Formula (24) was not satisfied, and, as a result, the iron losses W10/400 were high.

In addition, in No. 439 to No. 447, which are comparative examples, since the chemical compositions were outside the scope of the present invention, Formula (20) and Formula (21) were not satisfied, and the iron losses W10/400 became high or cracking occurred during the cold rolling.

### Fifth Example

Molten steel was cast, thereby producing ingots having chemical compositions shown in Table 9A. Here, the column “Left side of Formula (1)” indicates the values of the left side of Formula (1) described above. After that, the produced ingots were hot-rolled by being heated up to 1150° C. and rolled such that the sheet thicknesses became as shown in Table 9B. In addition, after the end of finish rolling, the hot-rolled steel sheets were cooled with water and coiled. The temperatures (finish temperatures) in a stage of the final pass of the finish rolling at this time were 830° C., and the coiling temperatures were within a range of 500° C. to 700° C.

Next, hot-rolled sheet annealing was performed on the hot-rolled steel sheets under conditions shown in Table 9B for 30 seconds, scales were removed by pickling, and cold rolling was performed at rolling reductions shown in Table 9B. In addition, intermediate annealing was performed in a non-oxidizing atmosphere at 800° C. for 30 seconds. Next, the second round of cold rolling (skin pass rolling) was performed at rolling reductions shown in Table 9B.

Next, in order to investigate the texture, a part of each of the steel sheets was cut, the cut test piece was processed to reduce the thickness to ½, and EBSD observation (step intervals: 100 nm) was performed on the processed surface. The areas and average KAM values of kinds shown in Table 8 were obtained by EBSD observation.

In addition, as a second heat treatment, annealing was performed on the steel sheets at a temperature of 800° C. for 2 hours. From each of the steel sheets after the second heat treatment, 55 mm×55 mm sample pieces were collected as measurement samples. The samples were collected using a shearing machine. In addition, as the magnetic characteristics, the iron losses W10/400 (average value of the rolling direction and the width direction), W15/50 (C), and W15/50 (L) were measured in the same manner as in First Example, and W15/50 (C)/W15/50 (L) were obtained. The measurement results are shown in Table 10.

TABLE 9A

| | Chemical composition (mass %, remainder is Fe and impurities) | | | | | | | | | | |
|---|---|---|---|---|---|---|---|---|---|---|---|
| | | | sol. | | | | | | | | |
| No. | C | Si | Al | S | N | Mn | Sn | Sb | P | Cr | Mg |
| 501 | 0.0010 | 3.20 | 0.59 | 0.0017 | 0.0019 | 0.19 | — | — | | 0.003 | — |
| 502 | 0.0010 | 3.20 | 0.59 | 0.0023 | 0.0022 | 0.20 | 0.05 | — | — | 0.003 | — |
| 503 | 0.0011 | 3.21 | 0.60 | 0.0022 | 0.0020 | 0.20 | — | 0.05 | — | 0.003 | — |
| 504 | 0.0009 | 3.21 | 0.60 | 0.0021 | 0.0021 | 0.21 | — | — | 0.05 | 0.003 | — |
| 505 | 0.0009 | 3.21 | 0.60 | 0.0021 | 0.0021 | 0.20 | — | — | — | 0.003 | 0.0051 |
| 506 | 0.0009 | 3.20 | 0.61 | 0.0017 | 0.0019 | 0.19 | — | — | — | 0.003 | — |
| 507 | 0.0011 | 3.19 | 0.59 | 0.0022 | 0.0020 | 0.19 | — | — | — | 0.003 | — |
| 508 | 0.0010 | 3.21 | 0.61 | 0.0023 | 0.0020 | 0.19 | — | — | — | 0.003 | — |
| 509 | 0.0009 | 3.19 | 0.59 | 0.0020 | 0.0019 | 0.20 | — | — | — | 0.003 | — |
| 510 | 0.0010 | 3.20 | 0.60 | 0.0018 | 0.0019 | 0.20 | — | — | — | 0.003 | — |
| 511 | 0.0012 | 3.21 | 0.60 | 0.0019 | 0.0019 | 0.19 | — | — | — | 0.003 | — |
| 512 | 0.0010 | 3.19 | 0.60 | 0.0020 | 0.0021 | 0.20 | — | — | — | 0.003 | — |
| 513 | 0.0009 | 3.21 | 0.60 | 0.0017 | 0.0019 | 0.20 | — | — | — | 0.003 | — |
| 514 | 0.0010 | 3.21 | 0.60 | 0.0021 | 0.0021 | 0.21 | — | — | — | 0.003 | — |
| 515 | 0.0010 | 3.20 | 0.59 | 0.0017 | 0.0019 | 0.19 | — | — | — | 0.093 | — |

| | Chemical composition (mass %, remainder is Fe and impurities) | | | | | | | | | |
|---|---|---|---|---|---|---|---|---|---|---|
| | | | | | | | | | | Left |
| | | | | | | | | | | side of |
| | | | | | | | | | | Formula |
| No. | Ca | Sr | Ba | Ce | La | Nd | Pr | Zn | Cd | (1) |
| 501 | — | — | — | — | — | — | — | — | — | −3.60 |
| 502 | — | — | — | — | — | — | — | — | — | −3.59 |
| 503 | — | — | — | — | — | — | — | — | — | −3.62 |
| 504 | — | — | — | — | — | — | — | — | — | −3.61 |
| 505 | — | — | — | — | — | — | — | — | — | −3.61 |
| 506 | 0.0047 | — | — | — | — | — | — | — | — | −3.61 |
| 507 | — | 0.0047 | — | — | — | — | — | — | — | −3.59 |
| 508 | — | — | 0.0052 | — | — | — | — | — | — | −3.62 |
| 509 | — | — | — | 0.0051 | — | — | — | — | — | −3.58 |
| 510 | — | — | — | — | 0.0053 | — | — | — | — | −3.61 |
| 511 | — | — | — | — | — | 0.0051 | — | — | — | −3.61 |
| 512 | — | — | — | — | — | — | 0.0053 | — | — | −3.60 |
| 513 | — | — | — | — | — | — | — | 0.0049 | — | −3.61 |
| 514 | — | — | — | — | — | — | — | — | 0.0051 | −3.60 |
| 515 | — | — | — | — | — | — | — | — | — | −3.60 |

TABLE 9B

| | After hot | Hot-rolled sheet | | | |
|---|---|---|---|---|---|
| | rolling | annealing | | | |
| | Sheet | Annealing | Rolling reduction (%) | | |
| | thickness | temperature | Cold | Skin pass | |
| No. | (mm) | (° C.) | rolling | rolling | Note |
| 501 | 2.50 | 1050 | 92 | 10 | Invention Example |
| 502 | 2.50 | 1050 | 92 | 10 | Invention Example |
| 503 | 2.50 | 1050 | 92 | 10 | Invention Example |
| 504 | 2.50 | 1050 | 92 | 10 | Invention Example |
| 505 | 2.50 | 1050 | 92 | 10 | Invention Example |
| 506 | 2.50 | 1050 | 92 | 10 | Invention Example |
| 507 | 2.50 | 1050 | 92 | 10 | Invention Example |
| 508 | 2.50 | 1050 | 92 | 10 | Invention Example |
| 509 | 2.50 | 1050 | 92 | 10 | Invention Example |
| 510 | 2.50 | 1050 | 92 | 10 | Invention Example |
| 511 | 2.50 | 1050 | 92 | 10 | Invention Example |
| 512 | 2.50 | 1050 | 92 | 10 | Invention Example |
| 513 | 2.50 | 1050 | 92 | 10 | Invention Example |
| 514 | 2.50 | 1050 | 92 | 10 | Invention Example |
| 515 | 2.50 | 1050 | 92 | 10 | Invention Example |

TABLE 10

| | | | | | | | | | | | | After second | | |
|---|---|---|---|---|---|---|---|---|---|---|---|---|---|---|
| | EBSD observation result after skin pass rolling | | | | | | | | | | | heat treatment | | |
| | | | | | S [symbol] / | S₁₀₀/ | S₁₀₀/ | K₁₀₀/ | K₁₀₀/ | S₁₀₀/ | K₁₀₀/ | W10/400 | W15/50(C)/ | |
| No. | K [symbol] | K [symbol] | K₁₀₀ | K₁₁₀ | S [symbol] | S [symbol] | S [symbol] | K [symbol] | K [symbol] | S₁₁₀ | K₁₁₀ | (W/kg) | W15/50(L) | Note |
| 501 | 0.371 | 0.364 | 0.363 | 0.364 | 0.72 | 0.14 | 0.71 | 0.979 | 0.997 | 5.61 | 0.996 | 10.5 | 1.10 | Invention |
| | | | | | | | | | | | | | | Example |
| 502 | 0.370 | 0.365 | 0.363 | 0.365 | 0.69 | 0.21 | 0.77 | 0.980 | 0.996 | 7.09 | 0.996 | 10.3 | 1.07 | Invention |
| | | | | | | | | | | | | | | Example |
| 503 | 0.371 | 0.364 | 0.364 | 0.364 | 0.67 | 0.21 | 0.77 | 0.980 | 0.999 | 7.09 | 0.998 | 10.3 | 1.09 | Invention |
| | | | | | | | | | | | | | | Example |
| 504 | 0.372 | 0.365 | 0.362 | 0.364 | 0.69 | 0.22 | 0.78 | 0.975 | 0.993 | 7.11 | 0.995 | 10.4 | 1.11 | Invention |
| | | | | | | | | | | | | | | Example |
| 505 | 0.370 | 0.364 | 0.364 | 0.365 | 0.74 | 0.14 | 0.72 | 0.982 | 0.999 | 5.59 | 0.996 | 10.1 | 1.12 | Invention |
| | | | | | | | | | | | | | | Example |
| 506 | 0.371 | 0.365 | 0.362 | 0.364 | 0.73 | 0.14 | 0.73 | 0.978 | 0.994 | 5.60 | 0.994 | 10.2 | 1.13 | Invention |
| | | | | | | | | | | | | | | Example |
| 507 | 0.371 | 0.364 | 0.363 | 0.365 | 0.73 | 0.15 | 0.73 | 0.977 | 0.996 | 5.59 | 0.994 | 10.2 | 1.11 | Invention |
| | | | | | | | | | | | | | | Example |
| 508 | 0.372 | 0.363 | 0.363 | 0.365 | 0.72 | 0.16 | 0.73 | 0.976 | 0.999 | 5.60 | 0.995 | 10.2 | 1.13 | Invention |
| | | | | | | | | | | | | | | Example |
| 509 | 0.371 | 0.365 | 0.363 | 0.364 | 0.73 | 0.16 | 0.73 | 0.978 | 0.994 | 5.60 | 0.996 | 10.2 | 1.11 | Invention |
| | | | | | | | | | | | | | | Example |
| 510 | 0.371 | 0.363 | 0.363 | 0.366 | 0.74 | 0.15 | 0.72 | 0.976 | 0.998 | 5.59 | 0.992 | 10.2 | 1.07 | Invention |
| | | | | | | | | | | | | | | Example |
| 511 | 0.371 | 0.365 | 0.362 | 0.366 | 0.72 | 0.14 | 0.73 | 0.976 | 0.993 | 5.59 | 0.991 | 10.0 | 1.08 | Invention |
| | | | | | | | | | | | | | | Example |
| 512 | 0.371 | 0.364 | 0.363 | 0.365 | 0.72 | 0.16 | 0.71 | 0.977 | 0.997 | 5.61 | 0.995 | 10.2 | 1.12 | Invention |
| | | | | | | | | | | | | | | Example |
| 513 | 0.372 | 0.364 | 0.363 | 0.365 | 0.73 | 0.15 | 0.71 | 0.977 | 0.998 | 5.59 | 0.995 | 10.0 | 1.10 | Invention |
| | | | | | | | | | | | | | | Example |
| 514 | 0.371 | 0.365 | 0.362 | 0.366 | 0.72 | 0.14 | 0.71 | 0.977 | 0.994 | 5.59 | 0.991 | 10.0 | 1.08 | Invention |
| | | | | | | | | | | | | | | Example |
| 515 | 0.371 | 0.367 | 0.362 | 0.365 | 0.73 | 0.14 | 0.71 | 0.977 | 0.988 | 5.61 | 0.993 | 10.4 | 1.11 | Invention |
| | | | | | | | | | | | | | | Example |

[symbol]

indicates data missing or illegible when filed

In all of No. 501 to No. 515, which are invention examples, Formula (3) to Formula (9) were satisfied, and the iron losses W10/400 were favorable values.

### INDUSTRIAL APPLICABILITY

According to the present invention, since the area and the area ratio of specific crystal orientations in a cross section parallel to the steel sheet surface are appropriate, it is possible to obtain excellent magnetic characteristics even after shearing. Therefore, the present invention is highly industrially applicable.

1. A non-oriented electrical steel sheet comprising, as a chemical composition, by mass %;
Si: 1.50% to 4.00%;
one or more of Mn, Ni, Co, Pt, Pb, Cu, and Au: less than 2.50% in total;
C: 0.0100% or less;
sol. Al: 4.00% or less;
S: 0.0400% or less;
N: 0.0100% or less;
Sn: 0.00% to 0.40%;
Sb: 0.00% to 0.40%;
P: 0.00% to 0.40%;
Cr: 0.001% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

2. The non-oriented electrical steel sheet according to claim 1,
wherein, in a case where an average KAM value of the orientated grains in which the Taylor factor M becomes 2.8 or less is indicated by Kₜᵣₐ, Formula (7) is satisfied,
K₁₀₀/Kₜᵣₐ<1.010 (7).

3. The non-oriented electrical steel sheet according to claim 1,
wherein, in a case where an area of {110} orientated grains is indicated by S₁₁₀, Formula (8) is satisfied,
S₁₀₀/S₁₁₀≥1.00 (8)
here, it is assumed that Formula (8) is satisfied even when an area ratio S₁₀₀/S₁₁₀ diverges to infinity.

4. The non-oriented electrical steel sheet according to claim 1,
wherein, in a case where an average KAM value of {110} orientated grains is indicated by K₁₁₀, Formula (9) is satisfied,
K₁₀₀/K₁₁₀<1.010 (9).

5. A non-oriented electrical steel sheet comprising, as a chemical composition, by mass %;
Si: 1.50% to 4.00%;
one or more of Mn, Ni, Co, Pt, Pb, Cu, and Au: less than 2.50% in total;
C: 0.0100% or less;
sol. Al: 4.00% or less;
S: 0.0400% or less;
N: 0.0100% or less;
Sn: 0.00% to 0.40%;
Sb: 0.00% to 0.40%;
P: 0.00% to 0.40%;
Cr: 0.001% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, an average KAM value of the orientated grains in which the Taylor factor M becomes more than 2.8 is indicated by K_{tyl}, an average grain size in an observation region is indicated by dₐᵥₑ, an average grain size of the {100} orientated grains is indicated by d₁₀₀, and an average grain size of the orientated grains in which the Taylor factor M becomes more than 2.8 is indicated by d_{tyl}, Formulas (10) to (15) are satisfied,
([Mn]+[Ni]+[Co]+[Pt]+[Pb]+[Cu]+[Au])−([Si]+[sol. Al])≤0.00% (1)
M=(cos ϕ×cos λ)⁻¹ (2)
S_{tyl}/Sₜₒₜ≤0.70 (10)
0.20≤S₁₀₀/Sₜₒₜ (11)
S₁₀₀/Sₜᵣₐ≥0.55 (12)
K₁₀₀/K_{tyl}≤1.010 (13)
d₁₀₀/dₐᵥₑ>1.00 (14)
d₁₀₀/d_{tyl}>1.00 (15)
here, ϕ in Formula (2) represents an angle formed by a stress vector and a slip direction vector of a crystal, and λ represents an angle formed by the stress vector and a normal vector of a slip plane of the crystal.

6. The non-oriented electrical steel sheet according to claim 5,
wherein, in a case where an average KAM value of the orientated grains in which the Taylor factor M becomes 2.8 or less is indicated by Kₜᵣₐ, Formula (16) is satisfied,
K₁₀₀/Kₜᵣₐ<1.010 (16).

7. The non-oriented electrical steel sheet according to claim 5,
wherein, in a case where an average grain size of the orientated grains in which the Taylor factor M becomes 2.8 or less is indicated by dₜᵣₐ, Formula (17) is satisfied,
d₁₀₀/dₜᵣₐ>1.00 (17).

8. The non-oriented electrical steel sheet according to claim 5,
wherein, in a case where an area of {110} orientated grains is indicated by S₁₁₀, Formula (18) is satisfied,
S₁₀₀/S₁₁₀≥1.00 (18)
here, it is assumed that Formula (18) is satisfied even when an area ratio S₁₀₀/S₁₁₀ diverges to infinity.

9. The non-oriented electrical steel sheet according to claim 5,
wherein, in a case where an average KAM value of {110} orientated grains is indicated by K₁₁₀, Formula (19) is satisfied,
K₁₀₀/K₁₁₀<1.010 (19).

10. A method for manufacturing the non-oriented electrical steel sheet according to claim 5, the method comprising:
performing a heat treatment on the non-oriented electrical steel sheet which includes, as a chemical composition, by mass %; Si: 1.50% to 4.00%; one or more of Mn, Ni, Co, Pt, Pb, Cu, and Au: less than 2.50% in total; C: 0.0100% or less; sol. Al: 4.00% or less; S: 0.0400% or less; N: 0.0100% or less; Sn: 0.00% to 0.40%; Sb: 0.00% to 0.40%; P: 0.00% to 0.40%; Cr: 0.001% to 0.100%; B: 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

11. A non-oriented electrical steel sheet comprising, as a chemical composition, by mass %;
Si: 1.50% to 4.00%;
one or more of Mn, Ni, Co, Pt, Pb, Cu, and Au: less than 2.50% in total;
C: 0.0100% or less;
sol. Al: 4.00% or less;
S: 0.0400% or less;
N: 0.0100% or less;
Sn: 0.00% to 0.40%;
Sb: 0.00% to 0.40%;
P: 0.00% to 0.40%;
Cr: 0.001% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average grain size in an observation region is indicated by dₐᵥₑ, an average grain size of the {100} orientated grains is indicated by d₁₀₀, and an average grain size of the orientated grains in which the Taylor factor M becomes more than 2.8 is indicated by d_{tyl}, Formulas (20) to (24) are satisfied,
([Mn]+[Ni]+[Co]+[Pt]+[Pb]+[Cu]+[Au])−([Si]+[sol. Al])≤0.00% (1)
M=(cos ϕ×cos λ)⁻¹ (2)
S_{tyl}/Sₜₒₜ<0.55 (20)
S₁₀₀/Sₜₒₜ>0.30 (21)
S₁₀₀/Sₜᵣₐ≥0.60 (22)
d₁₀₀/dₐᵥₑ≥0.95 (23)
d₁₀₀/d_{tyl}≥0.95 (24)
here, ϕ in Formula (2) represents an angle formed by a stress vector and a slip direction vector of a crystal, and λ represents an angle formed by the stress vector and a normal vector of a slip plane of the crystal.

12. The non-oriented electrical steel sheet according to claim 11,
wherein, in a case where an average grain size of the orientated grains in which the Taylor factor M becomes 2.8 or less is indicated by dₜᵣₐ, Formula (25) is satisfied,
d₁₀₀/dₜᵣₐ≥0.95 (25).

13. A method for manufacturing the non-oriented electrical steel sheet, comprising:
performing a heat treatment on the non-oriented electrical steel sheet according to claim 1 at a temperature of 950° C. to 1050° C. for 1 second to 100 seconds or at a temperature of 700° C. to 900° C. for longer than 1000 seconds.

14. A method for manufacturing the non-oriented electrical steel sheet, comprising:
performing a heat treatment on the non-oriented electrical steel sheet according to claim 5 at a temperature of 950° C. to 1050° C. for 1 second to 100 seconds or at a temperature of 700° C. to 900° C. for longer than 1000 seconds.

15. A method for manufacturing the non-oriented electrical steel sheet according to claim 6, the method comprising:
performing a heat treatment on the non-oriented electrical steel sheet which includes, as a chemical composition, by mass %; Si: 1.50% to 4.00%; one or more of Mn, Ni, Co, Pt, Pb, Cu, and Au: less than 2.50% in total; C: 0.0100% or less; sol. Al: 4.00% or less; S: 0.0400% or less;
N: 0.0100% or less; Sn: 0.00% to 0.40%; Sb: 0.00% to 0.40%; P: 0.00% to 0.40%; Cr: 0.001% to 0.100%; B: 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied, at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

16. A method for manufacturing the non-oriented electrical steel sheet according to claim 7, the method comprising:
performing a heat treatment on the non-oriented electrical steel sheet which includes, as a chemical composition, by mass %; Si: 1.50% to 4.00%; one or more of Mn, Ni, Co, Pt, Pb, Cu, and Au: less than 2.50% in total; C: 0.0100% or less; sol. Al: 4.00% or less; S: 0.0400% or less; N: 0.0100% or less; Sn: 0.00% to 0.40%; Sb: 0.00% to 0.40%; P: 0.00% to 0.40%; Cr: 0.001% to 0.100%; B: 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied, at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

17. A method for manufacturing the non-oriented electrical steel sheet according to claim 8, the method comprising:
performing a heat treatment on the non-oriented electrical steel sheet which includes, as a chemical composition, by mass %; Si: 1.50% to 4.00%; one or more of Mn, Ni, Co, Pt, Pb, Cu, and Au: less than 2.50% in total; C: 0.0100% or less; sol. Al: 4.00% or less; S: 0.0400% or less; N: 0.0100% or less; Sn: 0.00% to 0.40%; Sb: 0.00% to 0.40%; P: 0.00% to 0.40%; Cr: 0.001% to 0.100%; B: 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied, at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

18. A method for manufacturing the non-oriented electrical steel sheet according to claim 9, the method comprising:
performing a heat treatment on the non-oriented electrical steel sheet which includes, as a chemical composition, by mass %; Si: 1.50% to 4.00%; one or more of Mn, Ni, Co, Pt, Pb, Cu, and Au: less than 2.50% in total; C: 0.0100% or less; sol. Al: 4.00% or less; S: 0.0400% or less; N: 0.0100% or less; Sn: 0.00% to 0.40%; Sb: 0.00% to 0.40%; P: 0.00% to 0.40%; Cr: 0.001% to 0.100%; B: 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {100} orientated grains is indicated by S₁₀₀, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {100} orientated grains is indicated by K₁₀₀, and an average KAM value of the orientated grains in which the Taylor factor M becomes more than 2.8 is indicated by K_{tyl}, Formulas (3) to (6) are satisfied, at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cos ϕ×cos λ)⁻¹ (2)
0.20≤S_{tyl}/Sₜₒₜ≤0.85 (3)
0.05≤S₁₀₀/Sₜᵣₐ≥0.80 (4)
S₁₀₀/Sₜᵣₐ≥0.50 (5)
K₁₀₀/K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.
